(19) United States
(12) Patent Application Publication
(10) Pub. No.: US 2006/0161879 A1
(43) Pub. Date: Jul. 20, 2006

(54) Methods for managing standards

(75) Inventors: Michael D. Lubrecht, Carnation, WA (US); Kathryn A. Pizzo, Bellevue, WA (US); Dinah Turner, Cheshire (GB); Mark Ross Sutherland, East Lothian (GB)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/037,724

(22) Filed: Jan. 18, 2005

(51) Int. Cl. G06F 9/44

(52) U.S. Cl. 717/101

(57) ABSTRACT

One embodiment is directed to a method of instructing at least one operator in a best practices implementation of a standards facility for managing at least one standard in an information technology (IT) environment comprising a plurality of standards to be managed, the IT environment being managed in accordance with at least some aspects of the Microsoft Operations Framework (MOF), the at least some aspects of the MOF comprising a change management service management function (SMF) that documents, assesses the impact of, approves, schedules and reviews changes in the IT environment and a configuration management SMF that identifies and documents components of the IT environment and relationships between them. The method comprises an act of: (A) instructing the at least one operator to treat the at least one standard as a configuration item so that changes to the at least one standard are managed in accordance with the change management SMF and so that the at least one standard is tracked in accordance with the configuration management SMF.

### FIELD OF THE INVENTION

The present invention relates to operation of a facility for managing at least one standard in an information technology environment.

### BACKGROUND OF THE INVENTION

Networked computer systems play important roles in the operation of many businesses and organizations. The performance of a computer system providing services to a business and/or customers of a business may be integral to the successful operation of the business. A computer system refers generally to any collection of one or more devices interconnected to perform a desired function, provide one or more services, and/or to carry out various operations of an organization, such as a business corporation, etc.

In some computer systems, the operation and maintenance of the system is delegated to one or more administrators that make up the system's information technology (IT) organization. When a computer system is managed by an IT organization, the computer system may be referred to as an IT environment. The IT organization may set-up a computer system to provide end users with various application or transactional services, access to data, network access, etc., and establish the environment, security and permissions landscape and other capabilities of the computer system. This model allows dedicated personnel to customize the system, centralize application installation, establish access permissions, and generally handle the operation of the enterprise in a way that is largely transparent to the end user. The day-to-day maintenance and servicing of the system as well as the contributing personnel are referred to as IT operations (or “operations” for short).

As computer systems become more complex and as organizations continue to rely more on the resources and services provided by their respective computer systems, maintaining the system and ensuring that services provided by the system are available becomes increasingly important, more complex, and more difficult to achieve.

In particular, it may be desirable to use consistent standards pertaining to the infrastructure components and processes of the IT environment. A standard (also referred to as a policy) as used herein refers to a model, example, or rule for an infrastructure component or category of an IT environment. For example, a standard for implementing change in the IT environment might be the minimum required documentation for a request for change (RFC), including the format in which it is submitted. As another example, a standard for vendor management could be a vendor contract template. A standard for commercial off-the-shelf (COTS) software could define the minimum requirements for compatibility with other in-house products. As an IT environment grows larger, it may be increasingly more difficult to ensure the use of consistent standards across the IT environment, without any cohesive guidelines regarding how to how to manage these standards.

### SUMMARY OF THE INVENTION

In one embodiment, a cohesive process set of practices for managing standards in an IT environment may be provided to the operator or operators of the IT environment. The set of practices may instruct the operator or operators to treat standards as configuration items, so that the standards can be managed with guidelines that are already in place for managing changes to the IT environment and managing the configuration of the IT environment.

One embodiment is directed to a method of instructing at least one operator in a best practices implementation of a standards facility for managing at least one standard in an information technology (IT) environment comprising a plurality of standards to be managed, the IT environment being managed in accordance with at least some aspects of the Microsoft Operations Framework (MOF), the at least some aspects of the MOF comprising a change management service management function (SMF) that documents, assesses the impact of, approves, schedules and reviews changes in the IT environment and a configuration management SMF that identifies and documents components of the IT environment and relationships between them. The method comprises an act of: (A) instructing the at least one operator to treat the at least one standard as a configuration item so that changes to the at least one standard are managed in accordance with the change management SMF and so that the at least one standard is tracked in accordance with the configuration management SMF.

Another embodiment is directed to a method of operating a standards facility for managing at least one standard in an information technology (IT) environment comprising a plurality of standards to be managed, the IT environment being managed in accordance with at least some aspects of the Microsoft Operations Framework (MOF), the at least some aspects of the MOF comprising a change management service management function (SMF) that documents, assesses the impact of, approves, schedules and reviews changes in the IT environment and a configuration management SMF that identifies and documents components of the IT environment and relationships between them. The method comprises an act of: (A) following best practices instructions for the implementation of the standards facility, including instructions to treat the at least one standard as a configuration item so that changes to the at least one standard are managed in accordance with the change management SMF and so that the at least one standard is tracked in accordance with the configuration management SMF.

A further embodiment is directed to a method of instructing at least one operator in a best practices implementation of a facility for managing at least exception to at least one standard in an information technology (IT) environment comprising a plurality of standards to be managed, the IT environment being managed in accordance with at least some aspects of the Microsoft Operations Framework (MOF), the at least some aspects of the MOF comprising a change management service management function (SMF) that documents, assesses the impact of, approves, schedules and reviews changes in the IT environment. The method comprises an act of: (A) instructing the at least one operator to treat the at least one exception as a configuration item so that the at least one exception is managed in accordance with the change management SMF.

Another embodiment is directed to a method of operating a facility for managing at least exception to at least one standard in an information technology (IT) environment comprising a plurality of standards to be managed, the IT environment being managed in accordance with at least some aspects of the Microsoft Operations Framework (MOF), the at least some aspects of the MOF comprising a change management service management function (SMF) that documents, assesses the impact of, approves, schedules and reviews changes in the IT environment. The method comprises an act of: (A) following best practices instructions for the implementation of the facility, including instructions to treat the at least one exception as a configuration item so that the at least one exception is managed in accordance with the change management SMF.

### BRIEF DESCRIPTION OF THE DRAWINGS

FIG. 1 is a diagram illustrating the relationship between the Infrastructure Engineering (IE) Service Management Function (SMF) and other areas of the Microsoft Operations Framework (MOF), which provides one set of instruction for incorporating aspects of the present invention;

FIG. 2 is a diagram illustrating the relationship between the IE SMF, the Change Management SMF, and the configuration management database (CMDB), in accordance with one embodiment;

FIG. 3 is a diagram of process for an Infrastructure Engineering (IE) facility, in accordance with one embodiment;

FIG. 4 is a diagram showing the relationship between the IE SMF and other MOF and Microsoft Solutions Framework (MSF) processes, in accordance with one embodiment;

FIG. 5 is a flow diagram illustrating a process for defining an infrastructure environment, in accordance with one embodiment;

FIG. 6 is a chart showing a chart of categories for standards and policies;

FIG. 7 is a diagram of a typical life cycle of a standard;

FIG. 8 is a diagram illustrating iterations of a life cycle of a standard;

FIG. 9 is a flow diagram of a process for defining standards and policies in an infrastructure category, in accordance with one embodiment;

FIG. 10 is a flow diagram of a process for utilizing policies and standards to control the infrastructure, in accordance with one embodiment;

FIG. 11 is a flow diagram of an exception process, in accordance with one embodiment;

FIG. 12 is a flow diagram of a process for maintaining standards and policies, in accordance with one embodiment;

FIG. 13 is a diagram illustrating MOF team model role clusters;

FIG. 14 is a flow diagram of a change management process, in accordance with one embodiment;

FIG. 15 is a flow diagram of a change request process, in accordance with one embodiment;

FIG. 16 is a flow diagram of a change classification process, in accordance with one embodiment;

FIG. 17 is a flow diagram of a process for the authorization of minor changes, in accordance with one embodiment;

FIG. 18 is a flow diagram of a process for the authorization of significant and major changes, in accordance with one embodiment;

FIG. 19 is a flow diagram of a process for the authorization of emergency changes, in accordance with one embodiment;

FIG. 20 is a flow diagram of a change development and release process, in accordance with one embodiment;

FIG. 21 is a diagram of the MSF process model;

FIG. 22 is a flow diagram of a change review process, in accordance with one embodiment;

FIG. 23 is a diagram illustrating the relationship between the Change Management SMF, the Configuration Management SMF, and the Release Management SMF;

FIG. 24 is a flow diagram of a configuration management process, in accordance with one embodiment;

FIG. 25 is a flow diagram of set up activities for configuration management;

FIG. 26 is a flow diagram of a process for establishing configuration items, in accordance with one embodiment;

FIG. 27 is a flow diagram of a process for the accessing configuration items, in accordance with one embodiment;

FIG. 28 is a flow diagram of a process for changing configuration items, in accordance with one embodiment; and

FIG. 29 is a flow diagram of a process for reviewing configuration items, in accordance with one embodiment.

### DETAILED DESCRIPTION

Applicants have recognized that difficulties in maintaining a computer system include challenges relating to maintaining consistent standards across the computer system. Failure to maintain consistent standards may present numerous difficulties, such as when deploying new hardware or software resources in the computer system, as the new resources may not be compatible with some or all of the existing infrastructure or services in the computer system. This can limit an IT operator's ability to deliver services and functionality in a timely fashion.

In one embodiment of the present invention, a set of best practices for managing standards in an IT environment is provided. In one embodiment, the set of practices instructs an operator to treat standards like other items in the IT environment that are subject to change, so that the standards can be managed with guidelines that are already in place for managing the configuration of and changes to the IT environment. An example of process for managing standards in accordance with one embodiment is shown in FIG. 3. In FIG. 3, at act 301, the infrastructure environment may be defined. This includes, for example, determining the desired scope of components of the IT environment that are to be regulated with standards and categorizing elements of the infrastructure into groupings to allow effective utilization of standards and policies. At act 303, polices and standards are collected and defined. That is, existing standards in the IT environment may be recognized and new ones may be defined, where it is believed they will be helpful. At act 305, policies and standards are applied to the IT environment and at act 307 the policies and standards are maintained. Acts 305 and 307 may be accomplished using existing best practices approaches to change management configuration management. Thus, in one embodiment, the change management and configuration management best practices may provide guidelines for managing components of the IT environment, termed “configuration items.” Standards may be treated as configuration items, so that they may be managed using the change management and configuration management guidelines.

That is, existing standards in the IT environment and the need for new standards may be identified. These standards may then be applied to the IT environment, for example using guidelines in place for managing changes to the IT environment. The standards may then be maintained using guidelines in place for managing the configuration of an IT environment.

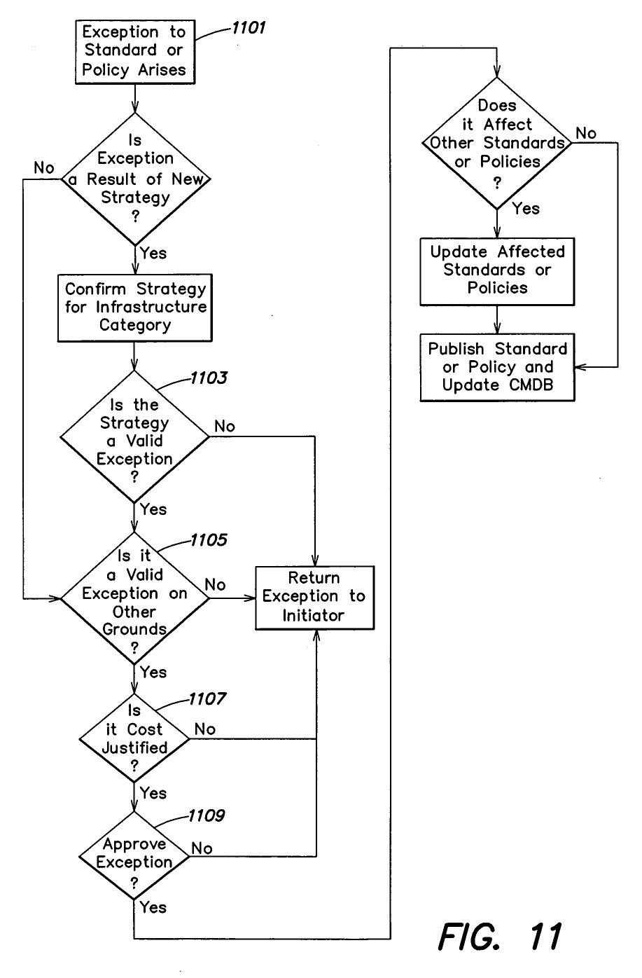

Applicants have appreciated that situations may arise where established standards and policies are not directly applicable and an exception to the standard is desired. Thus, in one embodiment, a set of best practices for managing standards includes best practices for handling exceptions to established standards, and includes a best practices approach of treating a valid exception using existing guidelines for managing changes to the IT environment. An example of such a process is shown in FIG. 11. As shown in FIG. 11, at act 1101, an exception arises. At acts 1103, 1105, and 1107, it is determined if the exception is a valid exception and if it is cost justified. If the exception is valid and cost justified, it is approved at act 1109.

One exemplary embodiment of the invention described below is adapted for use with the Microsoft Operations Framework (MOF). MOF provides guidance that enables organizations to achieve system reliability, availability, supportability, and manageability for a wide range of management issues pertaining to complex, distributed, and heterogeneous environments. MOF includes a number of service management functions (SMFs) that provide operational guidance for implementing and managing computing environments and other IT solutions. In one embodiment, instructions for implementing a standards management facility is provided as part of a MOF Infrastructure Engineering (IE) SMF, although embodiments of the invention described herein are not limited to use with MOF, or to employing the management best practices in the IE SMF. The IE SMF may be presented in accordance with the fundamental principles of MOF and may be fully integrated with other MOF SMFs. The Infrastructure Engineering (IE) SMF interacts with two other MOF SMFs: the Change Management SMF and the Configuration Management SMF. Descriptions of these two SMFs are also presented below. A complete description of MOF is provided in the published MOF version 3.0 documentation, which is herein incorporated by reference in its entirety, and is available at http://www.microsoft.com/mof.

Infrastructure Engineering (IE) SMF

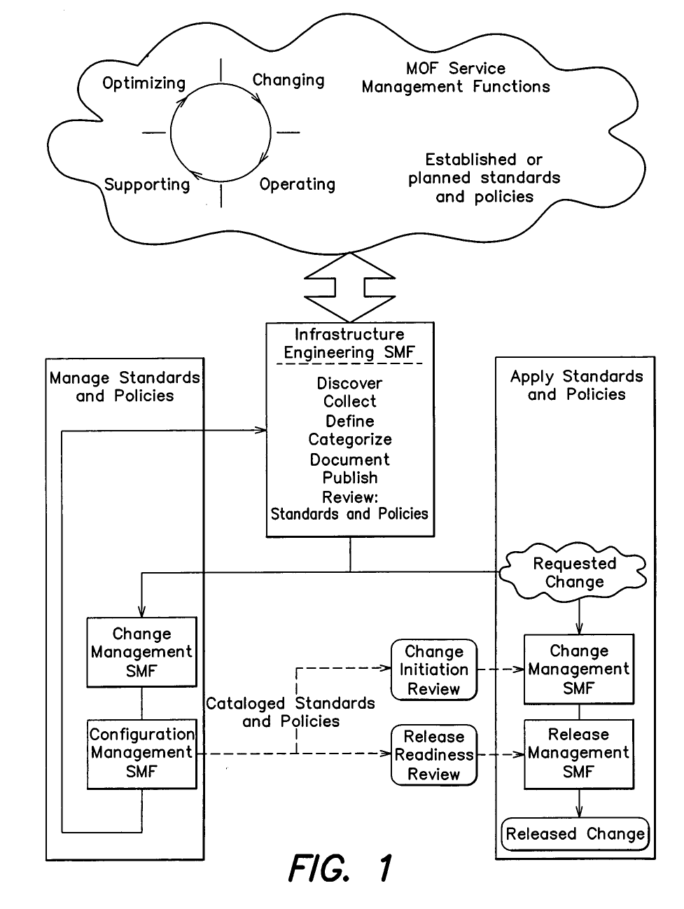

In one embodiment, the IE SMF primarily coordinates the creation, management, and application of consistent IT standards and policies, which are then applied across the organization in the development, deployment, and operation of tools and services. Application of the standards and policies managed through the IE process becomes a fundamental part of the project planning process; compliance with these standards and policies is reviewed at key MOF milestones for the Optimizing and Changing Quadrants. FIG. 1 shows a process for infrastructure engineering.

Through implementation of the Infrastructure Engineering SMF, organizations will:
Develop standards, policies, benchmarks, and guidelines for managing the infrastructure now and in the future, maximizing availability, supportability, and operability.
Provide guidance and control to ensure that solutions are operable at the appropriate level and to optimize timing for new solution design and changes.
Ensure that the infrastructure in use, including the technology and common application portfolios (for example, standard desktops) align to the business strategy and direction.
Measurably improve their management of the infrastructure environment.
Provide for a means of verifying quality assurance (QA) for all infrastructure development at the planning and authorization stages.
Maintain a cost-aware approach to the selection of strategic technology solutions and reduce unnecessary costs.

Infrastructure Engineering will take the lead in identifying and normalizing existing standards and policies and determining the need for new ones. The IE SMF has responsibility for managing the development of standards and policies, typically through internal or external subject matter experts.

In some cases, the role of IE is a coordinating one—for example, the Capacity Management and Service Level Management SMFs are typically well-connected to business strategy and planning and how they relate to current and forecasted IT. These SMFs create standards and policies that address issues appropriate to their scope. The Infrastructure Engineering SMF will coordinate with these and other SMFs to ensure that the standards and policies they develop are consistent with those already established or planned for other categories. Once created, IE will take responsibility for managing these standards.

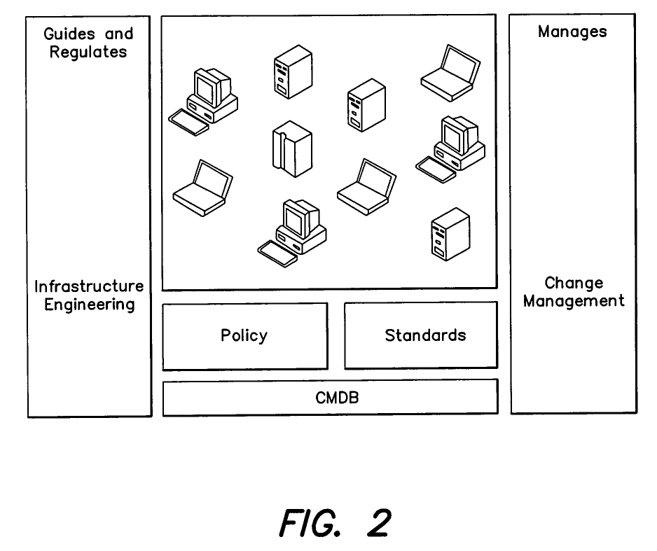

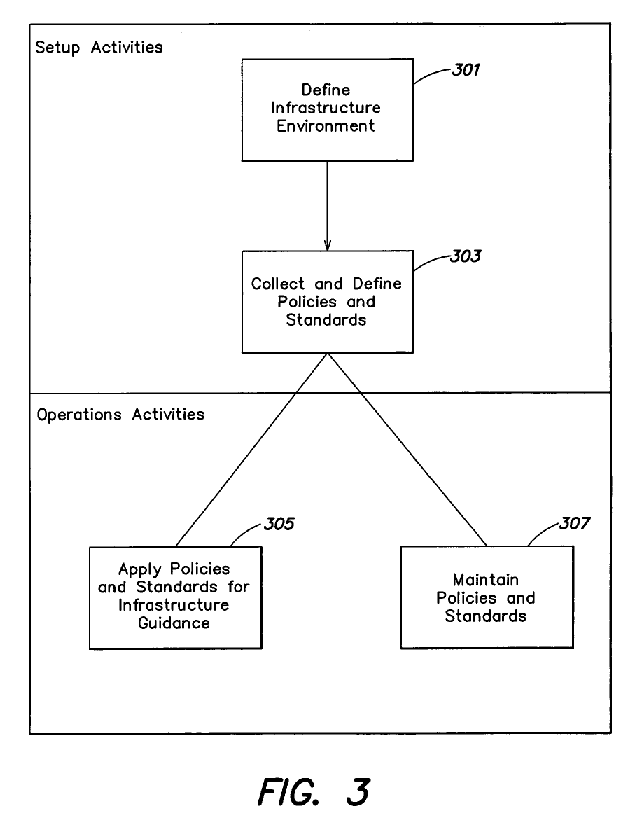

IE manages the resulting suite of standards and policies in concert with processes established by the Change Management and Configuration Management SMFs. This ensures that the standards and policies remain consistent and are changed only through a formalized process, illustrated in FIG. 2.

In turn, to ensure that these standards are applied during the planning phases of IT operations and new projects, IE facilitates access to the new standards by publishing them to the configuration management database (CMDB), corporate intranet, and/or other publishing media. IE also ensures that proposed changes to the IT environment are in compliance with established standards and policies; this is accomplished through participation as a key stakeholder in the Change Initiation Review and Release Readiness Review OMRs, described later in this document.

Finally, the Infrastructure Engineering SMF provides guidance for applying the standards and policies across the organization. For example, the Service Level Management SMF may query the IE SMF when creating new service level agreements (SLAs) and operating level agreements (OLAs). Access to this information will ensure that the negotiated requirements can be met by the standards and policies for the infrastructure elements or service components involved.

Due to the need for input from subject matter experts across all the SMFs, the processes within infrastructure engineering are delegated and performed by various roles across the MOF Team Model role clusters; the specific coordination role for IE is carried out by the infrastructure engineering manager within the Infrastructure Role Cluster, which is examined in more depth in the Roles and Responsibilities section later in this document.

Scope

The Infrastructure Engineering SMF affects all standardized practices within an IT organization. These standards and policies may originate from any other SMF in any MOF process quadrant. The SMF is flexible in its scope, with the extent of IT standardization to be determined by the implementing organization.

Infrastructure engineering is not about control or micromanaging. It's about defining common components that affect many groups and projects and facilitating the widespread application of these common components. To this end, controlling every single component within even a small infrastructure environment is impractical. Over and above the challenge of obtaining and collating all of the relevant information, the costs and resources involved in maintaining and updating the information would be prohibitive.

Therefore, choices must be made concerning the desired scope of infrastructure to be managed. This decision-making process requires that each category be evaluated for its direct relevance to meeting business needs, its dependencies on other categories, and the degree to which other categories depend on it. As with a CMDB, best practice calls for managing only those categories that:
Are necessary for the effective operation of the business.
Support the enablement and delivery of IT services.
Are common components across IT teams and projects that will save time and money if standardized for the whole.

These same criteria may be applied to creating standards or policies for the change or management of the infrastructure; centralized management of some infrastructure components is simply not practical or beneficial. Balancing this, it should be noted that the proliferation of multiple, seemingly inconsequential technologies—for example, remote management or scripting tools—can eventually amount to a significant operations management burden and cost. Furthermore, multiple technologies can impose additional security risks since additional network ports may need to be opened to accommodate them. In considering the scope within which to standardize, it is critical to consider these factors. Appendix A provides a list of typical IT infrastructure components to which standards and policies are applied. The decision to include a category within the IE scope should be reviewed at periodic intervals to ensure that resources are being allocated to useful activities.

Capabilities

An organization that implements this SMF should have the organizational capabilities in place to be able to complete and maintain the following:
Discover current standards and policies.
Define categories of standards, processes, and policies that align with their IT organizational structure.
Define an effective suite of standards, processes, and policies for common IT activities.
Implement and maintain a change management process.
Apply the standards and policies for design, development, and deployment tasks.

The breadth and depth of the standards and policies that are developed and applied may vary from organization to organization, depending upon the maturity level to which other MOF service management functions have been adopted.

Key Definitions

Change Initiation Review. The Change Initiation Review is the first milestone within the MOF Process Model and marks the beginning of an investment of resources from IT operations in instigating a change to the infrastructure. This review is held at the beginning of the change management process (closely synchronized with the Project Plan Approved MSF milestone) to evaluate the alignment of the requested change with IT policies or standards related to it. The guidance and infrastructure control processes managed by IE provide a key input to the Change Initiation Review as they ensure that any proposed change has utilized the policies and standards for the defined category to be changed.
Infrastructure category. A grouping of elements of the infrastructure with a commonality—for instance, hardware, desktop, network components, or buildings.
Infrastructure engineering manager. A specific role within the Infrastructure Role Cluster in the MOF Team Model. The individual responsible for the management, implementation, and review of the IE process. Coordinates and manages the relationships with those responsible for other SMFs and OMRs.
Infrastructure environment. The defined operational target for inclusion within the infrastructure engineering management process, which must be defined at the outset when implementing IE principles.
Policy. A defined process or set of procedures within a particular infrastructure category. For example, policies might be established for:
   Managing the outsourcing of a service.
   Hardware purchasing processes.
   Managing change approvals.
   Managing wireless security parameters.
   Procuring a vendor.
   Messaging security.
   Guiding developers in procuring IT environmental requirements outside of established policies or standards.
The policies in place will ensure that the infrastructure complies with the overall strategy and accepted procedures of the organization.
Standard. A standard within this SMF is defined as a set of criteria or configurations applied within a category. Whereas policies are frequently processes applied to human activities, standards are frequently lists of requirements that apply to technologies. Examples of standards created for specific categories might include:
   A network topology and layout standards.
   A corporate standard for client or server configurations, specifications, and builds.
   A standard architecture for test labs.
Standards may be prescribed, specific ways of working, or a set of specifications that describe a physical or virtual object, created to ensure a uniform approach to assist with control of the categories within the infrastructure. Note that both policies and standards may contain procedures; typically those defined within a standard are very prescriptive and focused on the completion of a well-defined task, as shown in the examples above. Appendix A provides a full listing of the standards and policies recommended by ITIL to provide guidance for infrastructure planning, engineering, and operations.
   Processes and Activities
   Process Flow Summary

In implementing the Infrastructure Engineering SMF, a setup activity is initiated to define the scope of the infrastructure environment and to determine how best to manage it using defined policies and standards. Regulation of the infrastructure through the use of these standards can be as passive or active as the organization needs, although it is suggested that the use of established policies and standards be enforced at the Change Initiation Review, as a minimum. IE is not intended for use as a stand-alone SMF; it relies heavily on effective input and feedback from other SMFs, the business organization, the development teams, and the MOF Risk Management Discipline and Team Model role clusters to deliver maximum benefit to the organization.

A high-level view of the IE process is diagrammed in FIG. 3. Note that the discovery and classification processes shown as setup activities may occur in parallel with the management activities illustrated in the lower half of the diagram.

The Infrastructure Engineering SMF is closely aligned with the Microsoft Solutions Framework (MSF) Planning Phase, as well as the MOF Change Initiation Review. Standards and policies that are derived in the top half of FIG. 3 are applied within the production environment as part of operations, but are also applied to MSF projects for solution development and deployment.

Application of the IE standards and policies in MSF projects is initiated early in the project's Envisioning Phase. Both MSF and MOF mandate that certain reviews take place throughout the course of a release's (or project's) evolution. As explained here, several of the MSF and MOF reviews synchronize closely within the release development timeline.

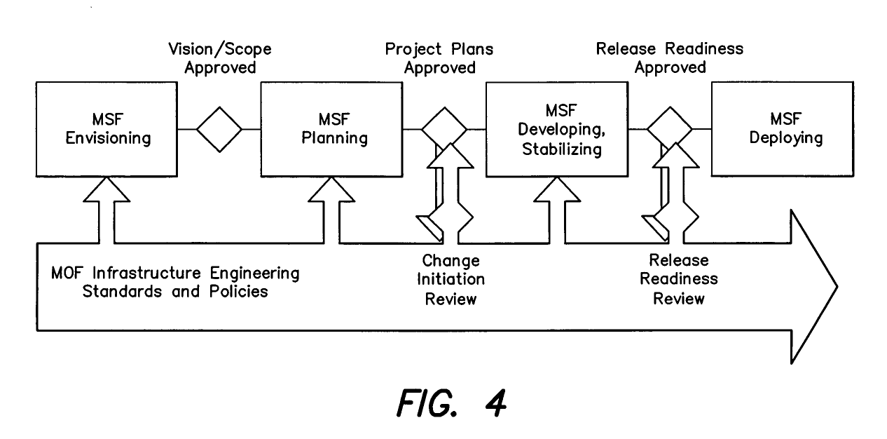

Project planning that occurs during the MSF Envisioning and Planning phases will incorporate IT policies and standards into the project requirements for development and deployment. Operations stakeholders first review these plans at the Change Initiation Review OMR, which occurs near the Project Plans Approved Milestone of the MSF Process Model. Compliance with standards and policies is again checked by operations stakeholders at the MOF Release Readiness Review, which is aligned with the MSF Release Readiness Approved Review. Both of these major milestones are significant checks against the possibility of releasing non-standard or incompatible changes into the production environment. These relationships are depicted in FIG. 4.

Process Flow Steps

The development and application of consistent IT policies and standards across an organization is accomplished through the following process, which is described in detail in subsequent sections.

Define the Infrastructure Environment

A clear and thorough definition of the infrastructure environment is key to its successful and subsequent management. This process provides guidance on how to define the environment and determine the desired scope of environmental components to be regulated, and examines how to categorize elements of the infrastructure into sensible groupings to allow effective utilization of standards and policies. For example, the facilities manager within a particular organization may already have well-defined standards and policies in place for the acquisition of power and communications services for the data center. Although ITIL and MOF both have functions to regulate this, the organization may decide not to include this scope within the managed IT infrastructure as long as the IT management continues to communicate well with facilities management.

Collect and Define Policies and Standards

As previously stated, the use of policies and standards to control evolution of the infrastructure helps to maintain a stable and effectively aligned IT organization. This process provides guidance on collecting and documenting the policies and standards that exist across the infrastructure and defining new ones where necessary, looking in particular at key inputs that will ensure the best fit for the organization now and several years into the future.

Apply Policies and Standards for Infrastructure Guidance

The creation of policies and standards adds real value only if they are used effectively to provide guidance and control over the integrated infrastructure environment. This process examines how policies and standards should be applied in developing a new requirement or a change to the infrastructure. The process also describes an alternative for dealing with situations that fall outside the need for a standard or policy by taking a controlled approach to exceptions.

The IE SMF also facilitates the documentation and publication of standards and policies for easy accessibility within the organization. Templates and examples are provided in the appendices for guidance in developing an effective standard or policy. Publishing these through internal Web sites, knowledge bases, standardized queries to the CMDB, or other media minimizes the time that cross-operational teams or other users need to spend in researching the infrastructure engineering areas of their development or deployment projects or in writing specifications. For example, Microsoft publishes all of its financial and procurement standards and policies on a unified internal Web site.

Maintain Policies and Standards

Because the policies and standards are created across all the SMFs and MOF Team Model role clusters, it is important to ensure that they are maintained effectively and kept accessible to all potential users.

This section explains the management of changes, additions, and reviews of the standards and policies and how these maintenance activities map onto the processes defined by the Change Management SMF.

Define the Infrastructure Environment

This section describes the process of defining the infrastructure environment. Managing the infrastructure can be carried out effectively only if you know what components you have and what you need to manage. This is particularly relevant to infrastructure engineering (IE) because the range of variables in IE is vast, and it is necessary to scope and define the area that the IE SMF applies to when implementing it. In varying sizes and types of organizations, the infrastructure may demand different levels of effort in management and control, and adequate scoping of these requirements beforehand will result in the successful management of the infrastructure in the future.

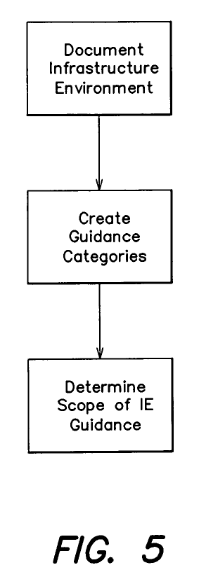

The overview of the process for defining the infrastructure environment is shown in FIG. 5.

In order to collect a set of standards to use in managing the infrastructure environment, the infrastructure engineering manager must first determine the extent of the current infrastructure and identify its characteristics. The initial step upon implementation of the IE SMF is to complete a discovery exercise to determine exactly what infrastructure exists within the organization and what standards, processes, or policies are used (if any) to manage it. Initially, the scope of this effort might be restricted to the IT production environment only, but there might be circumstances where it is beneficial to apply standards, processes, and policies to other areas, such as development and test labs.

There are various starting points from which to begin discovering the infrastructure environment, and because every organization is different, the discovery methods to be used reflect this variety.

Locations

Few modern businesses are based in only one location. Even small- to medium-sized enterprises often use remote workers and spread their infrastructure over more than one site. It is essential to understand the variety and range of locations over which the infrastructure needs to be managed. One example of where to begin to define the scope of the IE SMF is to start first with the central data center environment and then extend the scope of IE control from there as the management of the infrastructure matures and benefits to the IE policies/activities are seen. Conversely, it might be decided to identify the full range of possible infrastructure locations first and then work within this range to define a smaller starting point. In any case, understanding the range of locations helps avoid costly remedial changes in the future due to ignorance of some planned change and allows for scaling up the scope of control when the use of the SMF matures.

The majority of organizations should have the details of the physical locations, installed technologies, and infrastructure components that they operate at hand. More difficult to define may be offshore or outsourced functionality or the use of remote workers. If there is a configuration management database (CMDB) within the organization, ideally it should contain information about assets in all locations.

Technologies

Another approach to investigating the infrastructure is to inventory the types of technology in use and the existing standards, policies, and processes used to manage it. For example, you will want to collect all available information about server hardware: brands, sku, suppliers, configuration, and procurement policies. Although you will perform a detailed classification of this information in a later step, to begin you should strive to obtain complete information about the technologies and processes in use in your infrastructure.

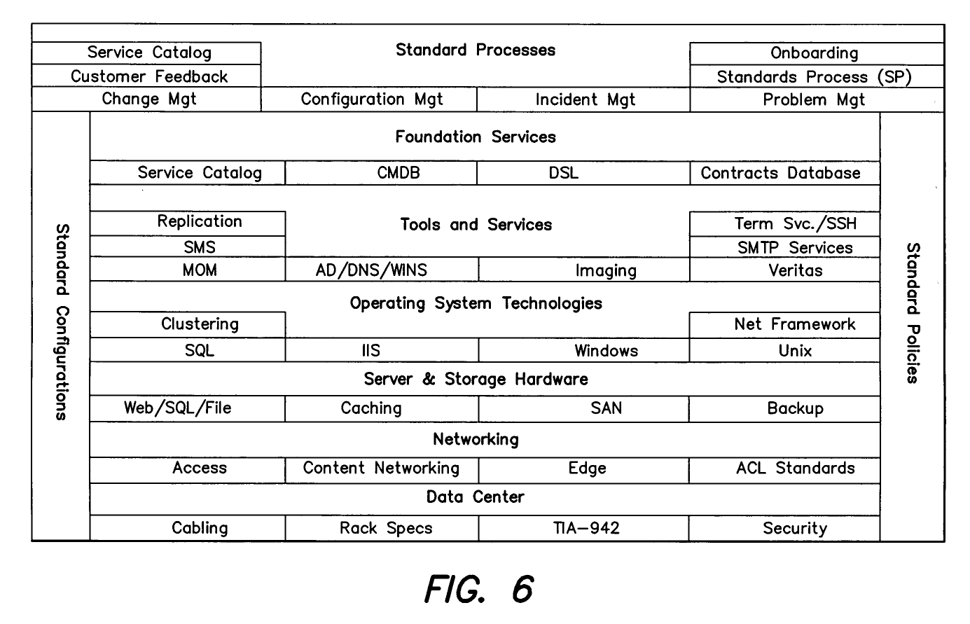

Within Microsoft, MSN has created categories and subcategories for a variety of technologies, as shown in FIG. 6.

When developing your own categories, you should consider including the following, as a minimum. The list below is not all-inclusive.
Data center hardware devices and configuration
Storage and backup devices and configuration
Core network infrastructure devices and configuration
Wireless or mobile connectivity devices and configuration
Desktops and mobile devices
Service provisioning software: Microsoft Exchange, SQL Server™, etc.
Standardized productivity software (corporate desktop)
Line-of-business software
   Sources of Information

The discovery exercise should utilize information from many sources, some of which are suggested below, in order from most to least comprehensive. The objective of this exercise is to focus on information sources that will provide the greatest amount of information with the least amount of effort. If additional detail is required during the standards-setting phase of implementation, it is always possible to revisit the area. It is important to balance completeness of information with the reality that you will likely not require explicit standards and policies for relatively insignificant parts of the infrastructure, so plan your use of investigative resources wisely.

Service Catalog

The first step in the discovery process is to examine the service catalog that is maintained by the Service Level Management SMF. If this is present in the organization, it will contain a comprehensive list of the services delivered by the IT organization. This catalog will ideally list all the service components used to deliver the service and should document the extent of the infrastructure in use, as well as the criticality of the elements to the organization as a whole. The service catalog suggests logical infrastructure environment categories that relate infrastructure components by their importance to the business. For instance, the service catalog would specify the service level agreement for backups (including restore time, backup window, backup success rate, rotation, and retention policies). However, the underlying technology for performing these backups, including the storage media, backup devices, backup software, and agents, should all be strong candidates for standardization.

Configuration Management Database

After the service catalog, the configuration management database (CMDB), if present within the organization, is next in line to be queried for details about the IT infrastructure. An effective CMDB will have quality, current data. Keep in mind that the CMDB content is still only as complete as the individual organization's level of configuration item (CI) recording. If the CMDB process is not mature, crucial information may be missing. For more information on CMDBs, visit the Configuration Management SMF guide at http://www.microsoft.com/mof.

Definitive Software Library

The definitive software library (DSL) should be consulted to obtain a definitive list of the software in use within the organization. Depending upon the operations maturity level of the organization, this list might not exist; if it does exist, it might not be fully inclusive of all products being used. Despite possible deficiencies, the DSL might be sufficiently complete to provide adequate information about key software usage.

Published Documents or Files

As a final step in the discovery process, the IE implementers should seek local documentation of various sorts. Various groups may document their infrastructure in Microsoft Word or Excel documents, or even on hardcopy forms. If this type of documentation is in use in the organization, it should provide information about the processes being used in the management and operation of the infrastructure. Document collections of this nature are unlikely to be centralized. More frequently, they exist locally, within departments or groups assigned to a specific function area or category. However, even these will provide some assistance in further scoping the infrastructure to be managed. These libraries should then be moved to corporate IE for wide access across the organization.

Contracts Database

If the organization has policies established for procurement or has implemented the Financial Management SMF, information should be available regarding the contracts currently in place. This information should be helpful, especially in reviewing purchased software and licensing, hardware products, outsourced facilities, and infrastructure—for example, power provision or ISPs, partners, and strategic relationships. As well as giving the current picture, details contained in a contracts database can be useful in scoping the extent of license agreements and partnerships by indicating length of tie-ins, renewal agreements, or expiration dates.

Once the information pertaining to the infrastructure has been gathered and there is confidence that the collected data is complete and accurate, you can begin categorizing the environment.

Create Guidance Categories

Categorization is the process of dividing the infrastructure into manageable and sensible sections. This is done to facilitate the development and management of similar standards and policies within a single group. In many cases, this is simply the recognition of existing categories or IT divisions. In others, it makes sense to split or merge existing divisions to accomplish the task. Categorization might occur along one of several different lines, each providing a different perspective of the IT environment. Examples include, but are not limited to:
Groupings based on table definitions and classifications within the CMDB.
Role cluster groupings assigned similar areas of responsibility for service functions.
SMFs responsible for coordinating the various areas of the infrastructure.

Keep in mind that this should be a simple process. The groups you create should be sensible and manageable groups of components, with commonality of purpose. In most organizations, the categories should become self-evident as you investigate the infrastructure.

Define the Scope of IE Guidance

In any organization, decisions must be made about which categories to manage and which to defer from standards compliance.

Categorizing and grouping similar infrastructure types, products, and services allows further refinement of the scope of the infrastructure being controlled. There are many examples; some will be specific to each organization. Several examples follow.
Data Center Standard Images. The data center environment is mission critical and highly dynamic. It is a corporate resource that depends upon the installation of consistently reliable components to achieve its mission; it is not an IT resource conducive to experimentation or incompatibilities. For these reasons, a key area for the implementation of standards is the data center hardware and server images. Although individual servers may be provisioned for a variety of server roles on a custom or semi-custom basis, it is important that the base servers be utterly reliable, with a well-tested and understood server image. The prudent IT organization will develop and maintain standards for the configuration of baseline servers in several roles, which may then be provisioned according to the service and service levels that have been negotiated.
Voice and Data Services. Many organizations outsource their communications services to a recognized supplier in that field rather than running it themselves across all their locations; in practice, national networks for telephony often rely on the use of commercial suppliers. The decision of whether to document standards for these services depends on the end use of the standards. For some organizations, this infrastructure element might be considered out of scope because it is provided externally and is supported by a contract and, ideally, an SLA. As long as the service is available when it is needed, no further management of the infrastructure that provides it may be required.
Conversely, for an organization that is actively expanding, it could be crucial to document standards for voice/data services for easy accessibility for future site development or to accommodate changes in vendors. There might be a need for scalability, however; and in some organizations where there is internal responsibility, there might be some input required for the way this infrastructure is managed and controlled up to the point where it is handed over to the external supplier.
New Technologies and Legacy Systems. As services become obsolete, they generally are phased out as new services are phased in. In some cases, however, legacy systems may remain for a period of time. This may occur because the solution works acceptably without the need to update it, because no update is available, or because it is not a critical function.
In contrast, organizations that rely upon implementing the latest technology in order to maintain a competitive advantage find it crucial to adopt cutting edge infrastructure components. This might also be done in phases to avoid large scale work disruptions or because only certain groups require the enhanced IT service or functionality. Some organizations recognize the phased nature of infrastructure rollouts by managing standards throughout an established life cycle. For example, MSN, in managing its online operations, manages standards and policies for its mainstream operations by designating preliminary, current, and retiring versions of a standard. The MSN approach is further described in the following section.
   Standards Life Cycle

Standards, or packages of standards, tend to follow a relatively predictable life cycle in most organizations.

The life cycle phases of a typical standard are as follows:

T0. The organization may propose a “preliminary standard” to govern the early adopters of newer and emerging technology, who will begin experimenting with and/or utilizing this newer “non-standard” technology. These early adopters will then typically contribute their knowledge and experiences into the standards development process.
T1. The organization formally proposes and ultimately approves a standard for the use of the new technology. Following the approval and publication of the new standard, the majority of other users will begin the process of becoming compliant with the new standard.
T2. Approximately 90 percent of the governed communities will have become compliant with the new standard. As the standard ages and technological developments continue, newer technologies will again begin to emerge by time phase.
T3. A new standards cycle must start again. At this point, compliance with the current standard will begin to erode as early adopters leave the current standard and begin to work with the emerging technology/standard.
T4. Is a representation of the mass adoption of new standards.

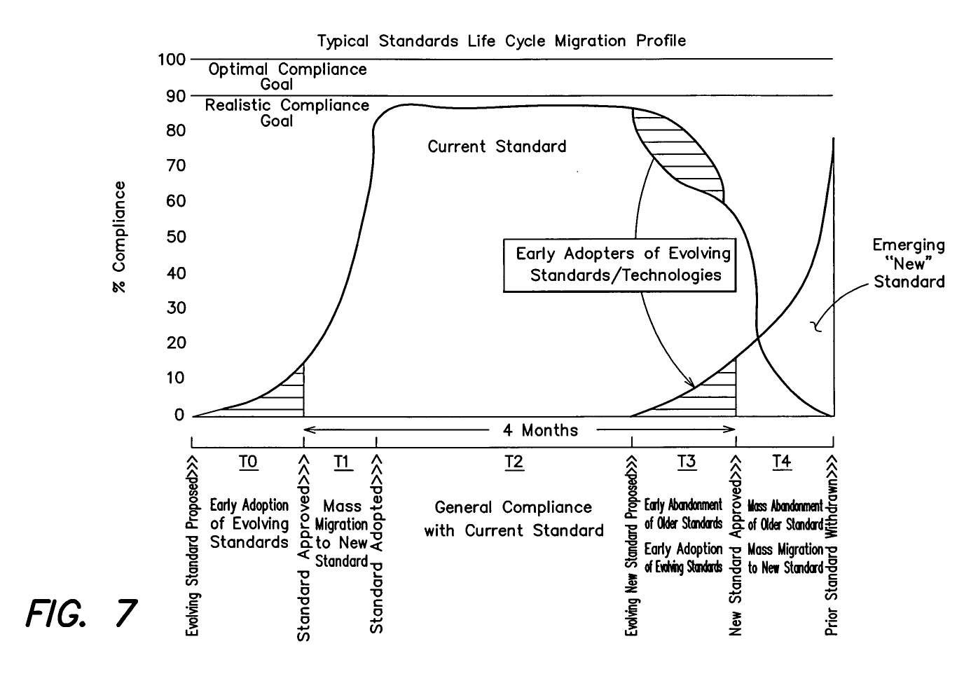

FIG. 7 depicts one full life cycle of a standard from the early development of requirements of the standard through to the ultimate withdrawal/retirement of the standard.

Standards Versioning

In order to manage the versioning of standards and the orderly transition through their overlapping life cycles the currently approved/active standard is given the designation of N. The newly emerging standard is designated N+1 and the standard immediately prior to N, the one that is being retired is designated N−1. Every standard during its life cycle will go through each of those phases/designations. The designations and descriptions of the N versioning model are shown in Table 1.

TABLE 1

| Version | Stage | Description |
|---|---|---|
| (N − 1) | Trailing | The standard is still valid; however, |
| | | not current, and will soon be retired. |
| (N) | On-boarders | The standard is current. |
| (N + 1) | Innovators | The standard is valid; however, |
| | | not current, but will become |
| | | the next current. |

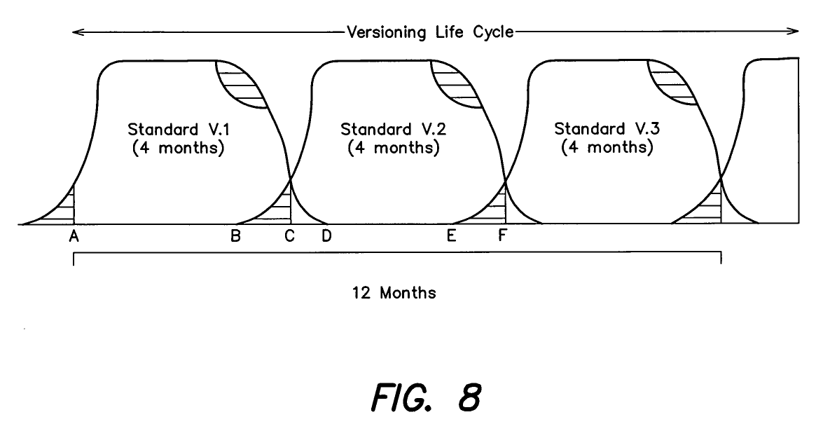

As shown in FIG. 8, this entire cycle iterates throughout the life of the standards process.

TABLE 2

| Cycle | Description |
|---|---|
| A-B | During time period A-B, Standard V.1 is the currently active |
| | standard and is designated N. |
| B-C | During time period B-C, Standard V.1 remains the currentlyactive |
| | standard and is still designated N. |
| | In addition, a new/revised standard (Standard V.2) has been |
| | proposed and is being tested/deployed by some organizations. |
| | The newer standard is the forerunner of Standard V.2 and is |
| | designated N + 1. |
| C | At time point C, the proposed new standard (Standard V.2 becomes |
| | approved and is now the currently active standard. It is now |
| | designated N. In addition, the earlier |
| | standard is now being withdrawn and is no longer |
| | current. It is now designated N − 1. |
| C-D | During time period C-D, most clients migrate to the new standard |
| | (Standard V.2) and some clients remain on the old standard |
| | (Standard V.1). |
| D-E | Most clients are now compliant with Standard V.2. |
| E-F | We now see a repeat of the cycle referenced in time period B-C. |

Based upon the cycles shown in Table 2, the adoption and retirement of standards is shown to be a predictable, cyclic process. MSN applies this model in its standards deployment. This model provides for early communication of both client and operations standards requirements, predictably scheduled releases of “bundled” standards, and the opportunity for both advanced lab and pilot testing. All new MSN standards (bundles of standards) are released on a 4-month cycle basis.

This example illustrates the decisions to be made when considering which standards to document or manage and which to leave unmanaged. If an infrastructure component, service, or subsystem is not working effectively with other systems within the organization, then a new solution may be contemplated and a policy might be created for this transition. If it would not be cost effective or beneficial to manage and control these systems, then they should be considered as out of scope. However, as new standards are written, as shown in the MSN example, it may become more practical to manage a dynamic set of standards as the organization matures in this SMF.

Special Considerations

The organization may establish a policy that if a category is not included within the scope of controlled IE, that category must nevertheless have a clear relationship and review process with the IE SMF. In some cases, the points that interact with managed categories may be subject to IE control at—for instance, where a product is handed over to a third-party provider or where a new power requirement is made.

Summary

The following list summarizes the important points discussed in this section.
Document the details of your infrastructure, using available resources such as service catalog, CMDB, and other references.
Create categories to logically group the elements of the infrastructure environment that will require standards and policies. The categories should be devised to simplify the assignment of responsibilities to subject matter experts for subsequent development of standards and policies.
Scope the extent of the infrastructure that will be subject to guidance or regulation through the application of centralized standards and policies. Not all parts of the infrastructure will require such control.
Align categories and scope with existing processes within the organization for best efficiency. For instance, to achieve maximum benefit, the CMDB categories should align IE processes with existing service management processes in the organization.
Add the documented infrastructure environment to the CMDB as a configuration item.
Review the infrastructure environment categories and scope periodically to determine whether changes are necessary.
   Define Standards and Policies

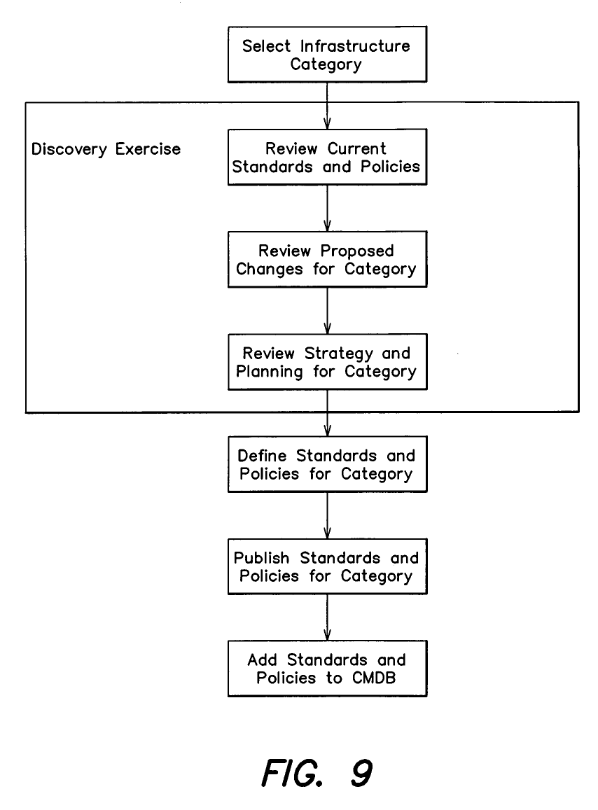

This section describes how to best define the standards and policies to be employed within each category of the infrastructure. It is important to note that this iterative process shown in FIG. 9 is carried out for each of the categories defined in the infrastructure environment. It includes a discovery exercise to be carried out within the organization to determine the current status of standards and policies within each category and to find out if any activities within the category are currently regulated.

This exercise has as its goal the identification of three elements:
Existing standards and policies
Infrastructure changes currently underway (to which no standards yet apply)
Proposed changes being developed (to which no standards and policies yet apply)

The output from this exercise is used to decide the best-fit standards and policy solutions for the category. This decision-making process will involve all relevant parties who can contribute to the definition of new or modified standards or policies. The defined standards and policies are then documented and stored in the CMDB as configuration items.

Select the Infrastructure Category

To begin the standard and policy definition process, select one of the infrastructure categories. It may be useful to make this decision strategically since areas that have the most impact on the organization can assist in demonstrating the benefit of the IE SMF. Thus, you may wish to select categories for initial policy and standard definition where you expect to see the most benefit from the outset. For example, you may choose to develop a policy for the use of change management first since this affects all business and IT areas. In another organization, perhaps one experiencing rapid growth, it might be more important to develop standards for the corporate desktop configuration and deployment process.

As the definition process continues, subsequent categories may be selected by the IE manager based on other criteria—for instance, available resources, skills, impact, or cost. In any case, since business benefit is the overarching objective of service management, it would be sensible to base decisions on the realization of financial and business benefits.

Review Current Standards and Policies

Within a given category, the previous investigation process may have documented a variety of different standards and policies. Some of these may overlap or conflict; in other areas, the existing standards may leave gaps. The objective of this standards review is to develop a unified view of the existing infrastructure standards and compare it with the desired scope of standardization decided upon previously. In the process, the review group will apply input from the subject matter experts, representing the stakeholder groups, to make appropriate recommendations. The goal of this exercise is identify:
Obsolete standards to delete or update.
Conflicting standards subject to deletion or merger.
Out-of-scope standards to be eliminated from further consideration.
Gaps that require the development of new standards.
   Review Proposed Changes for the Category

In the previous activity, you essentially developed a plan for consolidating and upgrading your existing IT standards and policies. Now it is recommended that you “future proof” this proposed effort by examining any changes currently in the pipeline, whether in development or underway elsewhere within the change management process. New initiatives might indicate a move away from a certain technology solution or software product—for example, migrating to Microsoft Windows® XP or moving from Lotus Notes to Microsoft Outlook®. New projects might also be underway—for instance, to consolidate all desktop computers to a common build or to move to a new location that uses wireless technology.

The change management process, in conjunction with the CMDB, identifies all changes in the system for the category. It is also useful at this stage to judge whether these changes have been outstanding for a long time or are more recent because they might become useless if there is a decision made to use a specific policy or standard for the category. For instance, a change might have been requested, but not yet authorized, to implement a printing solution using a new version of a technology, but 90 percent of the organization is found through the discovery exercise to be using a different technology. This information might be sufficient to alter the change request to a pending status until the decision on the IE policy is made.

Another example might be the development of policies within service monitoring and control to monitor certain network functions and to write a detailed set of policies to do so, only to find that these would be quickly superseded by the installation of a new Management Pack for Microsoft Operations Manager (MOM). Future proofing allows you to avoid the wasted expense of developing standards and policies for infrastructure that is due for significant alteration, or even abandonment, in the near future. If you determine that a category is in the planning stages for migration to a new system soon, for example, you might elect to postpone further preparations to control that category. The development life cycle will also be able to advise, through the change management process, of any changes to the infrastructure category that are in development, under research and vision scope, or due for imminent release. This information allows IE to build up a picture for the category on what is happening not only in the present, but what can be expected to happen in the short- to medium-term future. The more information available, the easier the decision should be for defining the best way to move forward. Approvals made as part of the change and development management processes should ensure that requested changes are cost justified and well documented before being authorized to continue.

Review Strategy and Planning for the Category

In addition to reviewing changes and development projects in progress, it is also useful to review strategy developments for the future. For instance, the business organization may have a strategy to outsource a telemarketing team within three years; this would affect the standards applied to long-term voice and data solutions. This strategy would obviate the need to update telephony solutions for this area of the environment. Similarly, a decision to move to a wireless technology, with an expected 40 percent increase in the number of telecommuting employees, would necessitate new requirements for the network category in the future and a corresponding reduction in investment in office-bound desktops in favor of mobile solutions.

A primary role of IT, and IE specifically, is to ensure that the IT infrastructure can enable business innovation and provide functionality to take advantage of market opportunities whenever possible. Tracking this type of strategic decision making requires that IE be recognized as a key stakeholder by the strategic business and IT decision makers in the organization. As the benefits of an effective IE process become apparent, it should be easy to gain the necessary buy-in from the senior level to share in this information.

Define Standards and Policies for the Category

Once there is an understanding of the existing, future, and strategic influences on the infrastructure category, it is then possible to define the standards and policies relating to that category.

Previous work has defined what standards and policies, if any, exist at present. It has also highlighted recognized conflicts and needed updates or deletions. Change records and development plans define the future for the category in the medium term, and the strategic plans for the business define the requirements for the category in the long term.

The standards and policies that are defined become the tools IE uses to progress from the current state to the desired state.

What is a Standard?

A standard typically describes objects within categories. It is defined as something established by authority, as a model, example, or a rule for the infrastructure component or category. For instance, a standard for the change management category might be the minimum requirement documentation for an RFC, including the format in which it is submitted. A standard for vendor management could be a vendor contract template, and a standard for COTS software could define the minimum requirements for compatibility with other in-house products. Typical standards within an organization include the hardware specs and configuration for a data center server or desktop computer. An example of a server standard is supplied below.

The standards for each category are likely to be more numerous than the policies for each category because they are more tactical. Standards are created with the current environment in mind and with an eye on the future. For instance, a standard requirement for a desktop build might take into account what is needed currently, but it might also include the capacity to integrate wireless technology if there is information from the strategic directions group that this is going to be developed in the future. Standards allow a structured and controlled approach to operating, changing, supporting, and optimizing the categories in the infrastructure environment.

What is a Policy?

A policy differs from a standard in that it is a defined management course or method of action to guide and determine present and future decisions. It is created to embrace the general goals and acceptable procedures of an organization. A policy can be a corporate-wide one, such as, “No political e-mails will be sent using corporate resources,” or a department-specific one, such as, “All purchase orders for equipment over $20,000 must be approved by the general manager.” Policies in IE, in simple terms, describe processes applied within categories. For instance, a policy for change management processes would describe how those processes are used in the organization; a policy on vendor management would define how vendor management processes are used in the organization; and a policy on commercial off-the-shelf (COTS) software would define how to use processes for COTS software in the organization. These policies are attached to the infrastructure categories that have been defined and act as the defined management actions for best practice control of the infrastructure environment. They are created in line with the requirements of the infrastructure now and in the future. Examples of typical policies are provided below.

Defining the Best Standard

As described earlier, standards answer the following tactical questions for the infrastructure category: “What are the ways we want the category to operate in our infrastructure environment, and how can we ensure the functions in that category are managed and controlled as we expect them to be?”

Each category is likely to contain multiple standards at the outset, depending on its scope—for instance, security requires standards for dealing with security for users, data, network, infrastructure, specific solutions and services, and specific locations. Standards might already exist within SMFs or other functions already deployed in the organization. During the discovery phase, these standards will have been exposed; in this phase of the process, a decision is made for which, if any, standards or policies should be retained as-is or with modification. In some cases, similar standards from complementary organizations might be merged. In other cases, a particular location might require a separate standard that is applied locally, although these decisions should be based on careful analysis to ensure that a disparate standard won't ultimately incur added expense and maintenance overhead. Table 3 shows some examples of standards that might be applied within categories associated with the MOF Infrastructure Role Cluster.

TABLE 3

| MOF Team | | |
|---|---|---|
| Model Role | | |
| Cluster | Infrastructure Categories | Standard Examples |
| Infrastructure | Workforce Management | Job descriptions and |
| | | requirements for defined job |
| | | categories |
| | | Compensation model for |
| | | system engineers |
| Infrastructure | Resource Planning | Acceptance testing reporting |
| | | format |
| Infrastructure | Capacity Management | Default topology for capacity |
| | | modeling |
| | | MOM agent configurations to |
| | | report performance metrics |
| Infrastructure | IT Service Continuity | Standard backup requirements |
| | Management | for e-mail server |
| | | Backup requirements for file |
| | | servers |
| | | Hardware specifications for |
| | | backup tape drives |

The discovery process might have identified a range of standards that all apply to the same category. In this case, it must be decided by input from the key stakeholders which are the best standards to apply for now and the future. The discovery exercise will also likely discover gaps where standards and policies do not currently exist but would be beneficial; these should typically be created by the subject matter experts in that field with input from other stakeholders, best practice advice, and the business strategy for use of that infrastructure category.

Microsoft IT and Standardized Server Platforms

In some cases, standards might not be applied as a set of specifications, but as a complete customer-oriented solution. For example, the Microsoft internal IT organization has adopted an effective approach to the standardization of data centers. Through a recent platform standards initiative, the IT group develops, tests, and delivers standardized Microsoft baseline server platforms called IPAKs (Microsoft IT Service Packs). These are created for Microsoft Windows Server™ 2003, as well as for SQL Server. IPAKs are issued every two quarters, and combine current version server software with all current hotfixes and patches. These configurations are thoroughly tested by the IT group and offer assured reliability to customers upon installation. For customers, this significantly reduces the complexity of installing patches on a regular basis.

Microsoft IT offers a sliding scale of support to internal Microsoft customers based upon the level to which the customer has adopted the IPAK standards. Between releases, Microsoft IT provides full support to customers running either of the two most recent IPAK releases. Older versions are supported on a “best-effort” basis.

Interim patches and fixes between IPAK releases are integrated into subsequent releases of the IPAK. Users may wait until a new IPAK release or may incorporate approved stand-alone patches into their own server. In either case, the IT group will provide full support to the extent of their service level agreement.

Whatever the situation, the standards are created with input from functional area subject matter experts, MOF Team Model role clusters, external benchmarks where appropriate, and business need and cost. No element of the infrastructure really stands alone; each standard must take into account the interacting infrastructures and the larger strategic picture. That is, all elements of the infrastructure link together effectively to support the business, complementing and enabling it.

Defining the Best Policy

As mentioned previously, there should be fewer policies than standards for a given category since policies tend to operate at a higher level than the more prescriptive-level standards. Occasionally, more than one policy for a given category may be necessary—for example, where multiple regions within an organization use different strategic partners for a product, there might be a policy for purchasing a product in each different region. Similarly, geographically separated branches may require different policies to accommodate variations in governmental regulations or operating requirements. However, since the goal is to create a consolidated and strategic set of solutions, too much variety in policies should not be encouraged since it might affect the potential cost savings and repeatability of a solution.

In defining the best policy for the organization, the following inputs should be considered:
Existing policy and documentation
New information that might become available through change management processes or development initiatives
Strategic information for the long-term plan
Information and recommendations from subject matter experts, internally and sometimes externally
Other SMFs or role clusters that might need to be informed

Through the consolidation and collation of all this information by the IE SMF, a best-fit policy can be created for control of the category or portions of the category. The best-fit solution needs to address:
Budget: Cost justification and approval.
Timescales: Present and future.
Potential risks and issues from choosing the policy.
Technology: Impacts on the targeted category and on other related technology within the infrastructure.
People: The skills and resources available to develop, implement, and support the defined policy; the buy-in needed to utilize the policy; the benefits to people of using the policy; and how people will react to the policy.
Process: The process or processes to which the policy applies and by which it interacts with other processes.

The decision-making process for defining the best policy can utilize any strategic decision-making tools and methods at the organization's disposal. In most cases, individual standards or policies will be assigned to a subject matter expert, who is responsible for delivering a complete standard or policy to the IE manager, who then distributes it to stakeholders for feedback prior to final approval. Table 4 provides examples of some specific standards and policies that might be implemented within operations categories. Similar tables should be developed to plan the development of standards and policies in the other categories established for your organization.

TABLE 4

| MOF Team | | |
|---|---|---|
| Model Role | | |
| Cluster | Infrastructure Categories | Policy Examples |
| Operations | Network Administration | Announcements for scheduled |
| | | system maintenance |
| | | Non-business use of computers |
| | | Assignment of IP addresses |
| | | Troubleshooting procedures |
| | | Network hardware procurement |
| Operations | Job Scheduling | Applying job scheduling |
| Operations | Storage Management | Storage device maintenance |
| | | policies File name conventions |

The level of effort applied in developing a policy will reflect the importance of its category. For example, a policy for a high-profile category, such as data integrity within a banking organization, will require a precise definition, might be very complex, and will require input from accountable parties throughout the organization. This might include input from legal departments on the official requirements and from technical staff on the capabilities of their components to deliver a secure solution. This policy will be a critical one for this organization. It must be carefully cost analyzed and evaluated to ensure consistency with future strategies, and it must be approved at a very senior level. Conversely, consider a policy related to the process for disposing of old toner cartridges: this is less likely to require the same sort of inputs but could still be cost effective for an organization if recycling opportunities and cost savings are explored. If the organization uses the best-fit solution, strategic input, and cost benefit for selection of the policies for each category, it should obtain the longest usability, highest supportability, easiest operability, and best functionality.

The creation and use of policies in the infrastructure environment will likely result in realizing at least some, if not all, of the following benefits:
More integrated strategic planning and reduction in piecemeal contracts.
Better decision making in the purchase of products with reasonable shelf lives.
Better value for money invested.
Better cost management through effective purchasing and use of strategic solution providers for enterprise-wide solutions.
Better retention of skilled staff, thereby reducing training and recruitment costs.
Improved consistency in making infrastructure choices. More appropriate usage of infrastructure resources.
Service improvement through integration of service management policies.
Higher confidence in supportability and operability.
Lower effort required in administration.
Simplified and repeatable deployments.
Better-integrated applications.
   Publish Standards and Policies for the Category

The defined standards and policies are truly valuable for the organization only if they are accessible and easily understood. For this reason, attention should be paid to the most effective method for publishing and publicizing the standards and policies to the target audiences who need to be aware of them. A common means for publishing standards and policies is through a widely publicized internal Web site or knowledge base. To achieve maximum benefit from this type of distribution, it is important to consider that the potential audience includes non-technical business users and to present the Web content so that all users can easily understand it. An alternative to a Web site would be to publish the standards as content within an intranet-accessible knowledge base. In the case of MSN, an intranet site was built that not only publishes approved standards, but manages the change process for proposing, approving, and adopting new standards.

Other alternatives for publishing standards include CD/DVD or hardcopy distribution. For all distribution mechanisms, it is crucial to synchronize the published content with the most current version of standards and policies written to the CMDB. If direct links are not made to the CMDB to refresh the content on Web sites or knowledge bases, then a manual or semi-automated refresh must be scheduled on a regular basis: this could be weekly, monthly, or quarterly depending on the number of changes made.

By making all the standards and policies accessible to the entire organization, you create an open arena and minimize the risks often caused by lack of awareness of specific system requirements. You also make known the requirements for interfaces among other systems within the infrastructure. It is useful to note that misinformation is prevalent in organizations; these standards and policies represent correct information that people have been waiting to have made public. Once the standards and policies are published, they are likely to become widely used, thereby making future updates and contributions to change or adding standards and policies even more likely.

Add Standards and Policies to the CMDB

Once the standards and policies have been defined and accepted for publication, they should be added to the CMDB. This ensures that the documented standards and policies are under the same change control as any other configuration item; it also means they come under the standard review process for CIs.

The benefit of adding the standards and policies to the CMDB does not end with change control. It allows relationships to other standards and policies to be indicated and associated, and these links also can be applied to other CIs. This mitigates the risk of solitary action taking place, for instance, on a standard that could affect entire sections of infrastructure policy. This demonstrates further control of the infrastructure and shows the benefit of taking the full service management approach to the IT organization.

The CMDB is accessible in read-only format for most users (except for the configuration manager and administrator, who retain full privileges). If the CMDB is reportable and understandable by the business, it might not be necessary to maintain a published version of the standards and policies; instead, access to the CMDB can be given to all who need it. However, if the CMDB is complex in approach, the standards and policies content could be linked to published policy on an intranet or other easily accessible source. This would be of particular benefit to the business and facilities organizations as they might need a business-friendly, non-technical reference to the standards and policies to apply in managing business projects and facilities.

Summary

The following list summarizes the important points discussed in this section.
Prioritize the definition of standards and policies on the basis of greatest benefit to the organization. Early wins will help develop credibility.
Baseline the current infrastructure, including existing standards and policies, for future reference.
Review plans and strategies for future projects and initiatives to prevent rapid obsolescence of newly created standards and policies.
The complexity of standard and policy definitions correlates to their complexity and potential effect on the organization.
Rely on appropriate roles and SMEs in creating standards and policies.
   Apply Standards and Policies for Infrastructure Guidance

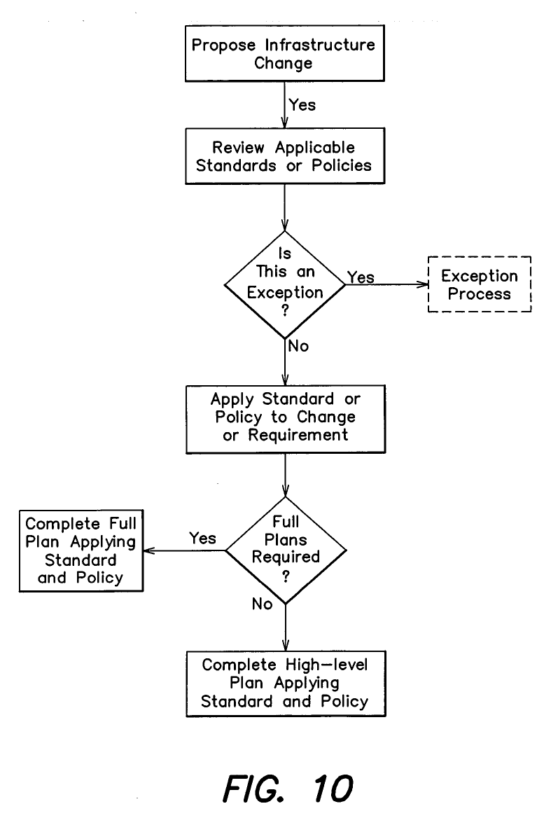

Ordinarily, proposed changes for development or deployment will fall within the norms of the established standards and policies; the process by which these are applied is described within this section. There are times, however, when a proposed change requires special considerations that will result in an exception to the established standards and policies. In addition to the normal process, this section also examines in more detail how these exceptions can occur and what actions can be taken by the infrastructure engineering manager to deal with them when they arise. FIG. 10 illustrates the normal process for the application of policies and standards and shows where exceptions to the process branch into a separate task loop.

Propose Infrastructure Change

Proposed changes to the infrastructure may arise for a variety of reasons. Microsoft Solutions Framework (MSF) provides considerable detail about the envisioning process for new development and deployment projects. As the project plans begin to solidify, the team must consider what services and components of the infrastructure will be affected and identify the applicable categories of standards and policies that must be referenced.

For example, new projects and development initiatives will apply the standards and policies when reviewing their limitations and scope in the context of developing their new solutions. Facilities may want to check minimum power requirements or security policies for certain infrastructure categories. Any changes, additions, removals, or new developments and projects will need to utilize the standards and policies for the infrastructure category they will affect.

Proposed changes to the IT infrastructure follow a prescribed process in MOF, as described in the MOF Change Management SMF. As proposed changes progress through this process, they are guided by MSF principles for project management as well as MOF guidance to ensure they will be operable in the production environment. The MOF Change Initiation Review, a major MOF milestone, is the first scheduled review of proposed changes to ensure that they are in compliance with approved standards and policies. The Change Initiation Review is one of four Operations Management Reviews, which are described in more detail in the MOF Process Model white paper available at http://www.microsoft.com/mof.

Review Applicable Standards or Policies

When an infrastructure change is contemplated, the applicable policies or standards can be accessed from the CMDB, the IE manager or, more likely, through the published source (for instance, an intranet Web page). In some cases, the IE manager or a designated SME may provide assistance in applying the standard to a proposed change.

Is This an Exception to the Standard or Policy?

What is an exception? An exception is a process, event, or acquisition to which the established rules do not apply. These should rarely appear since the IE manager has ensured that there has been input from the change, development, and strategy groups during the process of defining the policies and standards, but there may be occasions when a genuine exception may occur, in which case it will follow the exception process illustrated in FIG. 11.

Apply Standard or Policy to Change or Requirement

If the proposed infrastructure change is not an exception, the process continues with the incorporation of the specific standards into the requirements for the proposed change. Regardless of the nature of the change and its eventual application, it should be in compliance with the standards and policies established for that infrastructure category, exceptions notwithstanding.

Full Plan or High-Level Plan Required?

The extent to which policies and standards are included in a potential change depends entirely upon the nature of the change and its relevance to the scope of the regulated infrastructure. If it is a minor or standard change, then it may only need a sign-off within the change management process that affirms that the standards and policies have been used, similar to confirmation that the CMDB has been consulted to evaluate the impact of any proposed change. However, if it is a bigger change or development project, then standards or policies may contain specific design, build, or process elements that must be replicated within the project plans.

The results of the consultation will be that the change, addition, or development will in effect be planned according to the standards and policies in the IE SMF, although this checkpoint actually occurs outside of this SMF in the Change Initiation Review.

Exceptions to the Standards or Policies

As explained previously in this section, there are situations where established standards and policies may not directly apply. These are exceptions. Although an organization may maintain a set of standards or policies for a particular process or object, depending on the stage it occupies in the life cycle (as in the example of MSN with its set of standards for new, current, and departing technologies), sometimes an organization must also set up procedures for handling exceptions to the established standards and policies. FIG. 11 describes a process flow that reflects best practices derived from the MSN process for dealing with exceptions.

Exception to Standard or Policy Arises

When an exception arises, it is a requirement that does not appear to fit within the rule specified in the existing policies and standards. Why the proposed change is an exception needs to be confirmed before action can be taken. As mentioned earlier, if the IE SMF is running effectively and there have been strong relationships built with the other SMFs and the business, development, and strategy groups for the organization, then exceptions should be rare. In some cases, exceptions may evolve into new policies or standards as the IT infrastructure progresses through its life cycle.

Is the Exception the Result of a New Strategy?

If this is a new strategic direction, it should have been revealed through the relationship between the IE manager and the associated business strategy group. However, there may be occasions when a change in strategy might not be identified before a change is needed.

For example, a merger or acquisition of another company or hostile takeover bid could affect the policies and standards and change the requirements. A political or legal issue could also result in an exception if the contents of the new regulation have not been disclosed before being promulgated. Economic and political changes external to the organization could change the policy—for instance, shifting exchange rates could affect outsourced offshore services or a volatile political climate could affect the import and export of products or services.

Confirm Strategy for Infrastructure Category and Validate

If the exception is proposed as a new strategy for the organization, this must be confirmed with board-level representatives, subject matter experts, and the relevant SMFs (if required) and validated as a genuine exception to the existing policies and standards. If it is not a valid exception when confirmed with the higher level, then it is returned to the initiator with the explanation as to why it has not been accepted as a strategy change. There may be other reasons why the exception should be accepted, but these must be resubmitted to the IE manager following rejection from the board.

Is it a Valid Exception on Other Grounds?

Even if the exception request is not the result of a new strategy direction, there may be other reasons for allowing it. For instance, a third-party vendor or outsource partner might go out of business, leaving a gap in the supported infrastructure that must be quickly dealt with to ensure service continuity. As with a new strategy, changes can occur outside the organization on a legal, social, political, or environmental basis that have not been foreseen and which can constitute a genuine reason to institute an exception to the infrastructure policies or procedures. Security could be impacted by a new virus, and patch software from a non-standard organization may mitigate the risk, for instance. As another example, if a desired new technology is released, it may be necessary to establish a new lab to work with it before existing standards may be modified to reflect necessary changes in architecture or hardware requirements. In this instance, new hardware requirements, outside of existing standards, may also require exceptions to purchase and vendor policies if the equipment is not available through established channels.

Is it Cost Justified?

Even if it is a new strategy or an emergency exception to the existing policies and standards, the exception must still be cost justified. The benefits of the exception being allowed to proceed must be higher than potential costs, not only to the budget but also in the potential risk to the infrastructure caused by moving outside established policies and standards. This cost justification is carried out as it was in the initial stages of defining the policies and standards, although it may be fast tracked if required, with key individuals reviewing the exception and using a quorum to authorize it.

Approve the Exception

If the proposed exception is cost justified and accepted by the key individuals in that infrastructure category, SMF, or role cluster, it may then be approved. The exception may still need budgetary sign-off at the board level to implement it, and it must now be determined if any existing policies or standards need updating to reflect the changes introduced by the exception. The exception should also be assigned an effective duration in order to establish how long it may be used and when it should be re-evaluated for consideration as a standard or for retirement. This process can be fast-tracked, but it is important to recognize that any inputs for an emergency exception are as important now as when creating the original standards and policies. Key individuals still must look at the exception requirement and evaluate how it fits in with the current infrastructure environment and how it will affect other future strategies, changes, and developments.

Effect on Other Standards or Policies

If a new policy of standard is developed as a result of the exception, it is necessary to use the CMDB to reference related standards or policies and other infrastructure categories that may be applicable to the excepted one. It is not a certainty that an exception will trigger an update to the standard or policy—the exception may be a one-off isolated occurrence. However, exceptions may eventually require applicable standards to be rewritten or policies to be reconsidered. For instance, a policy to use a certain vendor would change if trust in that vendor was lost or if the vendor became unable to ship products without incurring extra costs for a variety of local reasons.

Most influences by which exceptions arise are likely to be external to the organization; otherwise their underlying cause would have been detected within the review, change, development, and strategy relationships the IE manager has built up with other areas.

Publish Standard or Policy and Update CMDB

The updated standard or policy is published and the CMDB is updated with the new version, including any updates to other related infrastructure policies and standards that may have been instigated by the change. Changes to the CMDB must also follow established procedures.

Summary

The following list summarizes the important points discussed in this section.
Avoid exceptions where possible. Careful planning and execution of standard and policy settings should avoid the need for most exceptions.
Treat exceptions as changes. They must be approved and cataloged just as standards and policies.
Justify exceptions by cost and business value.
Examine the effect of exceptions on related standards and policies.
   Maintain Standards and Policies

The previous section described how standards and policies are applied to changes that occur within the IT environment. This section describes how the standards and policies themselves should be managed. Standards and policies are stored as configuration items (CIs) in the CMDB; as standard changes they will follow the change process used for other CMDB changes, as described in the MOF guidance for the Change Management and Configuration Management SMFs. However, the review process for the standards and policies is presented here with additional detail to assist in effective maintenance of the collected standards and policies.

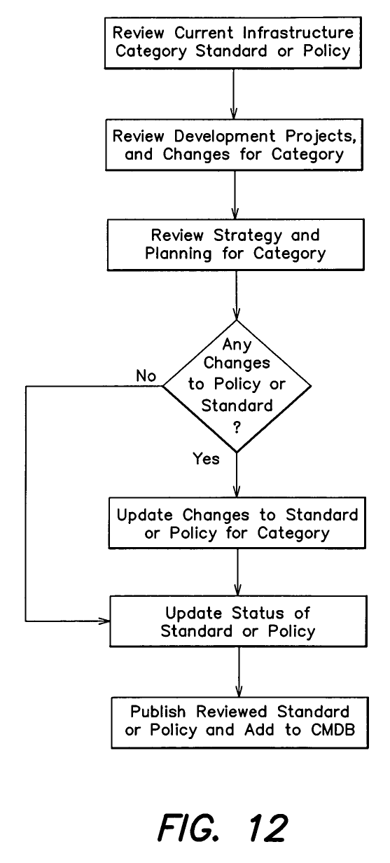

The standards and policies for each of the infrastructure categories should be reviewed on a regular basis. Reviews may be driven by changes to the existing policies and standards typical to the daily evolution of an organization, but it is also important to review the standards and policies that have not been highlighted or questioned by other changes or development projects. The timeline for reviewing the categories is entirely up to each organization and can be carried out by the role cluster responsible for input to the policy or standard or by the area with the most commonality to the category for the standard. For example, security standards and policies would be reviewed by the Security Administration SMF and Security Role Cluster, service desk policy and standards by the Service Role Cluster and, more specifically, the Service Desk SMF. The process for the review is detailed in FIG. 12.

Review Current Infrastructure Category Standard or Policy

It is useful to periodically review and report on the existing infrastructure categories, standards, and policies. If there are policies and standards that have been the subject of much change and many exceptions, it might be useful to re-evaluate if they are still relevant to the organization and, if not, where the shortcomings in the communication processes led to the mismatch. Similarly, there may be policies and standards that have not been accessed or utilized, which might indicate they are not adding real benefit through their inclusion in the IE control model. At this point, it is also useful to check compliance within the infrastructure with the published standards, using such tools as Microsoft Systems Management Server (SMS) 2003. A sudden decrease in compliance could reveal the adoption of a non-standard patch or perhaps implementation of a beta product prior to acceptance as a standard. Such reviews are useful as a “reality check” on the contents and can either be carried out on a scheduled basis or can be performed when deemed appropriate by the Team Model role clusters.

Review Development Projects and Changes for the Category

As the IE SMF evolves within an organization, so should the relationships with the IT development function, the project management function, and the Change Management SMF. Few surprises should arise as a result of milestone reviews for project development since all projects will be using existing policies and standards in order to work through the change approval process. It is worth noting, however, that if any surprises do occur in the pipeline of future changes and infrastructure development, this indicates that communication channels may need to be improved between those responsible. Action should be taken to address this as soon as possible, or the organization will not benefit from the integrated service management approach into which it has invested time and resources.

Review Strategy and Planning for the Category

As with the change and development relationship, there should be few surprises arising from strategic infrastructure planning if the IE manager has been successful in gaining senior and strategy group endorsement of the value of the IE SMF. If the IE processes are being perceived as valuable, the strategy planning group should not only be utilizing them, but demanding the creation of new policies and standards. The information held by the IE SMF can expose to strategists where corporate areas of potential reusability exist, where various skills reside in the organization, and what their current IT capabilities are. This can all be used to instigate cost-effective strategies for managing the infrastructure environment. It is important to remember that communication between the business strategists and the IE team should be two-way, providing information and guidance in both directions.

Are There Changes to Policies or Standards?

If there are changes to the standards or policies following the review, these changes should be initiated and directed through the change management process for CIs and the CMDB.

Update Changes to Standard or Policy for Category

Once the changes are authorized and planned, they can be deployed in line with the change management process and updated to the CMDB.

Update Status of Standard or Policy

The status of the CI for standards and policies should be updated in the CMDB. The suggested status for standards and policies changed as a result of the review process is Reviewed; it is also suggested that other status markers for standards and policies be used in line with those already used in the CMDB—for instance, Current, Retired, and Exception.

Publish Reviewed Standard or Policy and Add to CMDB

Ensure that any reviewed policy is republished and publicized to the Team Model role clusters and other audiences that may use it. If it is used regularly and has been altered, it is important to highlight the changes to the regular users to avoid any unintentional use of an old standard or policy.

Summary

The following list summarizes the important points discussed in this section.
Perform regular infrastructure reviews to ensure that standards and policies stay applicable.
Update standards and policies to keep pace with organizational requirements, applying change management.
   Roles and Responsibilities

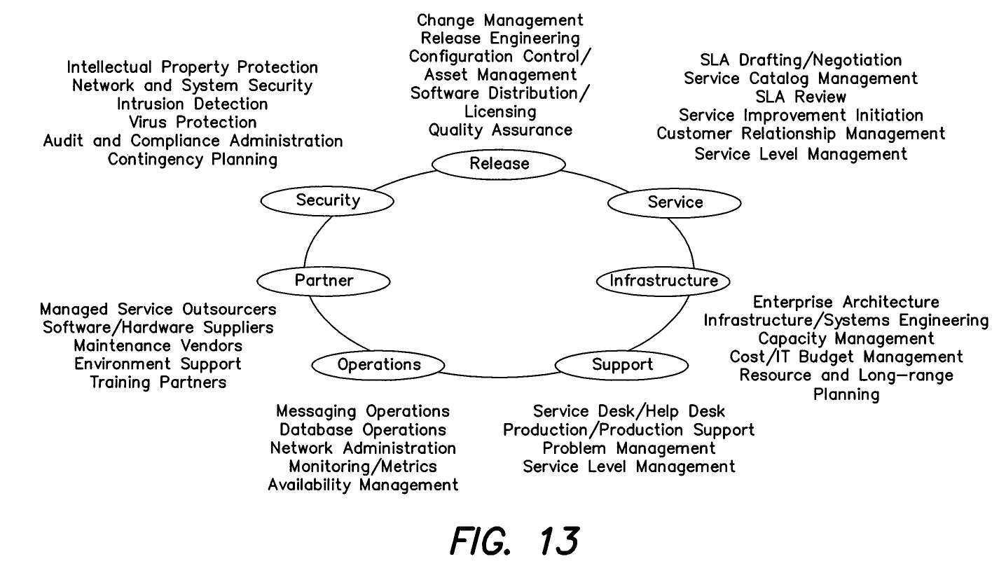

This section looks at the various roles and responsibilities within the Infrastructure Engineering SMF. It is important to note that the roles here denote groups of tasks to be performed and do not necessarily correspond to organizational job titles or specific individuals. The majority of effort expended in establishing and managing standards and controlling their application across the infrastructure will be performed by the MOF Infrastructure Role Cluster, with the select use of virtual teams. The MOF Team Model role clusters are illustrated in FIG. 13.

Infrastructure Engineering Manager

The IE manager has a coordinating role in the IE SMF, similar to that of the role of the change manager in the Change Management SMF. The role involves some technical decision making for approval and rejection of standards and policies, but in general the IE manager does not need to be technically cognizant of all areas of the infrastructure. Although IT infrastructure and engineering skills should be assumed qualifications for this role, the primary skill of the IE manager is the ability to extract the best information from the input groups, subject matter experts, Team Model role clusters, and business and strategy groups in order to come to agreement over a best-fit solution for the business.

In order to function effectively over such a wide array of groups and responsibilities, the IE manager role must be situated at the correct management level to be heard and respected within the organization—by the business and development organizations alike. Individuals filling this role need to have authority to reject non-standard infrastructure changes or development projects, or at least have a defined escalation path to senior IT executive committee members if they do not have the authority themselves.

Infrastructure Role Cluster

The Infrastructure Role Cluster has the quality goal of “management of physical environments and infrastructure tools.”

The roles within this cluster can perform many of the tasks reviewed in this SMF guide. The policies or standards within a particular infrastructure category will typically be assigned to their corresponding area of responsibility. For example, the standards and policies created for storage elements of the infrastructure will be part of a storage category, and the responsibility for input, maintenance, and updating of the standards will be carried out by those actively involved in the Storage Management SMF and Operations Role Cluster.

Relationship to Other Processes

This section examines the relationship between the Infrastructure Engineering SMF and the other SMFs in MOF.

Changing Quadrant

There are three SMFs in the Changing Quadrant; the IE SMF provides key input to all of them:
Change Management
Configuration Management
Release Management

It is useful here to review the diagram in FIG. 2 used at the outset of this document to illustrate the relationship between the Changing Quadrant and IE. The IE SMF controls engineering activities within the infrastructure, the Change Management SMF manages the infrastructure environment, and the Configuration Management SMF documents the standards and policies in use.

Change Management

The Change Management SMF has a close relationship with the IE SMF. The change authorization process described in the Change Management SMF has become formalized into the Change Initiation Review OMR in MOF version 3. This process, culminating in a formal review, requires that the initiator of a change complete the change request in accordance with the requirements for a change of that type and infrastructure category. For any change, the RFC should either apply the existing policies and standards for the change documentation submitted at the Change Initiation Review, or otherwise follow the exception process. Even exceptions must follow the change management process and as such have an important commonality with the Change Management SMF.

The change management process is, in itself, a policy. Changes to this policy must themselves go through change management. The Change Management SMF provides input to the IE SMF in terms of future changes that may be in development as these may affect the standards and policies being defined. In addition to this directly related input, the Change Management SMF itself will define specific policies and standards. The creation of these is formulated by the Change Management SMF, but agreement and administration and alignment of these to other SMFs is coordinated by the Infrastructure Engineering SMF.

Configuration Management

As shown in FIG. 2, the Configuration Management SMF stores the IE standards and policies as CIs in the CMDB and ensures they are under the same level of control and change management as the other CIs. The CMDB is a key source of information to the IE SMF during the setup activities, and the two are used in conjunction in preparing RFCs for change authorization. The CMDB holds all the information on the infrastructure categories, the services delivered by them, and the scope of their individual service components, so it is a valuable source of information in defining the scope and extent of the infrastructure environment.

It also facilitates, through its relational capabilities, the mapping of relationships between infrastructure categories, policies, and standards.

Release Management

The Release Management SMF contributes its own standards and policies to infrastructure engineering information on, among other categories:
Release build requirements.
Release acceptance criteria.
Release planning.
   Release Readiness Review

This review, the culmination of the change management process, applies infrastructure engineering standards and policies to confirm that current and appropriate policies and standards for build and standards for releases to different infrastructure categories have been used in the change and release development.

Operating Quadrant

There are seven SMFs in the Operating Quadrant; each is a valuable contributor to the standards and policies in the Infrastructure Engineering SMF. These SMFs all utilize standards and policies in their operation of the infrastructure environment to ensure it is operated in a controlled fashion. The Operating Quadrant SMFs are:
System Administration
Service Monitoring and Control
Network Administration
Directory Services Administration
Security Administration
Storage Management
Job Scheduling
   System Administration

The System Administration SMF contributes to the Infrastructure Engineering SMF standards and policies pertaining to the day-to-day administrative services that support the infrastructure environment and business functionality. The System Administration SMF guides the other SMFs in the Operating Quadrant and, as such, has a coordinating role in the use of standards and policies throughout operations. While the Infrastructure Engineering SMF is largely responsible for ensuring that IT standards and policies are applied in the development of new additions or changes to the infrastructure, the System Administration SMF fulfills a similar role in applying these to daily operations.

The system administration manager plays a key role in defining how administration services are provided and executed within the scope of the infrastructure environment—for instance, defining if the standard is centralized administration, remote administration, delegated administration, or distributed administration.

The System Administration SMF also uses the documented policies and standards input from other SMFs, role clusters, and infrastructure categories to ensure the integration and effectiveness of their own system administration solutions.

Service Monitoring and Control

Through the use of processes and technology, the Service Monitoring and Control (SMC) SMF allows operations staff to observe the health of an IT service in real time. SMC creates and uses policies for monitoring the services available and ensures that it is monitoring those services within the infrastructure environment. This activity adds real value to the business function. The standards and policies used by SMC in its monitoring function include, among others:
Defined thresholds for services.
Escalation policies.
Response policies.

It also uses standards and policies related to other infrastructure categories to plan future SMC requirements, changes, and improvements.

Network Administration

The Network Administration SMF is responsible for the maintenance of the physical components that make up the organization's network and as such is a key contributor to and user of the policies and standards of the Infrastructure Engineering SMF. The Network Administration SMF will contribute and coordinate input to policies for, as a minimum:
Network skills required.
Network management processes and procedures.
Network technology products and tools.
Approved network vendors and service providers.
   It will also develop standards, with other SMFs (if necessary) for, among others:
Managing network faults.
Modification and expansion of the network.
Security of the network.
   Directory Services Administration

The Directory Services Administration SMF is tasked with ensuring that data is accessible when it is needed by the authorized party. In this context, it is key for this SMF to use policies and standards, and it contributes to the definition of policies and standards in the areas of:
Directory standard types.
Network operating systems.
Special purpose directories.

As directory services deals with the day-to-day operation, maintenance, and support of the enterprise directory, it also provides input to and utilizes information from the Capacity Management SMF and other SMFs for standards and policies relating to other infrastructure categories.

Security Administration

The Security Administration SMF ensures a safe computing environment; policies and standards are key to its success in this endeavor. In defining a set of repeatable and strong security policies and standards for use across different infrastructure categories and in contributing to the further development, review, and increased maturity of these, the Security Administration SMF works with the Infrastructure Engineering SMF to deliver a secure, business-focused solution to security risks. Policies created by the Security Administration SMF include those supporting:
Data confidentiality.
Data integrity.
Data availability.
   Standards include those supporting:
Identification.
Authentication.
Access control or authorization.
Confidentiality.
Data integrity.
Non-repudiation.
   Storage Management

The Storage Management SMF deals with on-site and off-site data storage, restoration, and archiving. It aims to define, track, and maintain data for the production environment. It contributes to policies involving:
Handling classified data.
Outsourced data storage.
Data storing, restoring, and recovering.
   It will develop and contribute standards for:
Recovery requests.
Archiving data.
Media library.
   Job Scheduling

The Job Scheduling SMF involves the efficient organization of jobs and processes. It aims to meet agreed service levels and to use capacity effectively and, as such, can contribute to and use policies and standards that look at, for example:
Scheduling procedures.
Capacity.
Bandwidth.
Batch processing.
Scheduling tool utilization.
   Operations Review

The OMR associated with the Operating Quadrant is the Operations Review. Its primary function is to assess the effectiveness of internal operating processes and procedures on the delivery of the service.

The review is an IT-facing review and, as such, can use the policies and standards in the Infrastructure Engineering SMF as guidance during the review to examine the controls and how they are used to meet SLA requirements. Any improvements in the processes and procedures highlighted during this review should be forwarded for inclusion in the next Infrastructure Engineering SMF review of standards and policies through the change process.

Supporting Quadrant

The Supporting Quadrant includes the processes, procedures, tools, and staff required to identify, assign, diagnose, track, and resolve incidents, problems, and requests.

There are three SMFs supporting this quadrant:

Service Desk
Incident Management
Problem Management
   Service Desk

The service desk is the central single point of contact between the IT organization and its customers. It is a business-focused mechanism for which effective use of standards and policies facilitates the delivery of a structured service. It is a key contributor of standards and policies where the customer is involved, for instance:
Escalation policies.
Customer interface policies.
Customer communication.

In addition to this, the service desk is also involved directly in the restoration of service to the customer and, as such, will contribute to standards, for example:
Service requests.
Incident reporting.
Customer feedback.
Skill levels for service desk.

It may also highlight any exceptions to accepted standards and policies that are in use if there is a break in service and the policies are not in place to support and operate the service in that area of the infrastructure environment.

Incident Management

Incident management is the process of recording, managing, and controlling incidents. This control element means that the Incident Management SMF provides input to the Infrastructure Engineering SMF in terms of:
Incident investigation, diagnosis, resolution, and closure.
Incident categorization.
Major incidents.
Communication guidance.
Knowledge management.
   Problem Management

The Problem Management SMF investigates and analyzes the root causes of incidents and provides information to the Infrastructure Engineering SMF on:
Trend analysis.
Best fit and resilient solutions.
What not to use in future and lessons learned.

This information assists in creating a standard and improved infrastructure environment.

Problem management uses information in other policies and standards to improve its awareness of the environment, enabling it to plan for a resilient environment.

SLA Review

The OMR associated with the Supporting Quadrant is the SLA Review. This review is a key management checkpoint and occurs at specified intervals (as documented in the SLA).

The SLA Review's inputs to IE include promoting the business strategy awareness and planning for future requirements. It uses the IE SMF to further examine capabilities and limitations in standards and policies for new products or changes.

Optimizing Quadrant

The Optimizing Quadrant includes the service management functions responsible for managing costs while maintaining or improving service levels. Their activities include reviews of outages and incidents and examinations of cost structures, staff assessments, availability, and performance analysis, as well as capacity forecasting. There are eight SMFs supporting this quadrant, including Infrastructure Engineering:
Service Level Management
Financial Management
Capacity Management
Availability Management
IT Service Continuity Management
Workforce Management
Security Management
   Service Level Management

This SMF manages the quality of IT services by negotiating, monitoring, and maintaining SLAs between the IT service provider and its customers. The Service Level Management SMF uses the information provided by the Infrastructure Engineering SMF to improve the service being delivered. It uses information on capabilities and responsibilities available in the policies and standards to ensure that SLAs are aligned to both business commitment and IT reality.

The cycle of agreement, monitoring, and reporting uses input at each stage from the Infrastructure Engineering SMF. Service level management is also likely to have its own policies and standards—for instance, invoking an escalation procedure, which it will contribute to the Infrastructure Engineering SMF. It provides data from the service catalog when the Infrastructure Engineering SMF is first being implemented in an organization. It also supplies this information for review cycles and delivers additional information from the service level manager in terms of business direction and requirements from the infrastructure environment to document current and future strategies.

Financial Management

Financial management is the sound management of costs in the IT environment. The Financial Management SMF ensures that solutions used within the infrastructure environment are cost effective. The Financial Management SMF takes into account the financial data, potential revenue and benefits, and cost-management techniques to ensure the solutions selected by the organization are delivering on all of these components. Financial management is a key input into the Infrastructure Engineering SMF since it provides the cost-benefit analysis that must be considered in developing infrastructure engineering scope. The Financial Management SMF also assists in documenting and developing categories, policies, and standards used by the Infrastructure Engineering SMF. Financial management's contribution to the Infrastructure Engineering SMF includes, among others, the following examples:
Strategic partners
Suppliers
Selected solutions
   Financial management also contributes to the development of such standards as:
How to instigate a request to tender.
When to use legal departments for contract review.
Payment of license agreements.
   Capacity Management

Capacity management is the process of planning sizing and controlling capacity to meet commitments to the business organization, formalized in SLAs and OLAs. The Capacity Management SMF's input to the Infrastructure Engineering SMF is therefore crucial. Capacity management creates and contributes to the Infrastructure Engineering SMF policies relating to the best control for the capacity available, for example:
Optimizing resource usage.
Volume management.
Response time management.
Capacity planning.
   It also creates standards for the implementation of these policies for capacity management of the infrastructure environment, for example:
Component capacity requirements.
Predicting future usage.
Minimum resource requirements.
Workload sizing.
Tuning applications.
   Availability Management

Availability management aims to ensure that IT services meet customer-defined availability needs consistently and cost-effectively. Availability in the infrastructure environment means using the Infrastructure Engineering SMF to control the availability of existing and new services, maximizing investment, and using appropriate technology choices. The Availability Management SMF creates policies to control the infrastructure, which include:
Availability objectives and constraints.
Key service component requirements.
Life cycle requirements.
Incident recovery.
   It will also contribute standards relating to the availability of the infrastructure, such as:
Specific availability targets for components.
Risk countermeasures.
Use of recovery tools.
Downtime limits.
   IT Service Continuity Management

IT service continuity management aims to ensure that the infrastructure is still capable of delivering the services to the business in the event of an unlikely system failure. The continuity capabilities of the infrastructure are key, and as such the IT Service Continuity Management SMF delivers minimum requirements for the infrastructure categories used in delivering services to be included in policies and standards. These can be for all services if that is cost justifiable. Policies for the infrastructure that may be created and managed by this SMF may include:
Managing availability risk.
Countermeasure testing.
Release procedures.
Contingency planning.
   It also creates more specific standards for the control of the IT Service Continuity Management SMF within the infrastructure environment, for instance:
Minimum requirements for IT service continuity.
Formalizing IT service continuity requirements.
Failover instigation.
Restoration of infrastructure.
Escalation procedures.

The IT Service Continuity Management SMF provides control to the infrastructure environment and uses the other information provided for its own control. For example, knowing the policy for minimum capacity for infrastructure components is as necessary for an IT service continuity secondary site as it is in the initial infrastructure; management of any recovery infrastructure and its control is just as important as that of the production infrastructure environment.

Workforce Management

The Workforce Management SMF manages the recruitment, retention, education, and development of the individuals employed in controlling the infrastructure environment. As such, they use the information held in the Infrastructure Engineering SMF policies and standards as important guidance to meet the requirements for the workforce in accordance with the strategic plans for the business. For instance, if there is a strategic choice to move to in-house development of new solutions, it is important to mobilize the skill base and recruitment efforts to support the strategy. As well as addressing the management of the workforce, the Workforce Management SMF also considers environmental components of the infrastructure, thereby ensuring a safe, efficient, and predictable workplace, and uses the information available in the standards and policies to implement and control these components. Workforce management may create policies, for example, around:
Hiring new staff.
Security for data center staff.
Minimum requirements for development staff.
Maximum working hours.
Use of part-time resources.
Use of contractual and outsourced workforce.
   The Workforce Management SMF may also contribute to the creation of standards, for instance:
Setting objectives.
Evaluating performance.
Administering recognition and rewards.
Ergonomic standards.
Training plans.
   Security Management

The Security Management SMF relates specifically to policies and standards that ensure protection and confidentiality of data and users. In many organizations, these standards and policies are stringently enforced by a separate IT security group, but they can also be enforced through the broader scope of infrastructure engineering. Examples of security management policies and standards might include:
Standards for port settings for firewalls and internet connections.
Policies for strong encryption of passwords.
Policies for physical security to data center facilities.
   Change Initiation Review

The OMR associated with the Optimizing Quadrant is the Change Initiation Review (formerly called the Release Approved Review). The standards and policies managed by the Infrastructure Engineering SMF must be demonstrably used by changes being sent for authorization. Any plans required by the standard or policy for the infrastructure category being changed must be assessed in this review. In addition, the results of this review will be passed back to the infrastructure engineering manager, as any changes or impacts on the standard or policy may highlight the need for future changes and reviews of the documented policies and standards.

Key Performance Indicators

This section describes key performance indicators for the Infrastructure Engineering SMF. A key performance indicator is a measurable quantity against which specific performance criteria can be set.

The following metrics are examples demonstrating the effectiveness of the Infrastructure Engineering SMF:
Enhanced management of standards and policies.
Reduction in number of redundant policies and standards.
Reduction in number of conflicting policies and standards.
Decrease in number of exceptions to established standards and policies.
Increased standardization of infrastructure hardware and software.
Reduction in maintenance costs associated with diverse implementations.
Reduction in acquisition costs for hardware.
Improved measurement of infrastructure complexity (as variants/category for services or applications).
Reduction in development/deployment time of projects and/or services, attributed to availability of centralized standards and policies.
Reduction in changes rejected at Change Initiation Review or Release Readiness Review, or cancelled projects.
Reduced development/deployment costs associated with service/application compatibility and quality.
Reduction in number of security incidents.
   Recommended Policies and Standards for IT Management

A list of the standards and policies recommended by MOF and ITIL are provided below. The list is adapted from Annex 2B, “The contents of ICT policies, strategies, architectures and plans,” ICT Infrastructure Management, p. 69. Published by ITIL, Office of Government Commerce.
Access policies and standards
Acceptance criteria standards and policies
Applications policies and standards
Business case standards
Business requirements standards
Cabling standards and policies
Contract policies and standards
Communications policies and standards
Data policies and standards
Database standards and policies
Design standards and policies
Desktop and laptop policies and standards
Development standards, methods, and policies
Document and document library standards and policies
E-commerce and e-business standards and policies
E-mail and groupware standards and policies
Environmental policies and standards
Functional requirements standards and policies
Handover standards and policies
IT security policies and standards
IT systems use, misuse, and abuse
IT technology standards and policies
Information standards and policies
Intranet standards and policies
ITT standards
Network standards and policies
Network addressing standards and policies
Planning standards and policies
Procurement standards and policies
Program standards and policies
Project methods
Project planning policies and standards
Project review standards and policies
Prototyping standards and policies
Quality standards and policies
Remote access standards and policies
Sign-off policies and standards
Statement of Requirement standards
Storage policies and standards
Supplier standards and policies
Testing policy and standards
User access policies and standards
User account and password management standards and policies
User interfaces and standards
   Example of Infrastructure Category Definition
   Infrastructure Category:
   Infrastructure Role Cluster
   Hardware—Desktop and Laptop
   Location:
   U.K. and mainland Europe
   Includes:
   Desktop

IBM

Dell

Compaq

Laptop

IBM

Dell

Compaq

Out of Scope

Legacy terminals using accounts system—managed by external contract with Cash Interface Co. Ltd

Notes:

All power and facilities for this location are provided under the rental agreement with the property owners.

Hardware must conform to the power regulations laid out in the contract for the rental agreement.

Any new requirements for inclusion to this category to be submitted to the infrastructure engineering manager.

Sample of a Policy Template

Insert Infrastructure Category:

Insert Management Policy:

Insert Owner and Manager of Policy:

Insert Creation Date:

Detail the effective date of the policy.
The groups the policy is directed toward.
When the use of the policy applies.
What the policy applies to.
What infrastructure categories are affected by the policy.
   Exceptions
If available, detail if there are any exception criteria known for the policy.
State the policy will otherwise apply to all infrastructure and services.
Any new exceptions to the process will need to be escalated to the owner and manager of the policy and the infrastructure engineering manager.
   Policy Control

This guidance is for insert policy.

It requires all groups to use the following guidelines:

Insert guidelines, including

Scope of policy.
Any limits to use of policy.
Include any SLA or OLA requirements for the policy.
Include any communication requirements.
Include any use of system requirements.
Include any process requirements.
Include any individuals accountable.
   Support and Additional Information

Additional information to assist in determining how to apply the above policy guidelines can be better understood by reviewing the following documents:

Insert links to supporting documentation, policies, and standards.

Policy and standards documents are regularly reviewed and updated to help you work efficiently. If you have questions about insert policy heading tools, process documentation, and other insert policy heading support-related items, please contact insert policy owner or manager e-mail.

Policies and standards are mandatory requirements and must be adhered to when applying insert infrastructure policy heading.

You are expected to review and adhere to the published standards and policies. Non-compliance with the published standards and policies will be escalated and actioned by insert policy owner or infrastructure engineering manager.

### EXAMPLES OF POLICIES

### Example 1

Release Infrastructure Category

Change Management Policy

Owned by insert policy owner and manager

Insert creation date

Effective immediately, all insert relevant groups must use the following policy guidelines when implementing insert infrastructure category changes to all insert details infrastructure environments.

Exceptions

These policies do not cover any detail exception criteria currently known changes at this time, only changes to infrastructure or services provided by insert relevant groups. This announcement will provide the single process for managing insert infrastructure environment and service changes. Any new exceptions must be escalated to the policy owner and infrastructure engineering manager.

Policy Control

This guidance is for using change management processes.

It requires all groups to use the following guidelines:

Only changes from the Known Change Type List (KCTL) will be allowed.
Any exceptions must be approved by the Change Advisory Board (CAB) or Emergency Change Advisory Board (ECAB).
All changes will require an RFC number and request raised for entry into the approval process.
Non-Standard Scheduled Changes, as defined in the KCTL, are all considered high impact (Sev 1) and must be approved by the Change Advisory Board (CAB).
Emergency Changes must be approved by the Emergency Change Advisory Board (ECAB).
Standard/Routine Changes designated as medium impact in the KCTL (typically Sev 2 or 3) must be approved by the change manager. The operating level agreement for approval turnaround times on these types of changes is 24 hours, Monday through Friday. All changes for a given day will be batch processed by 4 P.M. (GMT+6). If a change is submitted after 4 P.M., it will not be processed until the next business day. For example:
For a change submitted at 4:01 P.M. Wednesday, a response will be provided by 4:00 P.M. Thursday.
For a change submitted at 4:01 P.M. on a Friday, a response will be provided by 4 P.M. the next business day.
The subject line on Change Control records must reflect the description of the change as shown in the KCTL, and be preceded with the Change Approver type abbreviation (for example, CAB for Change Advisory Board, CM for Change Manager).
Bulk changes affecting multiple devices will be allowed on a single RFC, and will follow the approval process as defined by the KCTL for that change type.
All communications to the business must follow the defined business communications policy and be routed to the appropriate regional contact.
   Support and Additional Information

Additional information to assist in determining how to apply the above policy guidelines can be better understood by reviewing supporting documentation found at:

Insert Change Advisory Board (CAB)

Emergency Change Advisory Board (ECAB)

Known Change Type List (KCTL)

Change Management Communication Guidelines

Change Control Subject Line Coding Examples

Policy and standards documents are regularly reviewed and updated to help you work efficiently. If you have questions about insert policy heading tools, process documentation, and other insert policy heading support-related items, please contact insert policy owner or manager e-mail.

Policies and standards are mandatory requirements and must be adhered to when performing infrastructure and service changes.

You are expected to review and adhere to the published standards and policies. Non-compliance with the published standards and policies will be escalated and actioned by insert policy owner or infrastructure engineering manager.

### Example 2

Policy 10.2.4—Desktop Printers

Origin Date: Jun. 7, 2004

Last Revised Date: Jul. 20, 2004 Policy Number: 10.2.4

Owner(s): Mark Bebbington, DIR OF TECHNOLOGY FULFILLMENT

Contact(s): Oliver Lee, ASSOCIATE PROGRAM MANAGER Neil Charney, PROGRAM MANAGER

Summary:

The individual purchase of desktop printers is strictly prohibited. Public printers are available in all buildings on all floors to employees for business use.

Body:

Desktop printers shall not be purchased for individual employee or group use. Public printers yield a much lower cost per page, improved print quality, and greater processing efficiency than desktop printing devices. The primary reason that many give for needing a desktop printer is document security. By using the “secure print” feature on public multi-functional printers, sensitive and confidential documents can be sent and temporarily stored on the public printer until the employee arrives at the device to begin printing. Because a personal identification number (PIN) is required for secure printing on public multi-functional printers, the only employee who can retrieve the document is the person who generates the secure print job. This ensures that documents remain private and secure until you physically release them for printing.

Exceptions:

Exceptions to this policy require general manager approval.

Enforcement:

Employees who fail to comply with corporate policies may be subject to disciplinary action up to and including termination of employment.

Reporting Treatment:

Not applicable

Application:

This policy applies to all employees worldwide.

Related Documents:

External Documents: Desktop Printer FAQ

Keywords: buy, printer, purchase

Virtual Categories:

Appendix E: Sample of a Standard Template

Insert Infrastructure Category:

Insert Management Standard:

Insert Owner and Manager of Standard:

Insert Creation Date:

Detail the effective date of the standard.
The groups the standard is directed toward.
When the use of the standard applies.
What the standard applies to.
What infrastructure categories are affected by the standard
   Exceptions:
If available, detail if there are any exception criteria known for the standard.
State the standard will otherwise apply to all relevant infrastructure and services.
Any new exceptions to the standard will need to be escalated to the owner and manager of the policy and the infrastructure engineering manager.
   Standard Control
   This guidance is for insert standard.
   It requires all groups to use the following guidelines:
   Insert guidelines, including
Scope of standard.
Any limits to use of standard.
Include any SLA or OLA requirements for the standard.
Include any communication requirements.
Include any use of system requirements.
Include any process requirements.
Include any individuals accountable.
   Support and Additional Information
   Additional information to assist in determining how to apply the above standard can be better understood by reviewing the following documents:
   Insert links to supporting documentation, policies, and standards.
   Policy and standards documents are regularly reviewed and updated to help you work efficiently. If you have questions about insert standard heading tools, process documentation, and other insert standard heading support-related items, please contact insert standard owner or manager e-mail.
   Policies and standards are mandatory requirements and must be adhered to when applying insert infrastructure standard heading.
   You are expected to review and adhere to the published standards and policies. Non-compliance with the published standards and policies will be escalated and actioned by insert standard owner or infrastructure engineering manager.
   Example of a Standard
   Hardware Control and Operability Category
   Low-end SQL Server Standard
   Owned by insert policy owner and manager
   Insert Creation Date
   Effective immediately, all insert relevant groups must use the following standard guidelines when implementing new installations or upgrades of SQL Server to all data center infrastructure environments.
   Exceptions
   These policies do not cover any detail exception criteria currently known changes at this time, only changes to infrastructure or services provided by insert relevant groups.
   This announcement will provide the single standard for the procurement and installation of new low-end servers running SQL Server in a corporate data center. Any new exceptions must be escalated to the policy owner and infrastructure engineering manager.
   Standard Control
   This guidance is for procuring and installing new low-end (2 processor) hardware for operating SQL Server in a data center.
   It requires all groups to use the following guidelines:
   Low-End (2-Processor) Server Configurations for SQL Server

As shown in Table 5, the low-end SQL Server configuration is designed for specific data collection situations were low cost is desired and low performance is acceptable. These configurations are not intended to be used for typical SQL Server applications with large queries or many users. Performance is explicitly sacrificed for specific situations.

TABLE 5

| Class | Vendor | SKU | Price | Description | Size |
|---|---|---|---|---|---|
| 10 GB | HP | SKU-EXMPL- | $x,xxx.xx | HP DL380-G3; (2) XeonDP/ | 2U |
| SQL | | HPServ1 | | 3.06 GHz; 1 GB RAM; 51.6 GB | |
| | | | | Total HD Capacity; 10 GB | |
| | | | | DB Capacity; iLO; Redundant | |
| | | | | Power Supplies, Redundant | |
| | | | | Fans | |
| 10 GB | Dell | SKU-EXMPL- | $x,xxx.xx | Dell PE2650; (2) XeonDP/ | 2U |
| SQL | | DELLServ1 | | 3.06 GHz; 1 GB RAM; 51.6 GB | |
| | | | | Total HD Capacity; 10 GB | |
| | | | | DB Capacity; Redundant | |
| | | | | Power Supplies; DVD; | |
| | | | | Platinum Support [Quote# | |
| | | | | 119641524] | |

Support and Additional Information
Additional information to assist in determining how to apply the above standard guidelines can be better understood by reviewing supporting documentation found at:
Insert CMDB Entry
Insert Hardware Procurement Policy Links

Standards and policy documents are regularly reviewed and updated to help you work efficiently. If you have questions about insert policy heading tools, process documentation, and other insert policy heading support-related items, please contact insert policy owner or manager e-mail.

Standards and policies are mandatory requirements and must be adhered to when performing infrastructure and service changes.

You are expected to review and adhere to the published standards and policies. Non-compliance with the published standards and policies will be escalated and evaluated for action by insert policy owner or infrastructure engineering manager.

Change Management SMF

In one embodiment, the goal of the Change Management SMF is to provide a disciplined process for introducing required changes into the IT environment with minimal disruption to ongoing operations. To achieve this goal, the change management process includes the following objectives:
To formally initiate a change through the submission of a request for change (RFC).
To assign a priority and a category to the change after assessing its urgency and its impact on the infrastructure or end users. This assignment affects the speed at which the change will be addressed and the route it takes for authorization.
To establish an efficient process for passing the RFC to a change manager and the change advisory board (CAB) for approval or rejection of the change.
To plan the deployment of the change, a process that can vary immensely in scope and includes reviews at key interim milestones.
To work with the Release Management SMF, which is embedded within the change management process and manages the release and deployment of changes into the production environment. For more information about the Release Management SMF, see http://www.microsoft.com/technet/itsolutions/cits/mo/smf/default.mspx.
To conduct a post-implementation process that reviews whether the change has achieved the goals that were established for it and determines whether to keep the change or back it out.
   Key Definitions
   CAB emergency committee (CAB/EC). The subset of the CAB that deals only with emergency changes. It is established to be able to meet on short notice to authorize or reject changes with emergency priority.
   Change. Any new IT component deliberately introduced to the IT environment that may affect an IT service level or otherwise affect the functioning of the environment or one of its components.
   Change advisory board (CAB). The CAB is a cross-functional group set up to evaluate change requests for business need, priority, cost/benefit, and potential impacts to other systems or processes. Typically the CAB will make recommendations for implementation, further analysis, deferment, or cancellation.
   Change category. The measurement of a change's deployment impact on IT and the business. The change complexity and resources required, including people, money, and time, are measured to determine the category. The risk of the deployment, including potential service downtime, is also a factor.
   Change initiator. A person who initiates a request for change; this person can be a business representative or a member of the IT organization.
   Change manager. The role that has the overall management responsibility for the change management process in the IT organization.
   Change owner. The role that is responsible for planning and implementing a change in the IT environment. The change owner role is assigned to an individual for a particular change by the change manager and assumes responsibilities upon receiving an approved RFC. The change owner is required to follow the approved change schedule.
   Change priority. A change classification that determines the speed with which a requested change is to be approved and deployed. The urgency of the need for the solution and the business risk of not implementing the change are the main criteria used to determine the priority.
   Configuration item (CI). An IT component that is under configuration management control. Each CI can be composed of other CIs. CIs may vary widely in complexity, size, and type, from an entire system (including all hardware, software, and documentation) to a single software module or a minor hardware component.
   Release. A collection of one or more changes that includes new and/or changed configuration items that are tested and then introduced into the production environment.
   Request for change (RFC). This is the formal change request, including a description of the change, components affected, business need, cost estimates, risk assessment, resource requirements, and approval status.
   Processes and Activities
   Process Flow Summary

In the context of change management, change is defined as anything-hardware, software, system components, services, documents, or processes—that is deliberately introduced into the IT environment and may affect an IT service level agreement (SLA) or otherwise affect the functioning of the environment or one of its components. Changes can be either permanent or temporary. Changes can completely replace a current version of a component, either with a new component or a changed version of the component, or they can involve the installation of a completely different component or the removal of an outdated one.

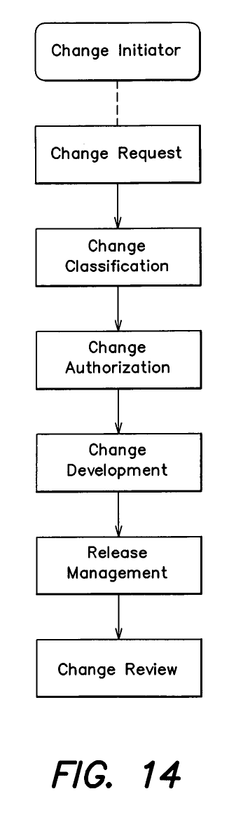

Whether permanent or temporary, new or revised, all changes falling under this definition must be managed by the change management process. Change management should manage all changes within the IT environment. This is important because changes may:
Affect multiple users.
Potentially disrupt mission- or business-critical services.
Involve hardware (such as servers or networking equipment) or software modifications.
Affect data stored in IT systems. (This is dependent on the type of data—for example, updating a price list on an e-commerce website should be controlled by the change management process, whereas updating customer information in a company's database would not be controlled in this way.)
Involve operational and process modifications that affect multiple users.
   Change can be graphically represented as a process flow diagram, shown in FIG. 14, that presents the key tasks needed to be performed in order to successfully deploy a change.

This high-level diagram can be further organized to provide detailed end-to-end process descriptions that, if followed, provide the comprehensive blueprint for the change management process. Diagrams illustrating these detailed change management processes are discussed below.

The release management process is embedded into the change management process; further information on the specifics of release management can be obtained from the Release Management Service Management Function Guide, which is available at http://www.microsoft.com/mof.)

Change Request

Typically, any person within a business environment can request a change and, by doing so, become a change initiator. Because the pool of potential change initiators is large and consists of people with varying degrees of familiarity with the procedures involved, a process is required that produces change requests of consistent quality and completeness and discards irrelevant requests.

Although a change request can be requested by anyone in the business, it is typically initiated and submitted by one of the MOF Team Model role clusters, as shown in Table 6. Normally, each role cluster submits requests for changes relating to its area of responsibility.

TABLE 6

| Role Cluster | Type of Change Request |
|---|---|
| Infrastructure | New systems and improvements to existing systems and infrastructure. |
| Operations | Changes that affect or improve day-to-day operations of the |
| | technology. |
| Partner | Third-party and supplier-related changes-for example, changes to an |
| | outsourced partner system affecting in-house systems. |
| Release | Changes to the change, configuration, and release management |
| | systems and processes. |
| Security | Changes to security processes-for example, authentication or |
| | network security improvements. |
| Support | Changes enabling incident and problem resolution and changes to the |
| | help desk system. |
| Service | Changes driven by new service level requirements, service |
| | improvement projects, or business strategy. |

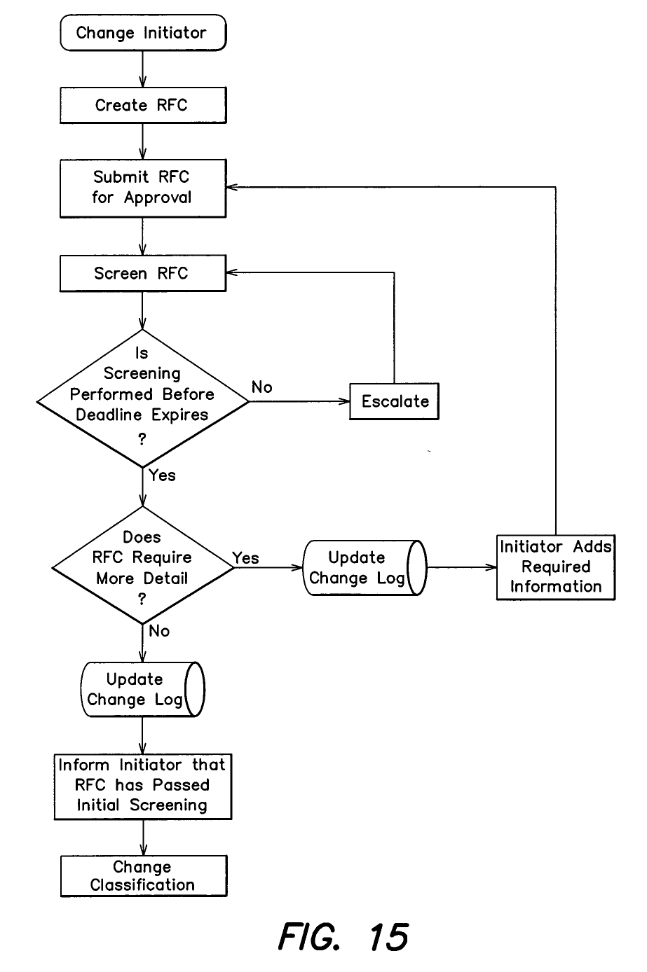

The process for requesting a change is shown in FIG. 15.

A need for change, whether it is an improvement to or phasing out of an existing service or the creation of a new one, drives the change management process. Within a controlled change management process, these needs all prompt the creation of a request for change (RFC). The RFC is a standard document in which all relevant information about the proposed change is recorded, ranging from basic facts about the change (for example, change to a field name on a data base system) to more detailed information, such as the wider-reaching effects of the change (for example, the systems that interact with or report on the changed field name).

The RFC must answer the what, why, who, when, where, and how questions of the proposed change. It must describe the change, the effort it will take to implement the change and by whom, the method of implementation, and the configuration items involved. It also includes supporting information about the purpose of the change, its impact on the organization, the backout plan in case of failure, the cost of the change, the budget approval sign-off if necessary, and the urgency of the proposed change. It should contain sufficient information to allow the change manager to quickly and accurately assess the change at the initial screening stage and again at its official review stages for approval or rejection.

The RFC should be created in a standard format, which ensures that the change initiator provides sufficient information to the change manager and subsequently the CAB to enable them to decide whether to implement the change. Using a standard format also forces the change initiator to identify and fully document the scope, implications, and risks of the change being requested, as well as the plans for recovery should the change be unsuccessful. In many cases, the change initiator will not know or fully understand the implications of the change. For this reason, the RFC needs to be considered by all of the MOF Team Model role clusters to determine the change's possible impact on IT operations.

The RFC becomes the point of reference for all activities associated with the change. Using a standard format, such as a template in Microsoft Word, a Microsoft Outlook® mail form, a Microsoft InfoPath™ form, or a Web form, which can be easily accessed by all interested parties at any time, can be useful.

To aid the change management process, the RFC form can have validated, mandatory, and optional fields for completion to ensure that essential information is completed as early as possible and to reduce the need to return the RFC to the initiator for further information before it can be reviewed.

Create a Request for Change

A person (the change initiator) who wants to make a change to any part of the IT infrastructure governed by the change management process begins the process by completing an RFC. Events that typically generate an RFC include:
A proposed resolution to an incident or problem.
User or customer dissatisfaction expressed through a customer liaison (often the service desk) or from service level management metrics prompting an improvement to the service.
The proposed introduction or removal of a configuration item (CI).
A proposed upgrade to some component of the infrastructure.
Business strategy influencing the requirements from IT.
New or changed legislation prompting service changes.
Physical location changes.
Product or service changes from vendors or contractors.

The change initiator may be in the right position in the business to submit the change, but may not always be familiar with the IT environment itself. In these instances, a change owner from the IT environment should be assigned who will be able to provide the necessary information relating to the technology specifics of the change for the RFC.

RFC Information

When completing the RFC, the change initiator should provide as much of the following information as possible:
The change initiator's name, position, and contact information.
The change owner's name, position, and contact information.
Description of the change, that is, a full account of the nature of the change.
A suggestion for the priority and category of the change based on the information available.
Problem report (PR) number of any problem that relates to the change, or incident numbers, if known.
Description and identity of any items to be changed, including identification of the CIs.
Reason for the change.
A cost-benefit analysis of the change and budgetary approval, if required.
Implications of not implementing the change, including any SLA that is at risk.
Impact and resource assessment, that is, which users will be affected and how big the effect.
Location of the release and a suggested implementation plan with timescales.
Backout plan including triggers and decision-maker contact details.
Impact on business continuity and contingency plans.
Risk involved in making the change.

The change initiator might also need to provide supporting documentation, such as the business case, cost-benefit analysis, or proposed implementation plan, to the change manager and others involved in the change approval process.

Two of the RFC items in the change initiator's list—the recommended or proposed change priority and category—merit further explanation.

Change Priority

There is often a degree of confusion surrounding the definition of priority; the dictionary definition states: “Precedence, especially established by order of importance or urgency.”

In the change management process, the urgency is determined by how quickly a change is required by the business. There are four recommended levels of priorities:
Emergency. A change that, if not implemented immediately, will leave the organization open to huge risk—for example, applying a security patch.
High. A change that is important for the organization and must be implemented soon—for example, an upgrade in line with new legislation requirements.
Medium. A change that should be implemented to gain benefit from the changed service—for example, between versions upgrade to a customer feedback service.
Low. A change that is not pressing but would be advantageous—for example, a “nice to have” addition to a user profile.

These priority levels have been defined according to industry best practice. However, depending on organizational size, organizational structure, and the underlying SLAs existing between the IT department and the business it serves, organizations might need to modify their own priority definitions. In some organizations, for instance, if the individual who wants to add the “nice to have” addition to his or her user profile works in a business-critical area, then the change may be perceived as being a high priority. Conversely, if that same change is requested for a business area that is being phased out, the change may be perceived as a low priority. It is essential that each organization consider the correct use of these priorities for its own environment, since these priorities determine when and how the change is to be implemented. They also determine the order in which change requests are reviewed.

It is important to note, however, that an emergency priority change differs from the other change priorities in that it takes a different path through the review process in order to implement the change as quickly as possible. This priority is reserved for only those changes that, if not implemented quickly, might seriously affect service levels or result in a large cost to the business. Emergency changes must be kept to an absolute minimum due to the increased risk involved in implementing them; their use should not replace good planning practices.

Change Category

Whereas the priority of a change indicates how urgently a change is required to be implemented, the category of a change is used to define the change's impact on the infrastructure, users, or business. For example, does the change affect one user, a department, or every user in the organization? Does the change involve updating a single switch, or is it a complete overhaul of the network? The answers to such questions determine the category of the change.

As with priorities, the decision of what constitutes each category of change is determined by the individual organization. As a suggestion, the following categories have been used effectively in other organizations.
Major. A change where the impact on the group could be massive—for example, a departmental or corporate-wide change, or a network-wide or service-wide change.
Significant. A change where the effect is widespread, but not massive—for example, a change affecting a group within a department or a specific group of CIs.
Minor. A change affecting small numbers of individuals or CIs—for example, a change to a printer used by a department consisting of just a few members.
Standard. A change that has been performed before and is part of the operational practice of the business—for example, an update to a user profile.

As with the change priority, the change category is also tied to the specific organization. A change affecting a particular department may be deemed significant in some organizations but may only be considered a standard category in another organization in which that department is regarded as less critical to the business. The same is true for changes to the delivery of specific services or the use of certain products. The information for defining the categories should be gathered from the Service Role Cluster, service catalog, and Service

Level Management SMF.

One category of change that needs special attention, however, is called a standard change in this guide. A standard change falls at the bottom of the category scale in that its impact is low in terms of effect on users or infrastructure. The effort required to implement it is also relatively small, and its risk to the environment is correspondingly low.

A set of standard changes and standard procedures for implementing them is normally predefined by the change advisory board (CAB). This set of standard changes can be automatically approved without needing to be voted upon by the CAB or the change manager, thereby taking a shorter route through the change approval process. Only changes that fall into the predefined standard set can be classified as such. Examples of standard changes include regularly scheduled maintenance, frequently performed administrative tasks (such as profile changes), and lesser service requests.

Submit the RFC for Approval

The change initiator documents all the information necessary to describe a proposed change and submits the RFC to the change manager. (The change manager role is one of the roles included in the Release Role Cluster of the MOF Team Model. See the MOF Team Modelfor Operations paper for more information about role clusters.) In order to provide an initial level of screening and “reality” checking of RFCs, the number of users in an organization who have the authority to submit RFCs should be limited. If other users wish to initiate an RFC, someone else must first approve it before it can be formally submitted and passed to the change manager.

Screen RFC

Following its submission, the new RFC must be screened. This screening process is not concerned with the validity or approval of the change request, but determines whether a decision to authorize or deny the change can be made based on the information in the RFC and any references made by the RFC.

This initial screening must be carried out by someone who has been given the authority to screen an RFC or by the initiator's manager. Such a chain of pre-approvals should be kept short—otherwise it becomes an administrative and logistical burden, subject to error.

This screening process should include:

A reality check to ensure that the RFC is appropriate. Because any user can create an RFC, it means that RFCs might be generated that are:
   Not relevant to the IT change management process.
   Not detailed enough.
   Not fully understood as to their implications.
   Not completed correctly due to the change initiator's lack of knowledge of the change management process.
Addition of missing information needed by evaluators to fully understand the impact of the change (for example, impact analysis results from the change management database).
Reclassification of the priority and category if appropriate. If an RFC has been submitted as a standard change, for example, but does not conform to one of the predefined types of standard change, then it must be reclassified.

The person designated to screen RFCs is responsible for carrying out the screening of the RFC and other actions within a set period of time, depending on the priority of the requested change. Emergency changes should have a much shorter time limit for screening than non-emergency changes. These times are defined in an SLA. For those times when the change manager is unavailable or otherwise unable to screen RFCs within the set time limit, a change manager deputy or deputies should be designated and given the authority to act in the change manager's place.

If the RFC is not screened within the set time limit, it should be automatically escalated to someone who has been designated as an alternate screener. This notification can be done through e-mail. If appropriate, this e-mail could also be copied to the IT executive committee or another escalation path. The details should also appear on a monthly escalation report to enable higher-level visibility. The fact that the RFC was not screened within the defined time limit should be added to the change log for that RFC.

If the person designated to screen RFCs determines that the RFC does not contain sufficient information for a decision to be made, the RFC is returned to the change initiator. The change manager specifies in the change log the additional information that is required and the reasons for needing it. The RFC status is set to pending and the change initiator should be informed. The change initiator can then add more information to the RFC and resubmit it, at which point the timeout period for screening restarts.

In the case of an RFC that has been returned for more information, the change initiator should resubmit it in a timely manner to prevent a build-up of pending RFCs awaiting resubmission or initial screening.

If the screening determines that the RFC has enough content and supporting information to warrant the discussion and authorization of the change, then the change log is updated and the change initiator is informed, and the RFC passes to the change classification stage.

Once an RFC has been screened, the change manager assigns it an ID for tracking purposes and records the fact the RFC has passed screening in the change log. The change log is a key component of change management and ensures all changes are controlled and reportable by the change manager. It acts as the repository of a detailed history of all changes—from RFC creation to change release or cancellation—and is updated with each change in status of the RFC. Organizations may decide to have the change log be a separate database or contained within the CMDB.

Summary

In summary, the process for requesting a change consists of the following steps:

The change initiator creates and submits a full account of the change needed in the form of an RFC.
A designated screener determines whether there is sufficient information present in the RFC for it to be authorized.
If sufficient information is not present, the screener returns the RFC to the initiator for more details to be added where required.
This cyclical process results in a screened RFC ready for entry into the change classification process.
   Change Classification

At this stage, the change request has passed the initial screening although it has not yet been approved. The next requirement is to classify the priority and category of the change. Even though the priority and classification have been entered by the change initiator, the change manager or a designated deputy reviews them and has the authority to change them if necessary.

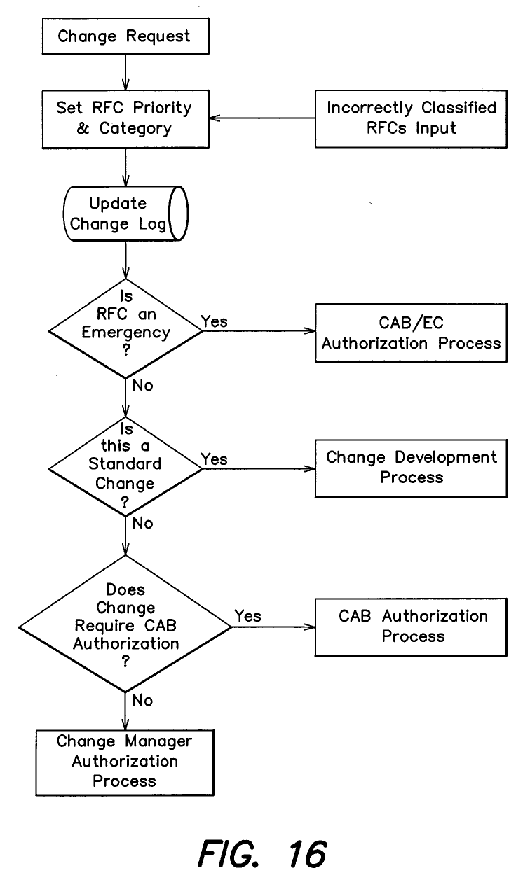

The process for change classification is shown in the flow chart in FIG. 16 and indicates the path that the RFC will take through subsequent processes. (All the action on the flow chart is performed by the change manager or deputy.)

The change manager reviews the RFC priority level suggested by the initiator and accepts or changes it. The priority level of the RFC affects how quickly the CAB will review the change request and how soon it will be implemented if approved. The change manager oversees all changes submitted and thus is in a good position to adjust the priority of the RFC compared to the priority of other RFCs.

Due to its direct effect on the order and timing of the review and implementation processes, setting priorities is extremely important. It is particularly important to assign the emergency priority classification to those changes calling for it since it expedites their path through the change process. This is also the point where RFCs that have been incorrectly prioritized previously are resubmitted to the change manager for reevaluation. The change manager may adjust the priority if he or she does not think the priority suggested by the change initiator is correct or if a change having an emergency priority was not deemed to be an emergency by the change advisory board emergency committee (CAB/EC).

If the change manager adjusts the priority, he or she also records the adjustment in the change log, together with the reasons for it. In all cases, the change log should record the adjusted priority of the change, along with the name and contact details of the change manager making the decision.

Change Priority Classifications

As mentioned previously, priority is derived from the need for the change. The priority rating is used to decide how quickly changes will be evaluated and implemented. Although each organization can define its own priority levels, Table 7 further illustrates the four-level classification system summarized in the change request phase.

TABLE 7

| Priority | Priority Definition |
|---|---|
| Emergency | Causing loss of service or severe usability problems to a large number of |
| | users, a mission-critical system, or some equally serious problem. |
| | Immediate action required. Emergency meetings of the CAB or |
| | CAB/EC may need to be convened. Resources may need to be |
| | immediately allocated to deploy such authorized changes. |
| High | Severely affecting some users or having an impact upon a large number |
| | of users. To be given highest priority for change building, testing, and |
| | implementation resources. |
| Medium | No severe impact, but rectification of an incident cannot be deferred |
| | until the next scheduled upgrade, for example. To be allocated medium |
| | priority for resources. |
| Low | A change is justified and necessary, but can wait until the next |
| | scheduled release or upgrade. To be allocated resources accordingly. |

In the case of an emergency change being submitted, the change will immediately follow the specific fast-track path to be authorized by the CAB/EC as described later in this guide.

Set RFC Category

As with change priority, the change manager reviews the change category of the RFC submitted by the change initiator and accepts it or changes it as needed. Because several different tools and technologies may be needed to perform this task effectively, the change manager may call on subject matter experts (SMEs), technical experts, and third-party suppliers (as needed) to assist in the change categorization. To identify the IT components that will be affected by a change, for example, impact analysis needs to be performed on the CMDB. Information stored in Microsoft Systems Management Server (SMS) or Microsoft Active Directory® directory service may also provide information relevant to the change category.

The change category determines the path that most RFCs will take through the change management process. Standard changes, however, take a slightly different path compared to the other change categories in that they are automatically approved. The change manager must ensure that a change that has been classified as standard matches one of the change types predefined by the CAB as a standard change and is therefore safe to preapprove for deployment.

In all cases, the change log should record the category of the change along with the name and contact details of the change manager making the final decision.

Change Category Classifications

Whereas the change priority indicates how quickly a change should be implemented, the change category, as explained earlier, is a measure of the size of the change's impact on users, the business, or the IT infrastructure. Organizations can tailor their change categories to their own needs. However, Table 8 illustrates a possible means of distinguishing the four categories and supplements the information provided in the change request phase.

TABLE 8

| Category | Category Definition |
|---|---|
| Major | Involves potential impact on the highest percentage of users or a business- |
| | critical system. The change may be new technology or a |
| | configuration change. It may involve downtime of the network or a service. |
| Significant | Affects a high percentage of users. The change is a nonstandard change, |
| | such as a new product, new users, or network changes, and may involve |
| | downtime of the network or a service. |
| Minor | Affects a smaller percentage of users and risk is less because of the |
| | organization's experience level with the proposed change. |
| Standard | Affects the smallest percentage of users and has a set release process. |

Summary

In summary, the change classification process:
Classifies the priority of the change by the urgency for the RFC to be deployed in terms of business need.
Classifies the category of the RFC by the nature of the change to be performed in the RFC.
Defines the path to follow for emergency changes, which go straight to the CAB/EC.
Defines the path for standard changes that have been preauthorized.
Defines the path for other changes for approval from the change manager, CAB, or CAB/EC.
   Change Authorization

After a change has been correctly prioritized and categorized by the change manager, the change must be authorized. The process of authorizing a change request depends upon the category and priority of the change:
Emergency priority changes are escalated to the CAB/EC for fast-track approval.
Standard changes are approved automatically and progress directly to the change development and release phase.
Minor changes can be approved by the change manager without reference to the CAB.
All other changes must be approved by the CAB.

These approval processes are discussed in greater detail below. In each case, the appropriate person or body makes a decision on whether the change should be implemented based on the information supplied in the RFC.

If the RFC is rejected and the change is not approved, the RFC is closed and the change initiator is informed of the decision. The reasons for the rejection are added to the change log. After it has been closed, an RFC cannot be reopened. If the change initiator wishes to resubmit the request, he or she must open a new RFC, make reference to the original, rejected RFC, and add any additional information that is necessary to get the request approved. The recorded reasons for the denial of the original RFC should give an indication of the extra information that might be needed. All SLA timings defined for the different stages of the change process (for example, time to initial screening) are restarted because it is a new RFC. If the RFC is time critical, the resubmitted RFC may need to be given an increased priority over the original due to the delays incurred during the processing of the original request.

The activities of the MOF Team Model role clusters within change authorization depend on the size and nature of the change. Table 9 provides examples of each role's involvement.

TABLE 9

| | | | | Significant and |
|---|---|---|---|---|
| Role Cluster | Standard Change | Minor Change | Emergency Change | Major Change |
| Infrastructure | Preauthorized | Not involved | CAB member | CAB member |
| Operations | Preauthorized | Not involved | CAB member | CAB member |
| Partner | Preauthorized | Not involved | CAB member | CAB member |
| Release | Authorize | Authorize | CAB member | CAB member |
| Security | Preauthorized | Not involved | CAB member | CAB member |
| Support | Preauthorized | Not involved | CAB member | CAB member |
| Service | Preauthorized | Not involved | CAB member | CAB member |

Authorize Standard Changes

A standard change is a change to the infrastructure that follows an established path, is relatively common, and is the accepted solution to a specific requirement or set of requirements. Examples might include password changes or updates to certain document templates. The crucial elements of a standard change are:
The tasks are well-known and proven.
Authority is effectively given in advance by the CAB.
The change process can usually be initiated by the service desk.
Budgetary approval is typically preordained or within the control of the initiator.

Standard changes are automatically approved and move straight to the change deployment phase of the change management process (see the Change Development and Release section). Because the types of changes that have been preapproved as standard changes are known to have a low impact on the environment and are a low risk to it, they do not need to be reviewed again by the CAB or even the change manager. This, however, means that care must be taken during the initial screening to ensure that a change request that has been categorized as standard is, indeed, one of the preapproved change types.

Authorize Minor Changes

A minor change is one that falls near the end of the categorization scale—one that has a low impact and risk. It differs from a standard change in that although the risk is low, the change may not have been performed before and therefore has to be approved. What actually constitutes a minor change depends upon the criteria chosen by the organization. Because the impact and risk of a minor change are low and the requirement for resources to implement the change is small, a minor change does not need to go before the CAB for approval. Instead, the change manager has the authority to approve or reject the change. The change manager still has the option to present the RFC to the CAB if he or she thinks it necessary.

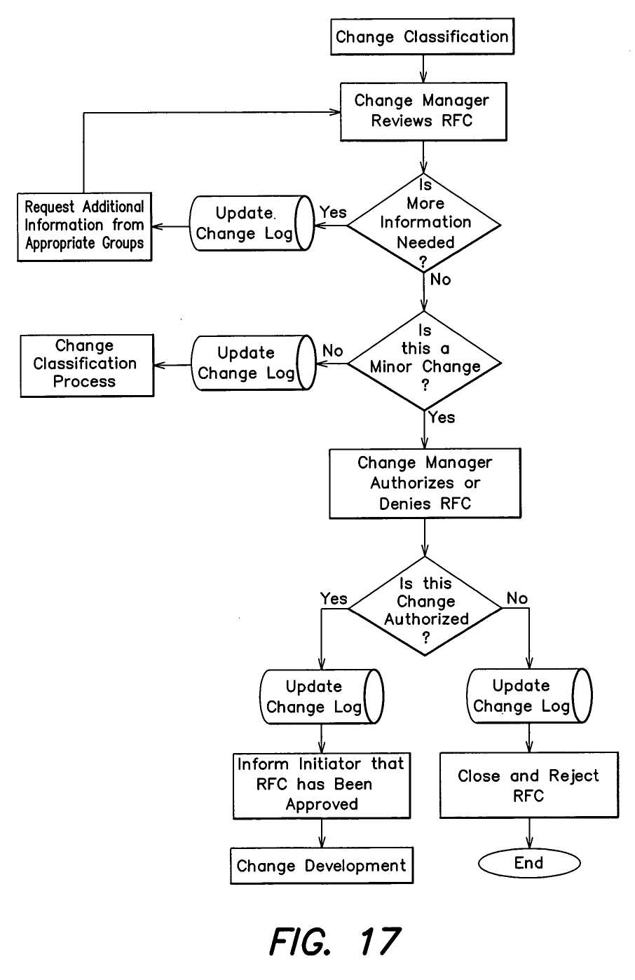

The process of authorization of minor changes by the change manager is shown in the flow chart in FIG. 17.

If the information in the RFC is not sufficient to allow the change manager to make a decision, the change manager should contact the change initiator to obtain the required information.

When sufficient information is available to make a decision, the change manager applies the usual criteria for accepting or rejecting the RFC. Applying these criteria should provide answers to the following questions.
Is the change necessary?
Do the benefits of the change outweigh any risks of destabilizing the environment?
Is the cost acceptable?

Because only minor changes are approved by the change manager alone, this process should be fairly straightforward and clear. Any doubt over whether to approve the RFC should result in a change to its category and escalation to the CAB.

The change manager records the decision whether to approve or reject the change in the change log. If the change is rejected, the change manager adds the reasons for doing so in the change log, closes the RFC, and informs the change initiator. If the minor change is approved, the change initiator is informed and the change request moves on to the change deployment phase. Although the CAB is not involved in the approval of minor changes, the change manager should still inform them of the change at their next meeting.

It is useful if the change manager reports RFC status by using such simple queries as “display all major RFCs awaiting approval,” “display all minor changes,” or “display all standard changes in progress.”

Authorize Significant and Major Changes

As discussed above, any changes other than standard changes and minor changes must go before the CAB for approval. Because of the impact of such changes on the IT environment or the number of users who will be affected, these changes cannot be authorized by a single individual. The individual might not understand the full impact of the change or might not understand the impact from the point of view of a particular function within the organization. For example, the individual might not understand the implications of a change on security, capacity, or service levels. The CAB, on the other hand, has a broad membership that possesses enough cumulative knowledge to fully understand the implications of the change.

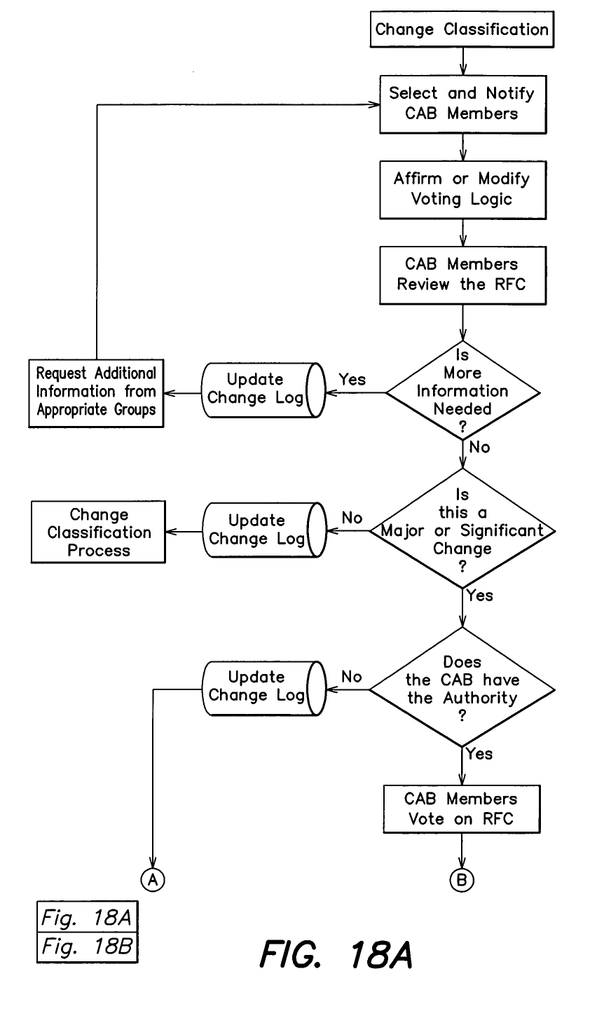

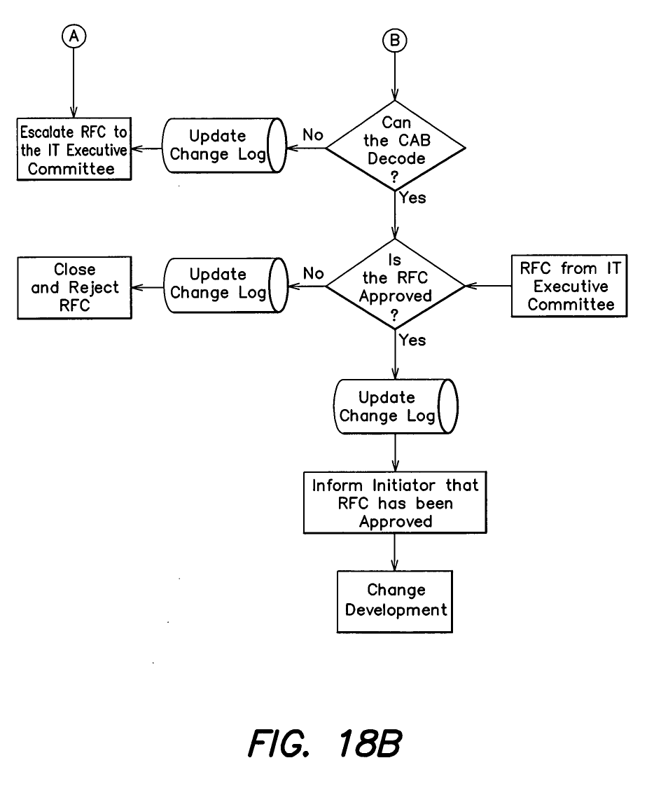

The CAB authorization process for significant and major changes is shown in FIG. 18.

Select CAB Members

A request for a significant or major change must go before the CAB, and the change manager must decide who should sit on that board to review this particular RFC. CAB members must be selected for each RFC, because the most appropriate people to review the requested change will depend on the exact nature of the RFC. The CAB includes a number of standing members who always sit on the CAB (or who have deputies who sit in their absence) and review all RFCs submitted to them. In addition to these, the CAB should include personnel and experts who are from departments affected by the change or who can add value to the discussion of the change. These additional members are chosen on a case-by-case basis. The CAB should contain at least one member from each role cluster as defined in the MOF Team Model.

The standing members of the CAB typically includes:

Change manager.
Customers or business manager representing the customer.
User managers or user group representatives.
Experts/technical consultants.
Security expert.
   Other roles that may be required to participate in the CAB for some changes include:
Network infrastructure representative.
Applications developers/maintainers.
Services staff.
Office services staff (where changes may affect accommodation and vice versa).
Contractor or third parties' representatives as required (for example, in outsourcing situations).

The process of selecting CAB members can be made easier by drawing up a CAB membership list for each type of change—for example, network infrastructure change, facilities change, new application, new data, operating system fix/upgrade, or desktop fix. For each change being reviewed, CAB members can be selected from the standing list and the optional lists. Individuals can be added or removed as necessary. The total number of CAB members should still be limited in order to make the CAB meetings more efficient and manageable.

The CAB normally meets on a regular basis—for example, weekly. The standing members always attend or send deputies who are authorized to make decisions in their place.

Notify CAB Members

Change advisory boards are normally convened on a weekly basis with all standing members or deputies present. Additional CAB members are normally notified of meetings that concern them through telephone calls or e-mail messages.

When the change manager has selected the CAB members who will review the change, the RFC is ready for review.

A few days before the CAB meeting, the change manager can send out a meeting notification and summary e-mail to all CAB members. The suggested contents of this e-mail are as follows:
Date, time, and location (if relevant) of the meeting.
Format of the meeting. As an alternative to holding face-to-face meetings, CAB meetings may be held using Microsoft NetMeeting® conferencing software or by telephone conference calls. NetMeeting is preferred because it enables CAB members to share documentation and use electronic whiteboards.
The reviewing order for RFCs (agenda). CAB members may be interested in only a small number of the proposed changes and might join the meeting only when necessary.
A link to all of the RFCs being reviewed at the meeting and a forward schedule of the change calendar for discussion.
Note The meeting notification must be sent to the attendees sufficiently far in advance to enable them to review the RFCs before the meeting.
   Affirm or Modify Voting Logic

After the CAB members have been selected and notified, the method by which they will approve the change must be determined. In an ideal world, a change request would get unanimous CAB approval. However, there will be changes that are controversial and changes where the risk/benefit balance is inconclusive. In such cases, the change manager must designate the voting criteria for approving the change prior to the CAB meeting so that everyone understands the rules before a vote is taken.

To define the voting process, a number of pieces of voting “logic” can be used either alone or in combination with one another. The change manager is responsible for establishing what voting logic the organization will use for change approvals and then applying it to each individual change. Examples of voting logic topics that might need to be addressed include the following:
Unanimous/majority decision/abstentions. Does the change require approval of all members of the CAB, that is, would a single vote for rejection cause rejection of the RFC? Or is a majority of approval votes sufficient to carry the change and, if so, what should be the size of the majority? Should abstentions be allowed, particularly when a unanimous decision is required?
Vetoes. Do any members of the CAB have the right to veto, meaning that if they reject a change, then the rejection stands, regardless of the size of the majority vote for the change? For example, the security manager's veto might have such weight for any RFC concerned with changes to an external website. Similarly, a decision allowing the approval of a change despite a majority vote against it should not be permitted.
One “group,” one vote. The CAB is often made up of (potentially) a number of representatives from specific groups within the organization—for example, several people from the networking team might attend the CAB meetings. In cases like this, only one vote should be allowed from the networking team. This maintains the balance of the voting system.
Quorum/required voters. Should there be a minimum number of people attending the CAB meeting and voting in order for an approve/reject decision to be made? This should be considered in case some CAB members are unable to attend a meeting or provide deputies, in which case a decision might be made by a small set of unrepresentative people.

A voting logic should be in place that applies to all RFCs by default. For example, “a 75 percent majority vote is required, all standing CAB members must be present and vote, and the security manager can always block a change.” This logic can then be adjusted on a case-by-case basis by the change manager. Such adjustments will depend on the type of change and who is sitting on the CAB for that change.

The actual vote should ideally take place electronically. In face-to-face meetings, it can be difficult to enforce the defined voting rules and to keep the discussions neutral. Voters could be swayed by perceived intimidation (for example, someone with a more aggressive or extroverted personality might force his or her opinion on others) rather than on the facts and the merits of the change.

The change manager records the voting logic that applies to the RFC in the change log.

If the CAB is using a virtual format, the change manager can use voting forms to define the number of votes needed to approve the change (majority or percentage) and to identify the groups or individual members of the CAB who have the power of veto, although the same measures may not always be suitable for use in face-to-face CAB meetings.

CAB Members Review the RFC

Each RFC on the agenda is reviewed by the CAB at the scheduled meeting. The change manager schedules, coordinates, and facilitates all CAB meetings. For each RFC review, the change manager must first ensure that the required quorum of voters is present at the meeting, that is, that all the required voters (or deputies) and the minimum number of voters are present, as defined by the voting logic for the RFC. If a vote cannot take place, the change manager must reschedule the review, and the RFC is placed in a pending state until then. The review can be deferred to the next scheduled meeting if time constraints allow. If not (for example, because the change must be made before the next scheduled meeting), then the change manager must arrange an extra meeting to review the RFC and possibly increase its priority.

Note CAB members do not have to be present for the entire meeting. They may join to discuss and vote on the changes that concern them, and leave as appropriate.

Change initiators are normally present at the CAB session that considers their proposed change. They may be requested to obtain additional information and then to re-present the RFC, or additional supporting information might be required from some other member of the CAB. For example, more detailed information about the security implications of the change might be needed from the security manager, or data about the wider impact on service levels might be required from the service manager. The CAB then schedules another meeting to review the new evidence and places the RFC in a pending state while the information is being obtained. The change log is updated with the request for more information and the date and time of the next review.

The CAB may also want to make changes to the RFC. Because change initiators must agree to any alterations, their presence at the meeting will speed up the decision on the RFC in light of these alterations.

When reviewing the RFC for impact and resource requirements, the CAB should consider the following items:
The impact that the change will have upon the business operation.
The effect upon the infrastructure and customer service, as defined in the SLA, and upon capacity and performance, reliability and resilience, contingency plans, and security.
The impact on other services that run on the same infrastructure (or on software development projects).
The impact on non-IT infrastructures within the organization—for example, security, office services, transport, and help desks that serve business customers.
The effect of not implementing the change.
The IT business and other resources required to implement the change, including the likely costs, the number and availability of people required, the elapsed time, and any new infrastructure elements required.
Additional ongoing resources required if the change is implemented.

Based upon these assessments and the potential benefits of the change, each of the CAB members should be able to decide whether to approve the change. The use of technology may allow CAB members to review and vote on an RFC without meeting in person. In cases where face-to-face meetings with all interested parties are impractical because of scheduling or distance restrictions, NetMeeting can be used. NetMeeting allows remote members to share documents, use an electronic whiteboard, transfer files, and hold text conversations. Note that NetMeeting can also be used to host voice and video conversations, if required.

CAB Members Vote on the RFC

After all necessary information has been presented, any agreed upon alterations to the RFC have been made, and discussions have been completed, the CAB votes on the change according to the defined voting logic.

For some changes, the CAB may determine that it does not have the authority to approve the change. For example, the CAB members may not have the required budgetary authority, or their span of authority may not encompass the anticipated business impact. In this case, the change request is escalated to the IT executive committee (ITEC), and the change log is updated accordingly by the change manager, who should include an objective executive summary containing the reasons for escalation and any relevant supporting documentation. The ITEC is a management committee with the budget and resource authority to make decisions about proposed major and significant changes within the IT environment. ITEC's decision is final, and a representative from ITEC notifies the change manager of ITEC's decision after it has been made. (The procedure for how the ITEC meets, reviews the change, and reaches its decision is not discussed here.)

When the CAB is able to approve or reject an RFC, they update the change log and inform the change initiator and all interested parties of the decision. If the decision is deferred to ITEC, its decision is again sent to the change initiator and other interested parties.

Authorize Emergency Changes

The emergency change process, which enables an organization to continue normal operations or restore them as quickly as possible, is an accelerated process that follows the normal change process to the extent that time constraints permit. Emergency changes need to be implemented quickly—for example, to prevent a potential security breach or fix a business-critical application. Because emergency changes are generally more disruptive and often prone to failure, the number of proposed emergency changes should be kept to an absolute minimum. Time constraints allow only limited testing and require that normal processes and controls be bypassed. Therefore, an emergency change needs to be fast-tracked through the change management system. Emergency changes cannot be authorized by a single individual and must be approved through a change advisory board emergency committee (CAB/EC).

The CAB/EC has the same purpose and performs the same functions as the regular CAB. The differences are that the CAB/EC membership is smaller than the regular CAB, and the CAB/EC is able to meet and make decisions at short notice. The CAB/EC must be empowered to make quick decisions without having to refer to the ITEC and must have the full authority to approve or deny emergency changes.

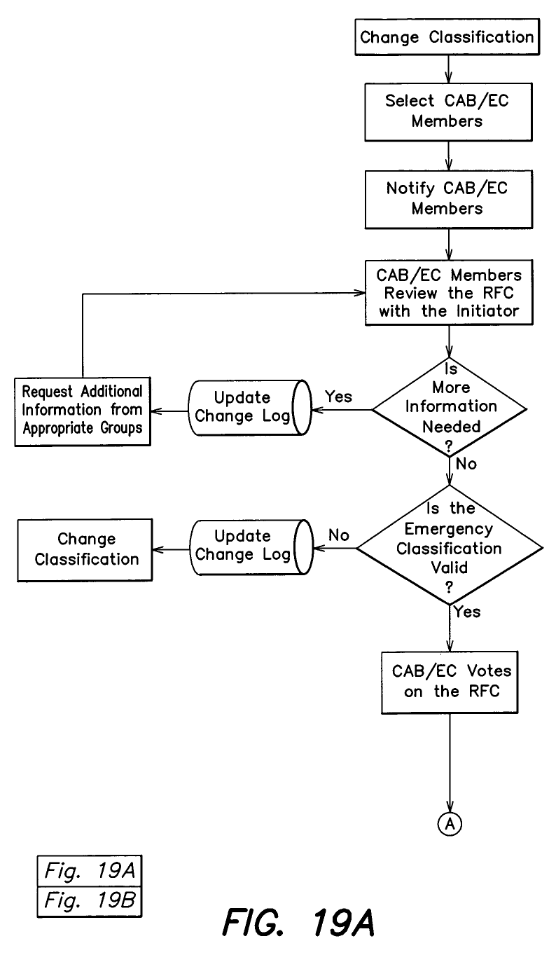

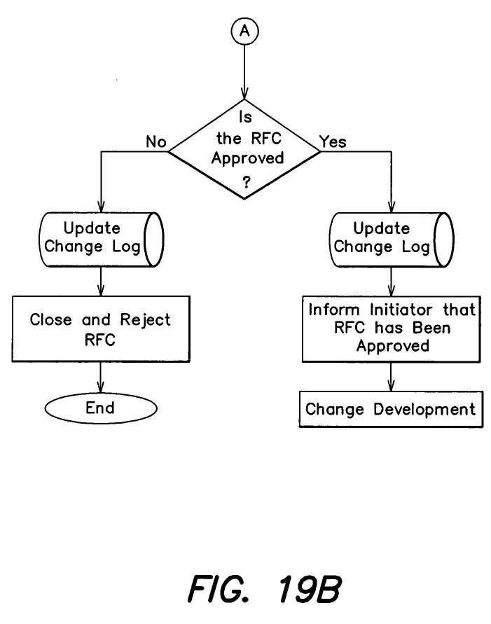

The process flow for emergency changes is shown in FIG. 19 and is similar to the process followed for nonemergency changes.

Select CAB/EC Members

The CAB/EC membership consists of a number of standing members, plus other members, depending on the nature of the emergency change. Ideally, the standing members alone should possess sufficient knowledge and authority to make a decision. The more people asked to attend a CAB/EC meeting, the less likely it is that all can attend at short notice, especially if such meetings are not a part of their normal day. Extra members of the CAB/EC should be asked, therefore, only if absolutely necessary. An example would be a change that affects areas that lie outside the knowledge and authority of the standing members. The change initiator for a particular RFC is an exception. This person needs to be a member of the CAB/EC in order to provide quick answers to their questions.

Because an emergency change can be requested at any time and because the emergency change requested needs to be deployed quickly, the CAB/EC has a very short timeframe in which to meet and vote. Since voting requires a quorum, the standing membership or appointed deputies of the CAB/EC must always be able to attend at short notice. This availability can be achieved by having an “on-call” roster for each role of the CAB/EC, whereby a person is available for each position on the CAB/EC at any time of day—either in person, over the phone, or by using other technology solutions.

The change manager should be able to add members to the CAB/EC as needed.

For an emergency change, the voting logic is that the change requires unanimous approval.

Notify CAB/EC Members

The change manager must contact each CAB/EC member personally to inform him or her of the emergency change request, when it will be reviewed, and what form the meeting will take.

As explained above, CAB/EC meetings are held on an as-needed basis with little advance warning. This means that normal notification methods may not be sufficient. If e-mail meeting requests are used, invitees should be given a short time period to acknowledge the meeting to the change manager; otherwise more direct methods of contacting CAB/EC members must be used.

CAB/EC Members Review the RFC

The CAB/EC reviews the emergency change request using the same criteria used for a regular change. The assessment of the risks and the impact are, in some ways, more important for an emergency change because the risks are usually higher and the testing of the change is minimal or nonexistent.

The presence of the change initiator at the meeting allows questions about the change and its impact to be put directly and be answered immediately. There may be a need to collect additional information and re-present the RFC to the CAB/EC before a decision can be made. In this case, the RFC is placed in a pending state until the CAB/EC can reconvene, likely within a very short time (an hour, for example).

The CAB/EC may decide that the change is not an emergency change and should be handled by the normal change process. In this case, the change manager reclassifies the change and updates the change log with the reason for reclassification. If the change initiator wants the RFC to be considered again as an emergency change, this person must provide additional supporting evidence to justify the need and resubmit the RFC to the change manager. The change manager can then bring the RFC, containing the new information, back to the CAB/EC. Again, this process can happen very quickly—in minutes or hours rather than days. If the change initiator agrees that the change is not an emergency change, the RFC returns to the change classification stage of the overall process for subsequent scheduling at a regular CAB meeting.

If not all members of the CAB/EC are available to meet face to face, NetMeeting can be used to facilitate their communication.

CAB/EC Members Vote on the RFC

When discussions are complete and it is agreed that all necessary information has been presented, the CAB/EC votes on the change. For an emergency change to be approved, a unanimous vote is required. In this case, a majority is not sufficient, considering the risks involved in making an emergency change.

If the RFC is approved, the change moves on to the change deployment stage, which again follows an expedited path to implement the change as soon as possible. Whichever decision is made, the change initiator and all other interested parties are informed of the decision, and the change log is updated.

The change manager should record the decision and document the vote (for or against) the RFC by updating the change log.

Summary

In summary, the change authorization process:

Defines the structure for authorizing changes from all categories and priorities.
Incorporates feedback from all role clusters involved in the authorization process when required.
Defines the functions of the change manager and the composition and functions of the CAB and CAB/EC in the change authorization process.
Utilizes voting logic for effective decision making.
Offers a feedback cycle for the change initiator to be involved in the authorization process.
   Change Development

After an RFC has been approved (using the appropriate path based on its priority and category), it moves into the change development phase. This phase is concerned with the steps necessary to plan the change, develop the deliverables of the change (for example, developing new code or configuring new hardware), and the handover to the release management process for the deployment of the change into the production environment.

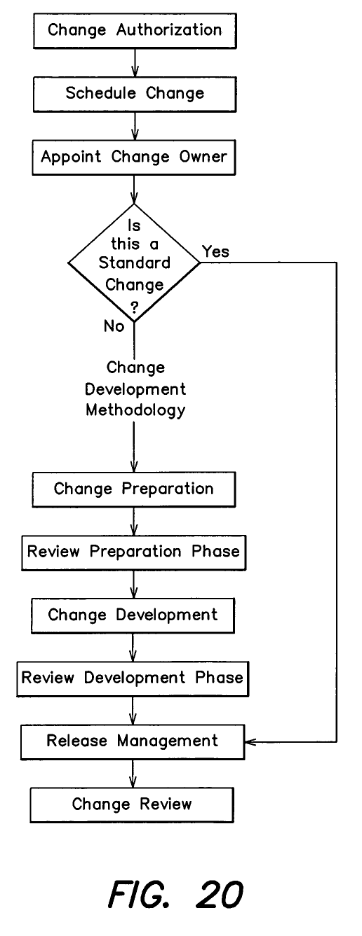

The processes involved in the change development and release phase are shown in FIG. 20.

The speed with which the steps in this process are executed can vary greatly. A small—but emergency—change may be planned, developed, and implemented in minutes. A change involving deployment of a new software package to an enterprise may take months or even years in the development and deployment phases. Because of this wide variation, considerable flexibility is required in the individual steps. However, some steps, such as the reviews, must always take place, even if they constitute only a very brief conversation between two people.

Whereas change deployment is led and organized by the MOF Team Model Release Role Cluster, other Team Model role clusters are also involved at this stage. Although specific activities depend on the type of change being deployed, Table 10 gives some examples of the activities that may be undertaken by different role clusters.

TABLE 10

| MOF Team Model Role | |
|---|---|
| Cluster | Change Development and Release Activity |
| Infrastructure | Provides additional technical expertise during change |
| | development and deployment. |
| Operations | Assists with the change development and deployment into the |
| | production environment, ensuring that the operational working |
| | practices can accommodate the change during and after |
| | deployment with minimal disruption. |
| Partner | Coordinates the involvement of any third-party resources and |
| | ensures that the change is successfully deployed into any |
| | outsourced services arrangement. |
| Release | Manages change deployment activity. |
| Security | Ensures that appropriate security features and elements are |
| | addressed in the change development, that security is not |
| | compromised during deployment, and that any additions or |
| | changes to security practices are implemented correctly. |
| Support | Provides support to the change development and deployment, |
| | ensuring that the help desk can assist users with any support |
| | needs during the deployment. |
| Service | Ensures agreed and projected service levels are not negated by |
| | the change development and that all changes have customer |
| | approval and fit into service improvement objectives. |

Schedule Change

After a change has been approved, it must be decided when to deploy it. The date and time of the change is entered into the forward schedule of changes, which is maintained by the change manager. The forward schedule of changes shows when all changes are to take place. Having a single change schedule makes it possible to show the available change windows (the times during which changes are permitted). It also ensures that multiple, interdependent changes are not scheduled at the same time; sometimes a change might be scheduled that would prevent all other changes (including standard ones) from taking place. When scheduling the change, notice must be taken of other changes that are dependent on the scheduled change or on which the scheduled change itself is dependent—for example, a prerequisite.

In some cases, it may only be possible to enter a tentative date for the change. This is the case for large changes that require a long development phase. As the development project progresses and the development project plan is drawn up and tracked, the date when the change will be implemented in the production environment becomes more definite. Nevertheless, the change date must be reviewed at intervals and adjusted as necessary.

The forward schedule of changes contains only minor, major, and emergency changes. Standard changes are not considered to have an impact on other types of change. Although standard changes are automatically approved for deployment, they must still be scheduled with reference to the forward schedule of changes. For example, installing a software application (standard change) could be prevented by a network upgrade (major change).

When scheduling a change, it is important not only to take into account the category and priority of the change, as well as any impact from changes awaiting deployment, but also to confirm any schedule effects on business priorities. For instance, deployment of a change may be scheduled to occur outside of normal working hours in line with existing service level agreements for the service affected. However, this should be confirmed in case there have been any changes to business priorities that may be affected if the change occurs on that date. For example, there may be days where there is lower risk to business productivity should the change need to be backed out.

It is useful to highlight key business priority dates, such as financial year end or predicted periods of high sales revenue, in the forward schedule of change as these become apparent, since changes can then be avoided at these key times. The Service Role Cluster will be able to provide this information to the change manager.

The calendar on a Microsoft Outlook, Exchange, or other e-mail program can be used to administer the forward schedule of changes. Outlook can be used to create appointments in the change schedule, and permissions can be set that allow the majority of users to read the calendar but permit only a limited number (the change managers group) to update or change it.

Adding color coding and using meaningful text in the change schedule entries make it relatively easy to identify emergency, major, and minor changes, or changes that affect a specific part of the business.

Appoint Change Owner

After the change has been scheduled, the change manager needs to identify and appoint a change owner to manage the change through the development and release process and into the production environment. The change owner can also be the change initiator. The change owner may have been involved as a technical expert earlier in the change life cycle when the initiator may not have known the full IT impact of a change he or she raised, or the change owner may be a new appointment, a person who is likely to be a subject matter expert in the area connected to the RFC and thus possess the technical abilities needed to manage the change to completion. In the case of small changes, the change owner might carry out the change personally. For larger changes, the change owner acts in the role of a project manager during the development and test phases and oversees the implementation of the change. The priority and category of the change should be part of the criteria used to appoint the appropriate change owner for a particular RFC. For example, for a high priority, major change to be implemented, the selected change owner may need to possess a certain level of project management skills or high seniority within the organization.

When the suitable change owner has been appointed and assigned to the RFC, the change manager records the change owner's name in the change log, and the change moves to the change development stage.

Change Development Methodology

All nonstandard changes pass through the change development methodology, which varies greatly in size and scope depending on the nature of the change. Some changes require more extensive and detailed work in each of the development phases than others.

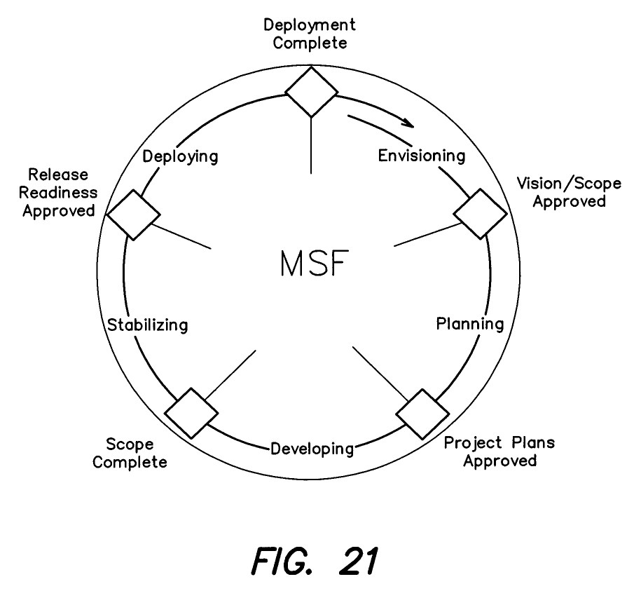

Because they represent a repeated, low risk change, standard changes do not pass through the development phase. For the other types of changes, the choice of methodology used in the change development stage is open, and many such methodologies exist. It is possible to follow the simple steps of the change development methodology, or the development process used internally within the organization. In addition, the Microsoft Solutions Framework (MSF) Process Model, shown in FIG. 21, can be used to structure the change development. More information on MSF can be found at http://www.microsoft.com/MSF.

The development methodology chosen must be sufficiently flexible to handle development work of any size. For example, something as simple as amending a process document, which passes through change management, can still be developed using MSF informally. In this case, the Envisioning and Planning phases are very short and do not involve many people. The Developing Phase does not need a complex project plan because it is mainly an authoring exercise and might involve only one or two people. On the other hand, a complex change, such as upgrading all desktop computers to Microsoft Windows® XP, is a very large project, involving many people across the organization, requiring long planning and development stages, and costing a large amount of money. In such a case, it is important to follow a formal development methodology so that the change manager can track the change's progress and coordinate any shift in the planned deployment date with other changes.

Emergency changes must also use the chosen development methodology, even though there is pressure to implement the change as quickly as possible. The amount of time spent in each phase is likely to be minimal, and reviews between the phases are likely to be merely quick meetings between the involved parties to verify that the milestone in question has been achieved. The methodology chosen should be flexible enough to allow this fast-track path through it, without skipping important checks along the way.

Note During the Developing Phase, and particularly at the milestone reviews (see below), the project team might abandon the change. This could happen for a number of reasons. For example, the Envisioning Phase might reveal that there is insufficient budget to achieve the change as desired; or during the Developing Phase, events such as a company takeover might make the change obsolete. For the sake of simplicity, these decision points are not shown on the flow diagrams. If, however, the change needs to be abandoned, it should be discussed at the next CAB, and the RFC closed as necessary. The change manager notes the reasons for abandoning the change in the change log and informs the change initiator and other interested parties.

Milestone Reviews

A solutions development framework such as MSF has review points as the development project moves from one phase to another—for example, from Envisioning through to Planning. The milestone review ensures that the preceding phase has been completed successfully and the project is ready to progress to the next phase. In some cases, as in a very small project, the review may be as simple as a discussion with a peer. However, before more complex changes can progress to the next phase, the approval of a number of people in different groups, perhaps a subset of the CAB representatives present for the change approval, may be required.

For any particular project, the milestone reviews may take different forms from one milestone to the next. For example, a full Vision/Scope Approved Milestone review by the CAB might be required at the end of the Envisioning Phase, when detailed costs of the deployment have been obtained and documented. A far smaller Project Plans Approved Milestone review might be sufficient at the end of the Planning Phase if there are no new issues requiring approval from the CAB.

The project review process ensures that progression from one MSF phase to the next is agreed upon by all the groups affected by the change. It links back into the change management process in that the RFC is referenced and updated in the review, and the reviewers have the option of halting the change and closing the RFC, if necessary, or escalating the decision to the ITEC.

The Project Plans Approved Milestone review is similar in many ways to the CAB review process, during which the initial decision about the change was made. The Project Plans Approved Milestone review can be regarded as reviewing the RFC again, but relying on more up-to-date information concerning costs or risks (bearing in mind that the basic change itself has already been approved). The same criteria used to select CAB members to authorize the change should be applied when selecting people to review the development process milestones.

For each milestone review, the change manager adjusts the CAB membership list as appropriate for the nature of the change, the milestone that has been reached, and the current overall status of the project (for example, more senior decision makers may be needed if the project is running late or is over-budget, or if other serious risks have been identified).

Milestone reviews normally occur at the same time as the regular (usually weekly) CAB meeting that reviews RFCs. If the milestone review must take place sooner than the next scheduled meeting, then an as-needed CAB meeting may be required. Each scheduled milestone review is reviewed by the CAB at the CAB meeting. When the presentation of information and discussions has been completed, the CAB votes on the change, using the defined voting logic. If no decision is made, the same principles and procedures are followed as in the initial CAB review: the decision is passed to the IT executive committee. See the CAB Members Review RFC section for a description of the escalation procedure, which is the same as for the original RFC review. If the CAB votes to not approve the review, this can have one of two consequences:
The CAB may decide that all the criteria for passing the review have not been met, but that the project can meet them with more work in some areas. In this case, the CAB fails the project in the review, but the RFC and the approved change remain in effect. The RFC is returned to the Deploying Phase just completed. The change manager updates the change log, detailing the additional work required for the change to progress to the next phase.
Alternatively, the CAB (or possibly the ITEC if the decision was escalated) may decide to not approve the milestone and to cancel the change altogether. This might happen during the Planning Phase, for example, if it is decided that the project cannot be completed on time with the functionality required and within the available budget. Rather than rework the plan, the CAB might decide to cancel the project altogether and provide the solution in a completely different way, such as outsourcing. In this case, the RFC is closed.

In either case, the change is updated with the reasons for the decision and the change initiator and any other interested parties are informed.

If the CAB approves the milestone review, then the deployment process moves on to the next phase, the release process. Please see the Release Management Service Management Function Guide for more details on the specific practices involved in this process.

Summary

In summary, the change development and release process:

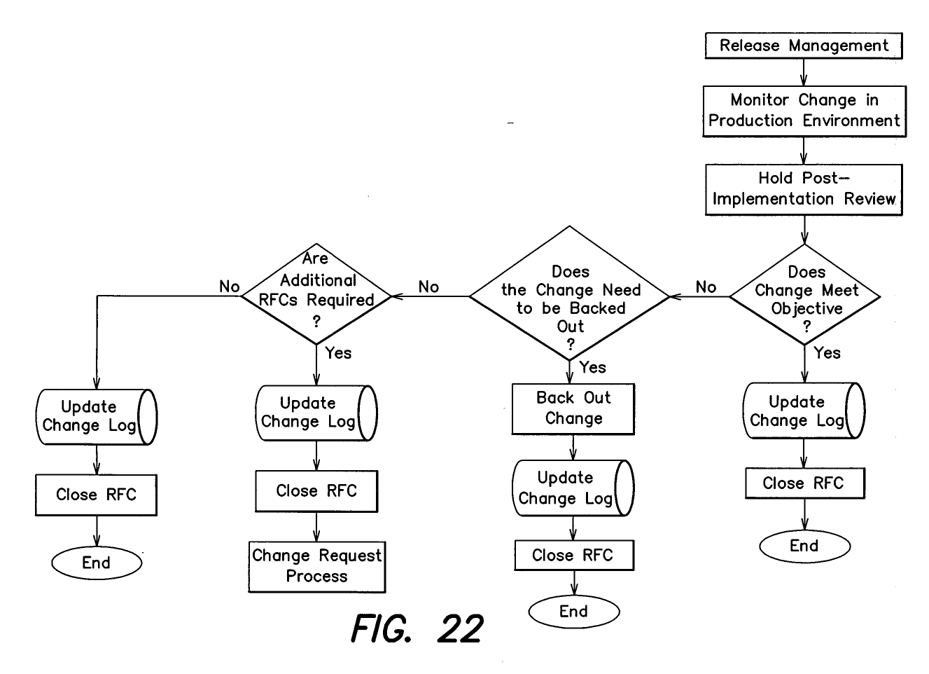

Schedules the change according to business priorities, change pipeline, category, and priority.
Appoints a suitable change owner according to the requirements of the change in terms of technology, size, priority, and category.
Ensures that the change development process follows a recognized development life cycle.
Conducts milestone reviews, with the participation of CAB members, to ensure that each phase has been completed successfully.
Ensures that the change developed and passed through to the release process has met acceptance criteria.
   Change Review
   Following a successful release and deployment into the production environment or, as in the case of a standard change, just a deployment into production, a review process must be conducted to establish whether the change has had the desired effect and has met the requirements from the original request for change. The process for the change review is shown in the flow chart in FIG. 22.

In most cases, this review process might be very brief. For a standard change, for example, where the effect has been small and the results relatively predictable, the review process may be limited to checking that the user has the desired functionality from the change, such as the availability of a new Word template. The other steps in the process can then be carried out in as-needed meetings or telephone calls with the change manager.

In addition to changes that take the “normal” route through the change process, emergency changes should be reviewed as well, despite the speed in which the deployment may have been carried out. In fact, it is more important to review the implementation of emergency changes because their typically curtailed testing leads to greater risks. It is therefore necessary to determine as soon as possible if the change resulted in any adverse effects.

All of the MOF Team Model role clusters should be involved in the change review activity. As with the other change management activities, the Release Role Cluster takes the lead in directing the change review, but each Team Model role cluster has specific areas of concern related to its responsibilities, as listed in Table 11.

TABLE 11

| MOF Team | |
|---|---|
| Model Role | |
| Cluster | Change Review Activity Area of Concern |
| Infrastructure | Did any technical or capacity issues |
| | occur during the change? |
| Operations | Did any operational issues occur during |
| | and after the change? |
| Partner | Were there any third-party or partner issues |
| | with the change? |
| Release | How did the change progress through |
| | the change management |
| | process and where can lessons be learned? |
| Security | Did any security issues become |
| | apparent with the change? |
| Support | Were any supportability issues evident |
| | during or after the change? |
| Service | Were any service levels breached |
| | during or after the change? |

Monitor Change in Production Environment

In order to determine whether the deployed change has been effective and has achieved the desired results, it is necessary to monitor the changes in the production environment. For a small change, this may consist of checking on the desired functionality—for example, for a change in Group Policy allowing a desktop setting to be changed. For larger changes, it might require the monitoring of network and server information, performance data, event logs, or response times.

A number of different tools and technologies are available for monitoring a change in the production environment. These include but are not limited to Microsoft Operations Manager (MOM) and the Windows Network Monitor, Replication Monitor, and Performance Monitor tools. The actual tools used depend on the nature of the change, the components of the IT infrastructure that are affected, and the skills and experience of personnel performing the monitoring activity.

Hold Post-Implementation Review

After sufficient information has been gathered from monitoring to determine the effectiveness of the change, a post-implementation review is held. The time interval between the change implementation and the review depends on the size of the change made and how quickly the effect of the change can be measured. For example, a change may have immediately measurable adverse effects on users or the network, as evidenced by a large increase in calls to the service desk from users unable to access a network resource. In such cases, the review must be held within a very short time in order to decide whether to back out the change or make other changes to fix the situation. Other changes, such as an increase in network capacity, may require several weeks to gather enough data to measure the change's effectiveness.

The format of the post-implementation review also depends on the planned and actual impact of the change. A standard change with little overall effect may require only the change manager, the change initiator, and the change owner to have a short meeting, possibly by telephone or NetMeeting, where they agree that the change was successful. In contrast, a major change involving the rollout of a new desktop operating system will probably require a formal meeting of several interested parties to review the data from the monitoring phase and compare the effects of the change to the initial objectives.

In all cases, the change manager schedules and moderates the review meeting and the change initiator should attend. During the review, reference must be made to the original RFC, which states the objectives of the change and, ideally, offers some measurable indicators for gauging the effectiveness of the change. The measured effects of the change can be compared with the desired effects in order to decide whether the change has met its objectives.

As well as making a success/failure decision on the change implementation, the review should also look at how the change was deployed and whether it was implemented on time and on budget. This exercise should result in the documentation of the lessons learned from the change. Review feedback is then sent to all parties involved in the change in order to encourage and enable future process improvements.

Depending on the number of changes being dealt with, several changes might be reviewed during one post-implementation review session. However, some changes—because of their size and complexity—might warrant individual reviews.

Close Successful Changes

If it was deemed that the change has met the objectives, the change log can be updated and the RFC closed.

Back Out Changes

If the change has not met the objectives, then a decision needs to be made about what, if anything, should be done. If the change is affecting users or parts of the IT infrastructure adversely, a decision might be made to back out the change and remove it from the production environment.

In such cases, the issues involved in conducting the backout should be evaluated, including:

The amount of effort required to perform the backout.
The effect it might have on other (either planned or already deployed) changes.
The possibility that users are already using the changed system, although not to the best effect, and removing some functionality that the users have become used to may be worse than leaving it as is.

In this last case, it may be better to initiate new RFCs to fix the problem, as discussed next in the Submit Additional RFCs section.

If it is decided that backout is required, the defined backout plan for the RFC is followed. The review meeting should decide on the timing. Although the backout would normally happen as soon as possible, it may need to wait until it can be implemented without causing additional adverse effects. For example, if the adverse effects of the change are not too great and a backout is nonetheless thought to be necessary, it might be delayed until the following weekend.

After the backout has been accomplished, further measurements and review should take place to ensure that it effectively restored the infrastructure to its pre-change state. If the backout was only partially effective, further RFCs may be required to fully restore the state of the infrastructure.

In all cases, the change log is updated with the reasons for the backout and the change initiator and other stakeholders are informed. The RFC is then closed.

When reviewing emergency changes, if it is seen that too many attempts to deploy a specific emergency change have failed, three questions need addressing:
Has the problem been correctly analyzed?
Has the proposed remedy been adequately tested?
Has the solution been correctly implemented?

In such circumstances, it might be better to provide a partial service (with some user facilities withdrawn) in order to allow the change to be thoroughly tested rather than to suspend the service temporarily, and then deploy the change.

The tools and technology used to back out the change will vary according to the type and nature of the change. Software applications deployed using Systems Management Server, for example, can normally be rolled back using the Uninstall option or Group Policy settings to disable or delete the appropriate Group Policy object.

Whether or not the change was successful, the fact that the RFC has been closed and the reason or reasons for closure must be recorded by updating the change log. An e-mail should be sent to the change initiator and other interested parties indicating that the change has been reviewed and is now closed. The e-mail should also provide information about the success or failure of the change and any detailed comments added by the change manager.

Submit Additional RFCs

Even if an implemented change has not fully met the objectives desired for the change, the review may determine that backing out the change is too costly or too risky, or the desired effect can be achieved with less expense by making additional changes. In the latter case, other changes may be required to rectify the problems caused by the change. For example, a service pack or hotfix may be required to fully implement the functionality to the level originally desired.

In this case, new RFCs should be submitted for any additional changes required to keep the production enviroment running and to achieve the results originally desired. The priority of such RFCs needs to be set appropriately: an emergency change might be required to minimize the time during which the adverse effects of the original change are experienced.

However, care must be taken not to implement “panic” changes to try to fix a problem caused by a previous change. This can become a vicious circle of changes to fix problems caused by a previous change that was itself implemented to fix a problem. If there is any danger of following such a spiral path, the change should be backed out instead.

In all cases, the change log is updated with the decisions made and the RFC is closed, although any new RFCs submitted will refer to the original RFC.

Accept Issues and Continue

Even if a change has not fully met the desired objectives for the change, the review may still determine that the change should not be backed out and that it is not desirable or cost effective to make more changes. For example, many users may already be using a new system, so backout is not a justifiable option, and the cost of fixing the problem may be too high. Instead, there may be options available to work around the shortcomings of the system. Such workarounds should be documented. If they are user workarounds, the service desk should be informed so that the information can be easily made available to the users. If the workaround is an additional manual process that some IT staff need to take, then they should be so informed.

In this case, the change log is updated with the reasons to accept the change and any workarounds that are implemented. The change initiator and other interested parties are informed and the RFC is closed.

Summary

In summary, the change review process:
Monitors and reviews performance of the change after implementation into production in line with the objectives of the original RFC and the objectives of the MOF Team Model role clusters.
Reviews lessons learned from the deployment and documents them for future benefit.
Deals with unsuccessful change implementations by backing out, considering further remedial changes, or using the “accept issues and continue” policy.
Closes successful RFCs and informs the initiator.
   Roles and Responsibilities

Roles associated with the Change Management SMF are defined in the context of the management function and are not intended to correspond with organizational job titles. Specific roles have been defined according to industry best practice. In some cases, many persons might share a single role; and in other cases, a single person may assume many roles, or at least more than one role. It is especially likely that a person will assume different roles with respect to different SMFs. For example, the change owner for change management is likely to be the release manager for release management.

The roles also correspond to the roles defined within the seven role clusters of the MOF Team Model. These role clusters (Release, Infrastructure, Support, Operations, Partner, Security, and Service) represent at a high level the functions that must be performed in an IT environment for successful operations. The roles within each cluster are closely related to each other.

The three significant roles defined for the change management process are:

Change initiator
Change manager
Change owner

Committees are also defined in terms of the roles they play and the responsibilities they have in the context of the change management function. Three committees typically have management responsibilities for the change management process. These three committees are:
Change advisory board (CAB)
CAB emergency committee (CAB/EC)
IT executive committee (ITEC)
   Change Initiator

The change initiator initiates changes by submitting an RFC to the change manager. Everyone in the organization should be authorized to initiate an RFC. Below the manager level, however, it is recommended that employees submit RFCs to their managers who review them to ensure that the change requested is in keeping with business strategy and the vision for that area before passing them to the change manager. The change initiator is responsible for completely filling out the RFC form, which includes the reason for the RFC, the requested implementation date, and the systems and personnel affected by the change. This person is notified whether the change was approved and is kept up-to-date on the status of the RFC throughout the change process. The change initiator assists the change manager and CAB in determining the RFC priority and, at the conclusion of the change, participates in the post-implementation review.

Change Manager

The change manager is responsible for managing the activities of the change management process for the IT organization. This individual focuses on the process as a whole more than on any individual change. However, the change manager is involved in every step of the process—from receipt of an RFC to the implementation of the change in the IT environment—and is ultimately responsible for the successful implementation of any change to the IT environment. The change manager's responsibilities include:
Receiving RFCs and ensuring that they are properly recorded in the change log.
Selecting CAB members and facilitating CAB meetings.
Preparing CAB meeting agendas and providing all necessary review information to the CAB members prior to the meetings.
If necessary, assigning teams to conduct RFC impact analyses and risk assessments.
Analyzing and prioritizing RFCs.
Categorizing, assigning change owners, and scheduling RFCs, subject to approval by the CAB.
Approving requests for minor changes.
Providing change notification to change initiator and other affected parties.
Monitoring the successful completion of all RFCs, including the change development project phases and ensuring that these processes follow the change schedule.
Reviewing and evaluating the change process.
   Change Owner

The change manager assigns (with the CAB's approval) an individual to be the change owner for a particular change. The change owner is responsible for planning and implementing a change in the IT environment. The change owner assumes responsibility upon receiving an approved RFC from the change manager or the CAB. The change owner is required to follow the change schedule approved by the CAB. For changes that are significant enough to require following a change development model—for instance, the MSF Process Model for application development—this individual is responsible for coordinating the project phases of the assigned change.

For standard changes, the service desk is typically the change owner. For major, significant, and minor changes, the change owner may also serve as the release manager.

The change owner should routinely provide project status feedback to the change manager and identify any problems as they arise. The change owner presents all formal updates and proposals to the CAB after the CAB approves the RFC for passage through the various MSF phases.

The change owner must work with the change initiator to ensure that the change meets the change initiator's requirements and that it successfully corrects any problems or provides the correct system enhancements intended by the RFC.

After implementing the change, the change owner assists the change manager in evaluating the change process as it applies to the particular change. The change owner also coordinates and presents the post-implementation review analysis to the CAB.

Change Advisory Board (CAB)

The CAB is a decision-making body for the IT organization and evaluates and votes to approve or reject RFCs.

CAB Membership

The CAB is made up of individuals with stakeholder interest in the production environment. Since RFCs can impact any part of IT and any organizational group, the makeup of the CAB should reflect the focus of the particular RFC being reviewed. However, a core group of individuals from IT operations is permanently assigned to the CAB. This group may include representatives from the MOF service management functions (Release Management, Capacity Management, Configuration Management, Availability Management, Security Management, or Service Desk) and should contain at least one member from each of the seven role clusters in the MOF Team Model.

The remaining members of the board may vary depending on the expertise required to effectively evaluate each RFC and the areas directly affected by the change, as determined by obtaining information from configuration management about the impacts of the change. The change manager is responsible for selecting the CAB members for each change. For large hardware and/or software changes, the change manager may decide to appoint an OEM vendor representative to the CAB. This facilitates the communication and the coordination of tasks between the vendor and organization. Having a vendor representative on the CAB also eases the resolution of problems during the change and release processes.

In general, the CAB should be composed of individuals with a wide range of expertise. Collectively, the individuals should be familiar with business requirements, the user community, IT system technology, and the organization's application development, testing, and support staffs.

CAB Responsibilities

The CAB should meet at regular intervals (perhaps weekly for a large organization) to review, prioritize, approve, and schedule RFCs. It is common for the CAB to consider more than one RFC in a session. In this case, members might come and go during the meeting as the changes relevant to their area of concern are considered.

The change manager directs the CAB in a vote to approve or reject changes. In order to approve RFCs, the board must have the authority to make budget- and resource-related decisions. The board also reviews the status of each change throughout the change process, assesses the progress with respect to the approved schedule, determines how to correct any identified problems, and communicates its findings to appropriate managers and stakeholders.

Those major or significant changes that are not decided upon by a majority vote may be referred to the IT executive committee. The change manager is responsible for deciding if the disputed change is rejected or should be forwarded to the IT executive committee.

Change Advisory Board Emergency Committee (CAB/EC)

The CAB/EC is a subset of the CAB and is responsible for assessing and approving any changes classified as emergency. Members of the CAB/EC must have the flexibility to meet at short notice or to provide recommendations using e-mail or other forms of communication.

IT Executive Committee

The function of the IT executive committee (ITEC) is to approve disputed changes that have been escalated to the ITEC by the CAB or changes that the CAB does not have the authority to make. Under these circumstances, the committee performs the same tasks of analysis and authorization that the CAB conducts. Following authorization by ITEC, the CAB has the responsibility for scheduling the RFC and monitoring the change process. Representatives from all of the IT groups within the organization are on the executive committee. Typically, managers who have the authority to make decisions regarding budgets and resources fill these positions. Table 12 summarizes the responsibilities of each role in change management.

TABLE 12

| Roles | Responsibilities |
|---|---|
| Change | Initiates the change. |
| initiator | Follows processes for submitting an RFC. |
| | Assists the change manager in updating the RFC. |
| | Provides input in the post-implementation review. |
| Change | Receives RFCs and ensures that they are properly |
| manager | recorded in the change log. |
| | Reviews, updates, and validates RFCs. |
| | Selects CAB members and facilitates CAB meetings. |
| | Prepares CAB meeting agendas and provides all |
| | necessary review information to the CAB members prior to |
| | board meetings. |
| | Assigns teams to conduct RFC impact analyses and |
| | risk assessments. |
| | Escalates RFCs that the CAB cannot decide to the IT |
| | executive committee. |
| | Analyzes, prioritizes, classifies, and schedules RFCs. |
| | Approves minor changes unless they are also |
| | emergency changes. |
| | Provides change notification to change initiator and |
| | other affected parties. |
| | Monitors the successful completion of all RFCs to |
| | ensure that the processes used follow the change schedule. |
| | Reviews and evaluates the change process. |
| Change | Receives approved changes from the CAB. |
| owner | Follows the change schedule that the CAB approves. |
| | Coordinates the phases of the change development |
| | project (as applicable). |
| | Provides project status feedback to the change |
| | manager and CAB. |
| | Identifies any problems as they arise. |
| | Works with the change initiator to ensure that the |
| | change meets the change initiator's requirements. |
| | Reports status and presents findings to the CAB. |
| | Prepares for and leads the post-implementation |
| | review. |
| Change | Assesses and approves changes to the production |
| advisory | environment. |
| board | Reviews the status of a change throughout the change |
| (CAB) | process. |
| | Assesses progress with respect to the approved |
| | schedule. |
| | Determines how to correct any identified problems. |
| | Communicates findings to appropriate managers and |
| | stakeholders, including the IT executive committee that they |
| | represent. |
| CAB | Assesses and approves emergency changes to the |
| emergency | production environment. |
| committee | Reviews the status of an emergency change |
| | throughout the change process. |
| | Updates the CAB of emergency change status. |
| IT | Approves major changes to the IT environment when |
| executive | the CAB cannot reach a final conclusion. |
| committee | Performs the same tasks of analysis and authorization |
| | that the CAB conducts. |
| | Has the requisite authority to veto RFCs (if the |
| | committee deems it necessary) that the CAB has approved. |

Relationship to Other SMFs

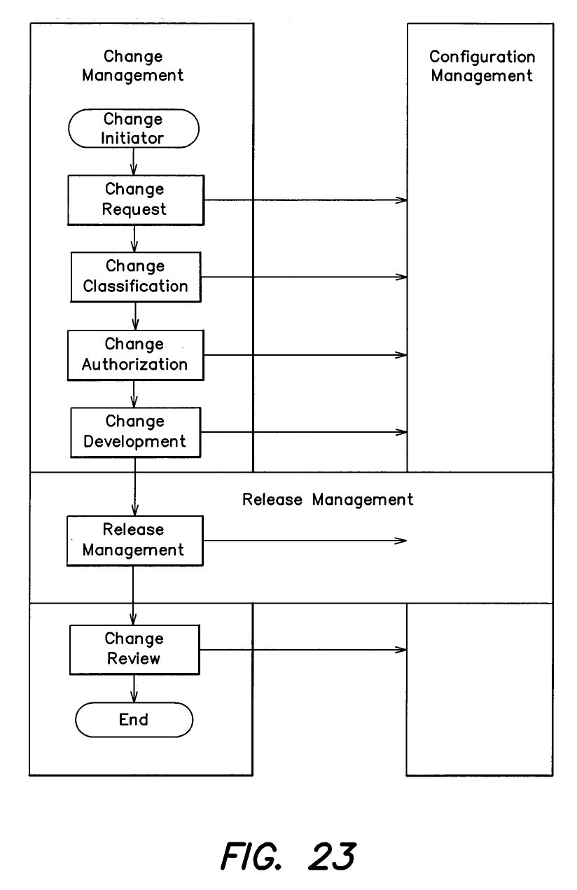

There is a close relationship between the three service management functions (Change Management, Configuration Management, and Release Management) that make up the MOF Changing Quadrant. FIG. 23 illustrates the relationship that exists between these three SMFs.

Change Management:

Provides the authorization and tracking (RFC, change log, and reviews) processes to ensure only approved changes are deployed.
Needs configuration management to assess the impact of change on all potential CIs.
Needs release management to package the changes for successful deployment with minimal disruption to production.
   Configuration Management:
Provides a managed database (CMDB) for the change logs, RFCs, definitive software library (DSL), definitive hardware store (DHS), release package, and all CIs.
Needs change management to ensure that only approved changes are deployed and all tracking of the authorization process is complete.
Needs release management to update the CMDB with the release package after deployment.
   Release Management:
Provides a packaged release for all changes deployed into production.
Needs change management to approve changes and track them throughout the release process.
Needs configuration management to assess the impact of changes to CIs and to provide a definitive store for the release package.

All other service management functions have a relationship to change management in that there is a direct effect on each SMF as change management is applied to that particular area. This not only applies to each of the technical areas covered within the Operating Quadrant, but also to changes that may affect the SMF processes in the Supporting and Optimizing quadrants.

Recommended Technologies

All organizations intending to use the Change Management SMF to effectively manage changes in their production environments can use certain tools and technologies to aid in this process. The number and complexity of these tools depend on the size of the organization and the type of changes that need to be made.

A number of Microsoft tools can assist with the change management process:

RFCs can be submitted to the change manager using e-mail messaging programs, such as Microsoft Outlook or Microsoft Exchange. Templates for the RFC can be created in Word or on Web forms.
The calendar function of Microsoft Outlook can also be used to manage changes in each phase of the process, and alerts can be set up for the timescales required for the authorization, development, deployment, and change review processes. It can also be used to publish a forward schedule of change.
Microsoft Visio® 2002 Enterprise Edition drawing and diagramming software and Microsoft Systems Management Server (SMS) are tools that can assist the change owner in defining the scope of a change and affected services.
SMS is also a software distribution mechanism that enables the change manager to report on the progress of a change following release, and can be useful in the review process.
Microsoft Project is a tool that enables the change manager to manage both simple and complex changes.
Exchange and NetMeeting allow the CAB to meet virtually in order to approve or reject RFCs.
   Configuration Management SMF

Configuration management is a critical process responsible for identifying, controlling, and tracking all versions of hardware, software, documentation, processes, procedures, and all other inanimate components of the information technology (IT) organization. The goal of configuration management is to ensure that only authorized components, referred to as configuration items (CIs), are used in the IT environment and that all changes to CIs are recorded and tracked throughout the component's life cycle. To achieve this goal, the configuration management process includes the following objectives:
To identify configuration items and their relationships and add them to the configuration management database (CMDB).
To enable access to the CMDB and CIs by other SMFs.
To update and change CIs following changes to IT components during the release management process . . .
To establish a review process that ensures that the CMDB accurately reflects the production IT environment.
   Key Definitions
   Configuration baseline. A configuration of a product or system established at a specific point in time, which captures both the structure and details of that product or system and enables that product or system to be rebuilt at a later date.
   Configuration control. Activities that control changes to configuration items. They include evaluation, coordination, approval, or rejection of changes.
   Configuration item (CI). An IT component that is under configuration management control. Each CI can be composed of other CIs. CIs may vary widely in complexity, size, and type, from an entire system (including all hardware, software, and documentation) to a single software module or a minor hardware component.
   Configuration item attributes. The information recorded in the CMDB for every configuration item identified, ranging from the item's name, description, and location to technically detailed configuration settings and options.
   Configuration management database (CMDB). A database that contains all relevant details of each configuration item (CI) and details of the important relationships between CIs. The database can include ID code, copy and serial number, category, status, version, model, location, responsibility, or historical information about the item. The level of detail contained in this database depends either on the aims or on the degree to which information is to be available.
   Configuration manager. The role that is responsible for managing the activities of the configuration management process for the IT organization. The role also selects, assigns responsibilities to, and trains the configuration management staff.
   Processes and Activities
   Process Flow Summary

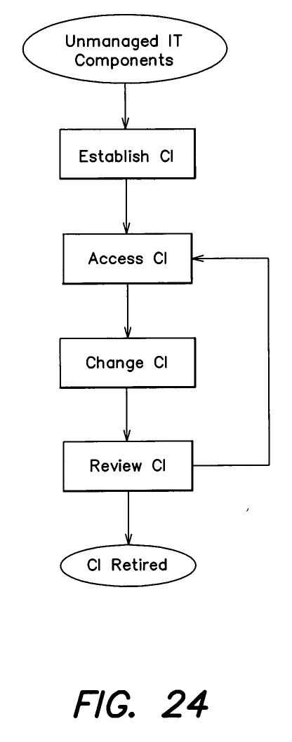

Configuration management is graphically represented in the form of a process flow diagram in FIG. 24 that identifies the activities needed to successfully manage and control key components of an IT infrastructure.

This high-level overview can be further broken down into a number of detailed activities and process flows, which are summarized below. Together these detailed activities and process flows provide a comprehensive blueprint for the configuration management process.

Establish Configuration Items (CIs)

Assuming the need to track and control changes to an IT component, the process of adding an item to the CMDB involves first deciding upon the appropriate level of detail necessary to track and control change. Next, configuration items (CIs) are created in the database to permit management of components at this level.

One of the key benefits configuration management provides, in addition to asset management, is the modeling of relationships between IT components. These relationships need to be identified and connections built between configuration items in order to model the real-world situation. For example, a workstation is made up of a desktop computer, operating system, and applications, and the workstation is connected to and uses the network. The proper understanding and documentation of relationships between IT components makes it possible to perform detailed impact analysis on a proposed change.

Access Configuration Items

After information about IT components and relationships has been added to the CMDB, it can then be used by other SMFs. Change management, for example, uses the relationships defined within the CMDB to determine the impact of a change on other components within the IT environment. Problem management uses the CMDB as a resource to identify which CIs are the root cause of incidents, and so on.

Change Configuration Items

As release management begins to make changes to IT components, corresponding changes must be made to the CMDB. Without accurate and up-to-date information, the value of configuration management is lost. This process should be done automatically, wherever possible. The amount of information and the frequency of change make manual data entry impractical for all but the smallest organizations.

Review Configuration Items

The accuracy of the information stored in the CMDB is crucial to the success of the Change Management and Incident Management SMFs, as well as other service management functions. A review process that ensures that the database accurately reflects the production IT environment needs to be established.

Note A more fundamental review should also be carried out at periodic intervals to establish whether the information in the CMDB is relevant to the business and is being managed at the correct level of detail.

Setup Activities

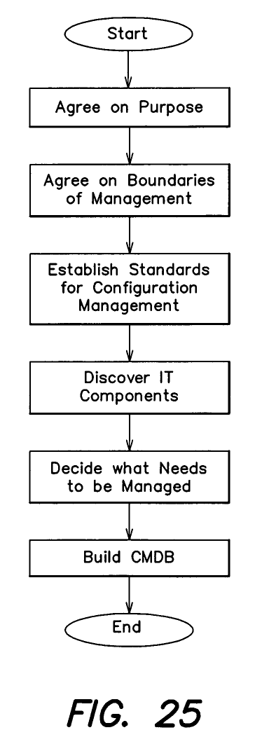

Prior to initiating the configuration management process flow activities described above, a number of detailed setup and planning activities must be completed in order to use configuration management effectively. The following process flowchart (FIG. 25) identifies these activities and the sequence in which they should be performed.

One-time configuration management setup activities necessarily precede the daily, ongoing configuration management process and involve a great deal of decision making and planning. Setup activities begin with deciding upon specific aims and objectives (the purpose) the organization intends to achieve by establishing a configuration management process. Issues to be considered include the scope of the IT environment to be managed and the level at which it needs to be managed. Participants in the discussions of purpose should include representatives from all parts of the organization that will be affected, and business relevance should be a guiding decision factor.

A second major setup activity involves identifying the entire set of IT components that exist within the agreed management boundaries. This leads to more decisions: determining the subsets of these components that need to be managed.

With very few exceptions, all the information necessary to manage the selected IT components needs to be stored in a CMDB hosted in a database product. Building the CMDB is the third major setup activity. It includes building table definitions and creating outline reports. An organization may have one or more CMDBs.

Finally, setup also includes design and development tasks that are specifically related to use of the CMDB. Policies and procedures for using the database, such as designing security and access restrictions and developing maintenance routines (which include backup and recovery procedures), must be established. Only after these have been accomplished can the database be populated.

Configuration management setup activities typically involve all of the MOF Team Model role clusters. Their involvement varies, however, based on the particular role cluster, as shown in Table 13

TABLE 13

| Role cluster | Involvement in setup activities |
|---|---|
| Infrastructure | Actively involved in all setup activities, including all decision-making |
| | and technical involvement in building the CMDB. Normally provides |
| | resources to complete this activity. |
| Operations | Provides operational perspective in agreeing on purpose and boundaries |
| | during setup activities. |
| Partner | Provides partner/third-party input into agreeing on purpose and |
| | boundaries. |
| Release | Manages and owns the setup activity for configuration management. |
| Security | Involved in all security-related issues during setup. |
| Support | Provides support perspective in agreeing on purpose and boundaries |
| | during setup activities. Also provides direct support for the setup activity. |
| Service | Ensures that the requirements of IT services are reflected in any setup |
| | decisions made. |

Agree on Purpose

The first and most important step in any project leading to the deployment of configuration management is to reach an agreement on its purpose, articulated in terms of key aims and objectives. These will act as terms of reference, helping to define the level at which the organization wishes to track and control change and to identify the IT components and services that should be regarded as “in scope” of the configuration management function.

Agreeing on a purpose entails obtaining a detailed understanding of the current situation (background). The issues and problems that exist in the current environment are often the main factors behind a decision to implement this function. For example, if a number of changes seemingly unrelated to line-of-business (LOB) applications have had an impact on them, there is clearly a need to understand and model the links and relationships between these IT components. In fact, the ability to model relationships and allow change management to look at the potential impact of a change is one of the key benefits that configuration management provides.

When discussing aims and objectives, representatives from all parts of the organization that have a responsibility for IT components and services should be included. Although configuration management can be used to successfully manage IT components within a small part of the organization, the benefits are only fully realized when it is used throughout.

The following two examples illustrate how aims and objectives relate to the level of tracking and controlling change and the scope of configuration items to be managed:
Although a workstation is made up of a number of components, such as motherboard, processor, operating system, and software applications, an organization may wish to track and control change to the operating system and installed software applications only.
An organization has offices in several countries, with each country responsible for the management of local IT resources. It would be reasonable to assume that each country would want to use configuration management to track and control change to its own resources.
   Agree on Boundaries of Management

Ideally, information about all components and services of interest to change management would be recorded in a single CMDB. In practice, however, organizational issues, such as a widespread geographic structure, delegated administration, and ownership of specific IT components, will dictate the contents of a particular CMDB.

In the example just cited of a geographically dispersed organization, each country would likely want to use a CMDB that contains only the local resources (the resources for which it is responsible). This ensures responsiveness and keeps database size and complexity to a minimum.

In most cases, the impact of a change to the local environment is restricted to the country in which the change is applied, so there is little need to maintain configuration data about IT components in other countries. The installation of corporate standard software on a client in Edinburgh, for example, has no impact on similar clients in Cambridge or Seattle.

There are some changes, however, that will impact IT components on a much larger scale. If a change request requires that the Microsoft Windows NT® 4.0 master domain (which contains all user accounts) be upgraded to Windows .Server™ 2003, users in more than one country and location could be affected by it.

A best practice would be to create processes and procedures that ensure other groups are notified whenever certain types of changes are proposed. The types of changes that could fall into this category include upgrading or replacing international lines or working on network services linked to a critical LOB application.

The responsibilities and placement of the service desk and the support model should also be considered at this point. If the service desk uses the “follow the sun” model (using geographic time zones to cover a 24-hour day) to provide 24×7 support, it must be able to access the CMDB that contains the IT components mentioned in the call. If a single database is not being used, it may be necessary to make a local copy of any remote CMDB to reduce the impact of network delays and to ensure that support personnel can access the data in case of a network failure.

After the geographic organizational issues have been resolved, another organizationally related aspect of scope that needs to be considered is the type of resources that might be recorded and tracked in the CMDB.

For example, the setting up of a desktop computer and operating system is normally the responsibility of the IT department, but the setting up of a work area, which includes desk, chair, and telephone, is the responsibility of facilities. A new employee requires a desktop computer (from IT) and a telephone, desk, and chair (from facilities). If information from both groups were to be recorded in a single CMDB, it would be quite simple to identify and coordinate delivery of the infrastructure components necessary to support the new user.

In practice, however, the CMDB is likely to contain information about IT components and services only. Facilities normally uses another system, such as the asset register, to manage the resources it owns. A manual procedure needs to be established that ensures that both groups are informed of changes that affect the resources under their control.

Establish Standards for Configuration Management

Configuration management is only as good as the policies and procedures governing its activities. This includes the procedures that are used in the performance of such configuration management tasks as updating the CMDB, performing audits, reconciling the CMDB, and preparing management reports. All configuration process activities should be clearly defined and documented.

The policies and procedures that define the relationships and interaction between configuration management, change management, and release management must also be defined. Without proper planning and communication between these groups, the objectives of the configuration management process cannot be realized. Security guidelines should also be established that provide guidance on how these groups should interact.

Definition and documentation of configuration management standards is a best practice, as is maintaining the standards as a single document in a secure location. One example of a best practice policy is: Only a few people and automated processes should have update privileges to the CMDB.

Discover IT Components

All of the IT components that exist within the agreed management boundary must be identified before it can be determined which ones are important enough to be tracked and controlled using configuration management. In this context, IT components include process documentation, reference guides, technical manuals, and build documents—in addition to software applications, operating systems, network routers, workstations, and servers. An extensive audit is needed to identify the different types of hardware and software deployed within the agreed management boundary and to collect the documentation (both process and technical) that supports that environment. The audit should also identify relationships between IT components. For example, all workstations are built using the Microsoft Windows® XP client build document.

Decide What Needs to be Managed

Managing and tracking change for every single component within even a small IT environment would be impractical. Over and above the challenge of obtaining and loading all of this information into the CMDB, the costs involved in maintaining and updating it would be prohibitive.

Therefore, choices need to be made concerning the subset of components to be managed. This requires considering the business relevance and importance of the component and the relationship(s) it has with other components within the IT environment. Best practice calls for managing only those components that:
Are necessary for the effective operation of the business.
Support the provision of IT services.
Can be seriously impacted by changes to other components within the environment. The decision to include a component in the CMDB should be reviewed at periodic intervals.
   Build CMDB

The CMDB provides a single source of information about the components of the IT environment. This information can be used within the organization to improve system reliability, availability, and control. By establishing a database to track IT components, known as configuration items (CIs), configuration management can verify that only authorized components are used in the IT environment. Why is the use of only authorized components so important? This is an important aspect of control, because an unauthorized component introduces an unknown that could have undocumented, detrimental, and/or difficult-to-trace effects on related components.

This single source of information also provides other organizational groups, such as the service desk, incident management, and problem management, with the ability to quickly and accurately assess the impact and cause of incidents and problems. This leads to a faster resolution of problems and a reduction in system downtime. The result is improved availability and reliability of the IT environment. For example, supplying a quick answer to a user's question typically requires knowledge of the user's hardware and software configuration. With a CMDB, this information is available at the fingertips of the service desk staff.

In addition to selecting the tools and technology to host the CMDB, a number of setup and initialization tasks need to be performed before the database can be populated with information about managed IT components and relationships. These tasks include:
Building table definitions.
Creating outline reports.
Designing security and access restrictions.
Developing maintenance routines (which include backup and recovery procedures).

The tasks needed to be accomplished at this stage depend on the database product selected and the complexity of the IT environment to be managed.

Once these setup activities have been completed, the process flow activities required to carry out configuration management can take place.

Establishing Configuration Items

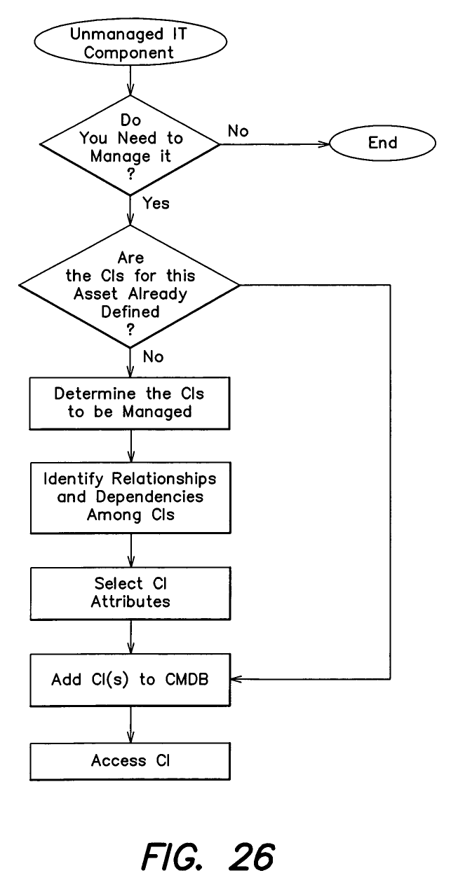

The process flow that leads to the identification of configuration items and relationships and their subsequent addition to the CMDB is shown in FIG. 26.

Tracking and controlling changes to an IT component involves adding it to the CMDB. This assumes that previously, in the setup stage, the desired level of detail at which to track and control change was identified, and CIs were created in the database that permit managing the component at this level.

When the component is recorded in the CMDB, relationships can be built between CIs to model the real-world situation in which IT components are connected to and dependent upon one another. For example, a workstation is made up of a desktop computer, operating system, and applications, and the workstation is connected to and uses the network. The proper understanding and modeling of the relationships in the CMDB makes it possible to perform detailed impact analysis on a proposed change.

Identifying CI activity is managed by the Release Role Cluster, but other Team Model role clusters also have some involvement, as shown in Table 14.

TABLE 14

| Role cluster | Involvement in establishing configuration items activities |
|---|---|
| Infrastructure | Provides technical expertise, |
| | including advice and guidance on how to |
| | identify and manage the relationship between CIs. |
| Operations | Provides input into operational CIs. |
| Partner | Provides partner/third-party input, |
| | particularly in cases where the |
| | partner manages this CI. |
| Release | Manages and owns the identification of CI process. |
| Security | Provides input into security CIs and |
| | security issues with this activity. |
| Support | Provides input into support CIs. Also provides |
| | direct support for this activity. |
| Service | Provides input across all configuration items |
| | from an IT services perspective. |

Does an Asset Need to Be Tracked and Controlled?

The initial setup and preparation activities should have included defining the list of IT components needing to be placed under the control of configuration management. As new components and assets are identified, they should be added to the CMDB only if they appear on this list.

The decision to include or exclude an IT component from the CMDB needs to be periodically reviewed to ensure that the database supports the needs of the organization and the service management functions using it.

Determine the CIs to Be Managed

Adding an IT component to the CMDB involves establishing it as a CI or CIs. To choose the appropriate CIs requires referring to the organization's customary level of detail for tracking and controlling change. Then, in the database, CIs can be created that permit managing the component at this level.

Using a workstation as an example, a workstation has several components: the installed operating system, software applications, processor, and memory.

To manage this workstation, organizations normally use configuration items that represent the workstation as a whole, including the operating system and installed software applications. However, in some situations, CIs could be created to represent each of these components, resulting in the ability to track and control change at a high-level of detail. And there may be some specialist organizations, such as personal computer hardware manufacturers, which need to include configuration items that allow them to track and control changes (at a very high-level of detail) to the graphics card, network card, and motherboard installed in a particular model of personal computer.

Although it is possible to do so, the benefits of tracking change at a high-level of detail may be vastly outweighed by the administration and management costs required to keep the CMDB up-to-date. Because each organization has different aims and objectives, there are no clear guidelines as to what constitutes a correct level of decomposition. However, the available time, resources, and technology should be considered prior to making a decision. This is the type of issue that must be explored during the initial discussions of the purpose of configuration management in the organization.

Note It is not necessary to track changes to items that an organization regards as consumables—items that generally have a low monetary value. The mouse and keyboard attached to a workstation often fall into this category.

Identify Relationships and Dependencies Among CIs

One of the key benefits of configuration management as compared to asset management is that configuration management models relationships between IT components. To do so, these relationships must first be identified and connections built between configuration items to replicate the real-world situation.

If the Internet Protocol (IP) address for a DNS server is changed, for example, it is then necessary to change the DNS resolver setting for all clients that use this server for name resolution. If the relationship between the DNS server and its clients is not maintained in the CMDB, it is possible that some clients will be missed, thereby preventing them from gaining access to network resources.

Identifying some relationships is relatively easy, while others may come to light only as changes are made to components within the IT infrastructure. It is advisable to focus initially on identifying the key relationships—those that are essential to the successful operation of the component and the infrastructure in which it is deployed—and then add in additional relationships as needed.

Relationships between IT components are modeled by building links between configuration items in the CMDB. When changes are proposed to a configuration item, these links can be used to identify the configuration items that may be impacted by that change. Making a change to a configuration item may not impact all the configuration items it is related to, and rules may be needed to ensure that only the relevant configuration items (those that will be affected by the change) are identified during impact analysis.

If a workstation's memory is increased from 256 MB to 512 MB, for example, this has no impact on the network the workstation is connected to. However, the network would be affected by a proposal to install a video conferencing application that requires a substantial (and dedicated) amount of network bandwidth.

It is not practical or even possible to define automated rules that cover all eventualities. The identification of configuration items affected by a change may require a combination of automated rules and the skills and experience of technically qualified staff.

Select CI Attributes

For every configuration item identified, there is normally a great deal of information that could be recorded in the CMDB, ranging from the item's name, description, and location to technically detailed configuration settings and options.

As will be emphasized throughout this document, the value of configuration management is entirely dependent on the quality and accuracy of the information contained in the CMDB. If too many attributes are selected, keeping this information accurate and up-to-date can be costly and time consuming. It is far better to select only those attributes that are needed to manage the configuration item and for which the organization needs to monitor and track change.

A configuration item (CI) that describes a software application, for example, could have the following attributes:
Unique identifier
Application name
Version number
Description
Location of source files (in the definitive software library)
Owner

It is also possible to create and store attributes that summarize lower-level details or contain values that are calculated by processing or filtering information. The need for these types of (processed) attributes depends on the requirements of each organization and the level at which configuration items have been identified and defined.

Add CI(s) to CMDB

The next major process to be conducted after identifying (or discovering) the configuration items and their relationships and selecting the attributes that represent the managed components of the IT infrastructure is to add this information to the CMDB. The first step in this process is to look at each configuration item (CI) and work out the best way to obtain the value (an assigned or calculated numerical quantity or an alphabetical entry that describes an attribute) of each attribute to be managed. These values are often recorded in a number of different places and it must be decided which of these should be used to populate the CMDB.

The IP address of a network server, for example, may be found in DNS, in the database of an automated inventory system, or even in a manually maintained Internet Protocol (IP) address register. It is also available locally.

In selecting an information source, consider the information's accuracy, whether it is up-to-date, and the difficulty and cost-effectiveness of retrieving it. In the example above, the server's IP address would probably be obtained from the automated inventory system in preference to DNS or the IP address register.

The next step is to decide how to retrieve the information. It is usually more efficient to obtain attribute values automatically by developing a tool that connects to the information source and extracts the needed information. In some cases, this approach is not cost effective or even possible, and some information has to be entered manually. Due to the time-consuming and error-prone nature of manual data entry, however, it is best to try and keep this to a minimum.

Note The tools and processes developed to retrieve attribute values from the information source will be needed whenever it becomes necessary to compare database values with those in the production environment (database verification).

After these preparatory steps have been completed, the third step is to initiate a change request that describes the configuration items, attributes, and relationships to be added to the CMDB. The request should also describe the mechanism by which attribute values will be populated.

Assuming the change request is approved, the configuration manager or an approved deputy should update the database structure to include the new configuration item(s), attributes, and relationships. The attribute values should then be populated using the tools and techniques identified in the change request.

All relevant document properties must be completed prior to storing a document in the production CMDB.

Accessing Configuration Items

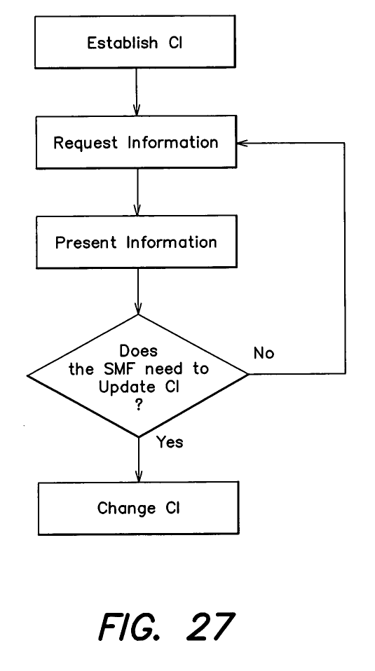

After the configuration items and their attributes and relationships have been recorded in the CMDB, people or automated processes carrying out other service management functions can request access to that information, as shown in the process flow diagram in FIG. 27.

Two primary and common CI access scenarios generally occur, for example, when the change management function uses the relationships defined within the CMDB to determine the impact of a change on other components within the IT environment, and when the problem management function uses the CMDB as a resource to identify which CIs are the root cause of incidents.

Accessing a CI can potentially involve all of the MOF Team Model role clusters, but their involvement varies according to their area of responsibility as shown in Table 15.

TABLE 15

| | Involvement in accessing |
|---|---|
| Role cluster | configuration items activities |
| Infrastructure | Consults on technical integration |
| | of CI information with other SMFs. |
| Operations | Performs day-to-day management of CIs. |
| Partner | Involvement limited to CIs that are managed |
| | by partner/third party. |
| Release | Owns CI data and the CMDB. |
| Security | Oversees security of CIs and CMDB. |
| Support | Supports CIs and CMDB. |
| Service | Provides any IT services information needed |
| | in requested information about a CI. |

Request for Information

A request for information in the CMDB may originate from within an SMF at any time. Information may be required about a single configuration item or multiple configuration items, using the relationships and dependencies to conduct an impact analysis (as in change management).

In organizations with more than one CMDB, a number of separate requests may be required to establish the true impact of a change. To understand the impact of replacing a transatlantic line, for example, staff members engaged in change management may need to request information from databases located in both Edinburgh and Seattle.

To achieve the needed results, requests for information must take into account the part(s) of the environment that are modeled in a particular CMDB. If desks, chairs, and telephones are not included in the CMDB, for example, then queries must be issued against other databases (such as the asset register) to gain the needed information. The implication is that personnel making requests directly and programmers setting up automated requests should both be familiar with the kinds of information contained in the CMDB.

Note Access rights and controls are also required to ensure that only authorized users access information stored in the CMDB. Even among this group, there may be a requirement to restrict access to sensitive information. For example, only certain users should be able to view detailed attributes of a network router. Security guidelines, policies, and access restrictions should have been established during the configuration management setup process.

How is information requested? Assuming authorized access, information retrieval may be performed within the CMDB application or through published interfaces.

Present Information

How the information is presented to the requester is dependent on the method or tools used to request the information. The information may be made available online through a Web reporting tool or database query or delivered through hardcopy reports.

Note The value of the information returned to the requesting service management functions depends entirely on the quality of the information stored within the CMDB. To achieve the anticipated benefits, information within the database must be complete, accurate, and up-to-date. Maintaining these aspects of quality is a responsibility associated with the “change CI” and “review CI” steps. Regular reviews (the last step of the configuration management process flow) should be held to ensure that the database and hence the information returned to an SMF accurately reflect the status of the production environment.

If, for example, some critical configuration item relationships and dependencies are missing from the CMDB, then the information returned to change management during impact analysis will be incomplete. As far as configuration management is concerned, however, the information retrieved and presented to the requesting SMF is complete.

To make it very easy to use these tools, the information needs to be presented in a simple and logical manner. One point to consider here is the naming standards for the CMDB fields—when “as needed” reporting is involved, the name of the field should be immediately understandable.

Sometimes the presentation of information contained in the CMDB suggests the need for a change in a configuration item. In this case, the regular change process must be followed, including approval and authorization through change management, before physical changes can be made to the IT component. Only then is the corresponding information within the CMDB changed.

Changing Configuration Items

As changes are made to IT components during the release management process, corresponding changes must be made to the configuration items and relationships that model them in the CMDB. If managed IT components in the live environment are changed without mirroring them in the CMDB, information within the database quickly becomes out-of-date or inaccurate, and the value of configuration management to other SMFs is significantly reduced. Whenever possible, the release mechanism should make these changes automatically; but in practice, this is not always possible. Manual data entry may sometimes be required to keep the database up-to-date.

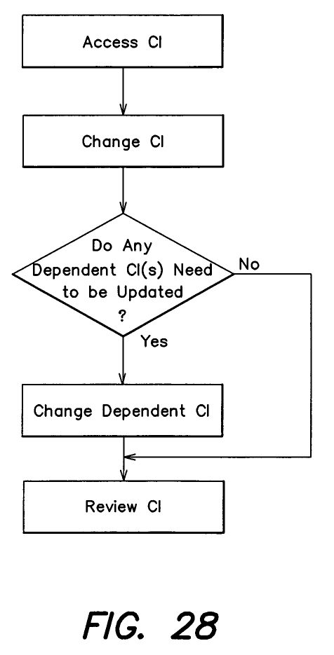

The process flow diagram in FIG. 28 highlights the fact that changes to IT components are rarely done in isolation. The relationships and inter-dependencies between IT components can often mean that a change to one component has an impact on another, forcing a change in or update of the other.

Adding video conferencing facilities to a workstation, for example, has the effect of increasing network utilization whenever conferences are in progress. If the local area network (LAN) is already running at capacity, video conferencing sessions cannot be run without making changes to other IT components and services. To resolve the problem, the workstation could be moved from one network segment to another, the LAN could be re-segmented to reduce utilization, or another solution could be found.

In all cases, however, a change must be made to one or more related IT components before video conferencing can be deployed and used successfully. Note that these changes must also be agreed upon and approved through the change management process. Assuming that approval is given, the CMDB needs to be updated with the original change (add video conferencing to workstation) and the additional changes required to support it (move workstation to new network segment).

The changing configuration items activity is managed and owned by the Release Role Cluster, but each of the other team roles may also be involved in this activity, as shown in Table 16.

TABLE 16

| | Involvement in changing |
|---|---|
| Role cluster | configuration items activities |
| Infrastructure | Limited involvement but can provide |
| | technical advice and guidance as a |
| | CI is changed. |
| Operations | Limited involvement other than |
| | operating CI during change. |
| Partner | Limited involvement. |
| Release | Manages and owns the change |
| | configuration items activity. |
| Security | Provides input into security issues both |
| | before and during change. |
| Support | Provides direct support during this activity. |
| Service | Provides any IT services information needed |
| | for the process of changing a CI. |

Change CI

There can be a substantial delay between change management approval and the eventual (full) deployment of that change into the production environment by release management. To make sure that the CMDB takes account of this delay and accurately reflects the state of an IT component, the CMDB must be updated at least twice for every change—once when the change is first approved and again, when it has been completed.

The initial update, at change approval, is required to ensure that an SMF querying the database for information about a particular configuration item can be notified about upcoming changes. The information added to the database at this stage should include the RFC, the date of the proposed change, and a status indicator that shows that a change(s) is (are) pending.

Note More than one RFC may be pending for a particular configuration item. A server, for example, could have these RFCs pending: upgrade server memory from 256 MB to 512 MB (RFC1) and install SQL Server (RFC2).

Over its lifetime, a configuration item is likely to be updated a number of times. A history of changes (with dates) should be maintained to provide the Problem Management SMFs and other SMFs with a view of changes made over time. If a change needs to be rolled back and the IT component restored to its previous state, this information will be invaluable.

If SMS is used to roll out software applications or to roll back an installation, then a “receipt of advertisement successful (or failed)” message can be used to trigger a CMDB update. Note that a program that is tied into the status message system (and particular messages) is required to write the update into the CMDB.

Change Dependent CI

As explained previously, the relationships and inter-dependencies between IT components can often mean that a change to one component affects another. In some cases, it is necessary to make additional changes to support the original change.

To install Microsoft Windows Messenger 4.6, for example, a workstation must be running Windows XP. If the installed operating system is currently Microsoft Windows 2000 or Windows 98, the operating system must be upgraded before Windows Messenger can be installed. In addition, the client might not have sufficient memory or disk space for Windows XP and further changes will be required to bring the computer up to the required specification.

Because the goal of configuration management is to provide a model of the production environment, the CMDB must record and track the original change and all of the subsequent changes required to support it. In the example above, changes to the operating system, memory, and disk space need to be tracked in the CMDB. Only when all of these changes have been successfully completed can the installation of Windows Messenger begin.

Reviewing Configuration Items

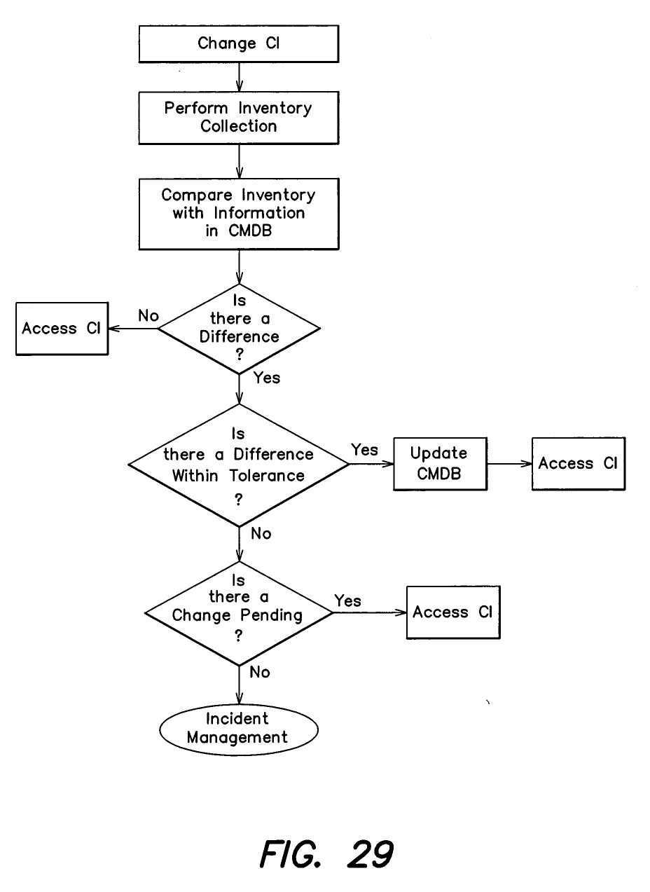

Because the accuracy of the information stored in the CMDB is crucial to the success of the Change Management and Incident Management SMFs as well as other SMFs, a review process, illustrated in FIG. 29, should be set up to ensure that the database accurately reflects the production IT environment.

At regular intervals, configuration management staff should perform an inventory (and audit) of managed components within the production environment and compare the information retrieved with that stored in the CMDB. Assuming that no differences exist, the date and time of the comparison should be recorded for tracking purposes.

If differences do exist, however, the action to be taken (if any) depends on a number of different factors. If an approved change has been deployed but the information within the CMDB is out-of-date, the likely choice is to update the database to the current value. However, if the CMDB indicates that Windows XP, for example, is installed on a workstation, and the actual installation is Windows 98, the issue would be raised with incident management.

It is also recommended to periodically check that the configuration items recorded within the CMDB are still relevant to the business and enable the organization to manage the IT environment at the correct depth (level of detail). Similarly, the accuracy of the agreed management boundaries or scope of configuration management should also be confirmed. (This type of architectural review is not shown on the process flow diagram.)

The reviewing configuration items activity is also managed and owned by the Release Role Cluster but, similar to other configuration management activities, each of the other Team Model role clusters may be involved, as shown in Table 17.

TABLE 17

| | Involvement in reviewing |
|---|---|
| Role cluster | configuration items activities |
| Infrastructure | Limited involvement but can provide |
| | technical advice and guidance, |
| | particularly when discrepancies are found. |
| Operations | Limited involvement. |
| Partner | Limited involvement. |
| Release | Manages and owns the review |
| | configuration items activity. |
| Security | Provides input into security issues |
| | both before and during change. |
| Support | Provides direct support during this activity. |
| Service | Provides any IT services information needed |
| | for the process of reviewing a CI. |

Perform Inventory Collection

The first phase in the review process is to obtain information from the production IT environment. This can be accomplished in a number of different ways, but it should be automated as much as possible. Manual auditing of IT components and assets is often expensive and time consuming and the results are often out-of-date before the information has even been analyzed.

Compare Inventory with Information in CMDB

After the needed information has been collected from the production environment, it can be compared with that stored in the CMDB. As with inventory collection, this task should be automated as much as possible. If collection was manual, for example, the information can be added to a spreadsheet or database application, which can then be used as an input to the mechanism used to validate the CMDB.

If there are no differences between the inventory value and that recorded in the CMDB, the date and time the comparison was made should be recorded for tracking purposes. Although the two values may match, a further check should be made on pending changes. If the “implement by” date for a change has expired but the live environment remains the same, then the issue should be escalated to incident management.

An example: A change request is created and approved to deploy Microsoft Office XP on all workstations before the end of the month. At the end of the month, the CMDB information is reviewed. For some workstations, the CMDB reports that Office 2000 is currently installed but an installation of Office XP is currently pending. If the inventory process confirms that Office 2000 is still installed, the issue needs to be raised with incident management.

If there are differences between the production environment and the CMDB, the action to be taken depends on a number of factors:
If a change is pending (or in progress), the inventory process might pick up new information before release management has had the opportunity to update the CMDB. The configuration management team should confirm that the change was successful before adding the information to the CMDB.
For many configuration items, it is possible to define a tolerance level. If the difference between the production environment and the Cl's defined tolerance level is within certain parameters, the new (production) information will be accepted and the CMDB updated accordingly.
If the operating system recorded in the CMDB is Windows XP, for example, but the inventory process reports it as being Windows XP Service Pack 1, this difference would be regarded as being within tolerance. In contrast, an inventory report stating that the operating system is Windows 2000 or Windows 98 would be regarded as out of tolerance and would need to be escalated to incident management.
It is not possible to define tolerance levels for all configuration items and their attributes. Some items require a decision to either simply accept the information obtained during the inventory or to escalate the difference to incident management.

In all cases, however, the difference between the CMDB and the production environment should be logged, together with any actions taken (if any). This log may be required when evaluating the success of configuration management within the organization.

Roles and Responsibilities

This section describes the roles and associated responsibilities of the configuration manager and the configuration management staff. It is important to note that these are roles, not job descriptions. A small organization may have one person perform several roles, while a large organization may have a team of people for each role. It is always recommended, however, that the configuration manager role be performed by just one person.

The roles also correspond to the roles defined within the seven role clusters of the MOF Team Model. These role clusters (Release, Infrastructure, Support, Operations, Partner, Service, and Security) represent at a high-level the operations functions that must be performed in an IT environment to achieve successful operations. The individual roles within each role cluster are closely related to one another.

The significant roles defined for the configuration release management process are:
Configuration manager
Configuration management staff
   Configuration Manager

The configuration manager is responsible for defining the processes and procedures that govern management of the CMDB. The person in this role is a member of the change advisory board (CAB) and works closely with the change manager to ensure that the impacts of proposed changes are known prior to changes being authorized and that all changes to the IT environment are recorded accurately in the CMDB. For more information about the CAB, refer to the Change Management SMF guide.

Configuration Management Staff

The size of the configuration management staff depends on the size of the organization, the size and frequency of changes and releases in the IT environment, the automation of the CMDB, and the granularity at which CIs are recorded in the CMDB. The configuration manager should ensure that sufficient staff is available to prevent the configuration process from becoming an impediment to the successful operation of other related processes.

If an organization is spread across multiple geographic locations, staff members may be required at each location. In a small organization, participating as a member of the configuration management team may be a collateral duty. However, in large organizations, being a member of the configuration management team is a full-time position—with the staff segmented into multiple groups, each responsible for managing specific areas of the IT environment. If the configuration management staff is segmented into separate groups, close coordination must occur between staff members to prevent updating errors.

When defining the CMDB management processes and procedures, the configuration manager needs to establish appropriate control mechanisms to ensure that the information recorded in the CMDB by the configuration management staff is accurate and complete. Table 18 summarizes the responsibilities associated with each of the configuration management roles.

TABLE 18

| Role | Responsibilities |
|---|---|
| Configuration | The configuration manager defines the processes and procedures that |
| manager | govern management of the CMDB. This role: |
| | Establishes the policies and procedures to govern the |
| | configuration management process. |
| | Determines the scope and granularity of the CIs recorded in the |
| | CMDB. |
| | Performs audits and establish baselines. |
| | Conducts organization-wide awareness campaigns about |
| | configuration management policies. |
| | Selects, assigns responsibilities to, and trains the configuration |
| | management staff. |
| | Establishes CMDB policies, including CI-naming conventions. |
| | Automates CMDB updating systems, if possible. |
| | Produces and distributes management reports. |
| | Provides change owner with a baseline report for assessing the |
| | impact of a release. |
| | Assists in development of the test environment (for changes) to |
| | mirror target environment. |
| | Updates the CMDB with all changes to the target environment |
| | when both the pilot and the full release have been completed. |
| Configuration | Staff members might each be responsible for managing |
| management staff | configuration management tasks for specific areas of the IT |
| | environment. Staff members may be assigned any of the following |
| | tasks: |
| | Update the CMDB with new CI information and status |
| | information. |
| | Control access to and distribution of documents from document |
| | repositories. |
| | Make changes to the CMDB structure. |
| | Prepare management reports. |
| | Conduct audits and reconcile the CMDB. |
| | Perform baselines. |
| | Assist the service desk, incident management, and problem |
| | management in using the CMDB to facilitate the resolution of |
| | incidents and problems. |
| | Create storage areas for configuration items (that is, document |
| | repositories). |
| | Perform any other role that the configuration manager needs to |
| | delegate. |

Relationship to Other SMFs

There is a close relationship between the three service management functions (Change Management, Configuration Management, and Release Management) that make up the MOF Changing Quadrant. FIG. 23 illustrates the relationship that exists between these three SMFs and is discussed above in connection with the Change Management SMF.

Recommended Technologies

All organizations that intend to use configuration management to track and control change to key components within their IT environment need to obtain and make use of certain tools and technologies. The appropriate number and complexity of these tools depends on the size of the organization and the number and type of IT components it wishes to manage.

This service management function guide takes a middle road by describing the tools needed to support the detailed processes that make up configuration management. The tools described here are sufficiently generic to enable all types and sizes of organizations to apply the advice.

There are a number of Microsoft tools that can help with the configuration management process. These include:
Microsoft SQL Server or Microsoft Access for hosting a configuration management database (CMDB), which all but the smallest of organizations will find essential.
Systems Management Server (SMS) for an automated inventory system for workstations and servers running Microsoft Windows.
Microsoft Visio® Enterprise Edition for identifying network resources.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed function. The one or more controller can be implemented in numerous ways, such as with dedicated hardware, or with general purpose hardware (e.g., one or more processor) that is programmed using microcode or software to perform the functions recited above.

It should be appreciated that the various methods outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, it should be appreciated that one embodiment of the invention is directed to a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

It should be understood that the term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

What is claimed is:

1. A method of instructing at least one operator in a best practices implementation of a standards facility for managing at least one standard in an information technology (IT) environment comprising a plurality of standards to be managed, the IT environment being managed in accordance with at least some aspects of the Microsoft Operations Framework (MOF), the at least some aspects of the MOF comprising a change management service management function (SMF) that documents, assesses the impact of, approves, schedules and reviews changes in the IT environment and a configuration management SMF that identifies and documents components of the IT environment and relationships between them, the method comprising an act of:
(A) instructing the at least one operator to treat the at least one standard as a configuration item so that changes to the at least one standard are managed in accordance with the change management SMF and so that the at least one standard is tracked in accordance with the configuration management SMF.

2. The method of claim 1, further comprising an act of instructing the at least one operator to implement the standards facility in accordance with MOF.

3. The method of claim 1, further comprising an act of providing instructions to the at least one operator for implementation of the standards facility, the instructions being provided as at least a portion of at least one MOF SMF.

4. The method of claim 3, wherein MOF comprises an optimizing quadrant, a changing quadrant, a supporting quadrant and an operating quadrant, and wherein the instructions for implementation of the standards facility are provided as at least a portion of at least one SMF included in the optimizing quadrant.

5. The method of claim 4, further comprising providing the instructions for implementation of the standards facility as at least a portion of an infrastructure engineering SMF that ensures coordination of infrastructure development efforts, translates strategic technology initiatives into functional IT environmental elements, and manages technical plans for IT engineering, hardware and enterprise architecture projects.

6. The method of claim 3, further comprising providing the instructions for implementation of the standards facility as at least a portion of an infrastructure engineering SMF that ensures coordination of infrastructure development efforts, translates strategic technology initiatives into functional IT environmental elements, and manages technical plans for IT engineering, hardware and enterprise architecture projects.

7. The method of claim 1, wherein the act (A) comprises an act of instructing the at least one operator to treat each of a first and second standard as a configuration item so that changes to the first and second standards are managed in accordance with the change management SMF and so that the first and second standards are tracked in accordance with the configuration management SMF.

8. The method of claim 1, wherein the act (A) comprises an act of instructing the at least one operator to treat each of the plurality of standards as a configuration item so that changes to each of the plurality of standards are managed in accordance with the change management SMF and so that each of the plurality of standards is tracked in accordance with the configuration management SMF.

9. The method of claim 5, further comprising an act of providing instructions, as part of the infrastructure engineering SMF, for implementing at least one process for establishing the at least one standard.

10. The method of claim 5, further comprising an act of providing instructions, as part of the infrastructure engineering SMF, for implementing at least one process for managing the at least one standard.

11. The method of claim 1, wherein the MOF comprises a change initiation review that provides a best practices approach for reviewing a change being initiated into the IT environment, and wherein the method further comprises an act of:
instructing the at least one operator to consider the at least one standard as part of the change initiation review.

12. The method of claim 1, wherein the MOF comprises a release readiness review that provides a best practices approach for reviewing a change being released into the IT environment, and wherein the method further comprises an act of:
instructing the at least one operator to consider the at least one standard as part of the release readiness initiation review.

13. A method of operating a standards facility for managing at least one standard in an information technology (IT) environment comprising a plurality of standards to be managed, the IT environment being managed in accordance with at least some aspects of the Microsoft Operations Framework (MOF), the at least some aspects of the MOF comprising a change management service management function (SMF) that documents, assesses the impact of, approves, schedules and reviews changes in the IT environment and a configuration management SMF that identifies and documents components of the IT environment and relationships between them, the method comprising an act of:
(A) following best practices instructions for the implementation of the standards facility, including instructions to treat the at least one standard as a configuration item so that changes to the at least one standard are managed in accordance with the change management SMF and so that the at least one standard is tracked in accordance with the configuration management SMF.

14. The method of claim 13, further comprising an act of following best practice instructions for implementing the standards facility in accordance with MOF.

15. The method of claim 13, further comprising an act of following best practice instructions for implementing the standards facility, the instructions being provided as at least a portion of at least one MOF SMF.

16. The method of claim 15, wherein the MOF comprises an optimizing quadrant, a changing quadrant, a supporting quadrant and an operating quadrant, and wherein the instructions for implementation of the standards facility are provided as at least a portion of at least one SMF included in the optimizing quadrant.

17. The method of claim 16, further comprising following best practice instructions for implementing the standards facility, the instructions being provided as at least a portion of an infrastructure engineering SMF that ensures coordination of infrastructure development efforts, translates strategic technology initiatives into functional IT environmental elements, and manages technical plans for IT engineering, hardware and enterprise architecture projects.

18. The method of claim 15, further comprising following best practice instructions for implementing the standards facility, the instructions being provided as at least a portion of an infrastructure engineering SMF that ensures coordination of infrastructure development efforts, translates strategic technology initiatives into functional IT environmental elements, and manages technical plans for IT engineering, hardware and enterprise architecture projects.

19. The method of claim 13, wherein the act (A) comprises following best practices instructions to treat each of a first and second standard as a configuration item so that changes to the first and second standards are managed in accordance with the change management SMF and so that the first and second standards are tracked in accordance with the configuration management SMF.

20. The method of claim 13, wherein the act (A) comprises following best practices instructions to treat each of the plurality of standards as a configuration item so that changes to each of the plurality of standards are managed in accordance with the change management SMF and so that each of the plurality of standards is tracked in accordance with the configuration management SMF.
